(19) United States
(12) Patent Application Publication
(10) Pub. No.: US 2023/0296956 A1
(43) Pub. Date: Sep. 21, 2023

(54) ULTRA-COMPACT PHASE MODULATORS BASED ON INDEX AND LOSS MODULATION IN RING RESONATOR CAVITIES

(71) Applicant: The Trustees of Columbia University in the City of New York, New York, NY (US)

(72) Inventors: Ipshita Datta, New York, NY (US); Michal Lipson, New York, NY (US); Sang Hoon Chae, New York, NY (US); James Hone, New York, NY (US)

(21) Appl. No.: 18/063,352

(22) Filed: Dec. 8, 2022

Related U.S. Application Data
(60) Provisional application No. 63/287,294, filed on Dec. 8, 2021.
(60) Provisional application No. 63/374,717, filed on Sep. 6, 2022.

(51) Int. Cl. G02F 1/225; G02F 1/035; G02F 1/00

(52) U.S. Cl. CPC G02F 1/2252; G02F 1/035; G02F 1/0018; G02F 2203/15

(57) ABSTRACT

Methods and systems are described for modulating optical signals. An example method may comprise supplying, via a waveguide, an optical signal to a resonator optically coupled to the waveguide. The method may comprise modulating a phase of the optical signal based on at least one layer comprising an electro-optic material having an electro-refractive property and an electro-absorptive property. The modulating of the phase may be based on using the at least one layer to tune a coupling of the waveguide and the resonator between being under-coupled and being over-coupled. The method may comprise outputting, via the waveguide, the modulated optical signal.

### CROSS-REFERENCE TO RELATED APPLICATIONS

This application claims the benefit of U.S. Provisional Patent Application No. 63/287,294 filed Dec. 8, 2021, and U.S. Provisional Patent Application No. 63/374,717 filed Sep. 6, 2022, each of which is hereby incorporated by reference for any and all purposes.

### GOVERNMENT SUPPORT CLAUSE

This invention was made with government support under DE-SC0019443 awarded by the Department of Energy, FA8650-18-1-7815, FA8650-16-1-7643, and FA9550-18-1-0379 awarded by the US Air Force, and HR0011-17-2-0034 awarded by the Defense Advanced Research Projects Agency. The government has certain rights in the invention.

### BACKGROUND

Optical phase modulators play a vital role in various applications including phased arrays, light detection and ranging (LIDAR), quantum circuits, optical neural networks and coherent optical communication links. There is an urgent need for ultra-compact, low-power, low-loss and high-speed optical phase shifters that can induce strong phase modulation with minimal amplitude modulation, to realize higher order modulation formats including differential phase shift keying (DPSK), quadrature phase shift keying (QPSK), among others. Higher-order phase modulation formats enable support for enhanced bandwidth requirements in heterodyne communication links and data centers.

### SUMMARY

Methods, systems, and devices are described for modulating optical signals. An example device may comprise a waveguide, a resonator optically coupled to the waveguide, and at least one layer comprising an electro-optic material. The at least one layer may have an electro-refractive property and electro-absorptive property. The device may cause phase modulation to optical signals based on using the at least one layer to tune a coupling of the waveguide and the resonator between being under-coupled and being over-coupled.

An example method may comprise supplying, via a waveguide, an optical signal to a resonator optically coupled to the waveguide. The method may comprise modulating a phase of the optical signal based on at least one layer comprising an electro-optic material having an electro-refractive property and an electro-absorptive property. The modulating of the phase may be based on using the at least one layer to tune a coupling of the waveguide and the resonator between being under-coupled and being over-coupled. The method may comprise outputting, via the waveguide, the modulated optical signal.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

The file of this patent or application contains at least one drawing/photograph executed in color. Copies of this patent or patent application publication with color drawing(s)/photograph(s) will be provided by the Office upon request and payment of the necessary fee.

FIG. 1A shows a schematic representation of an example device in accordance with the techniques of the present disclosure.

FIG. 1B shows a theoretical simulation of the phase response (top panel) and the normalized transmission (bottom panel) at the output of the ring resonator when both the index and loss in the ring resonator is modulated simultaneously.

FIG. 1C shows a cross-sectional view of an example device.

FIG. 1D shows in the top panel the position of monolayer TMD (WSe₂) and graphene in the mode-profile of the waveguide configuration. The bottom panel of FIG. 1D shows the optical micrograph of the fabricated device with 40 μm long WSe₂—Al₂O₃-graphene capacitor embedded in a 50 μm radius ring resonator.

FIG. 2A shows a fiber-based MZI experimental setup for measuring phase in a SiN chip with 40 μm long WSe₂—Al₂O₃ capacitor embedded in a ring resonator of 50 μm.

FIG. 2B shows experimentally measured phase response ϕT in radians (top panel) and normalized ring transmission (bottom panel) as function of wavelength (in nm) for various voltages applied across the 40 μm capacitor in the ring resonator.

FIG. 2C shows extracted phase change of π/2 radians at the probe wavelength (marked with a dashed line in FIG. 2B) with an amplitude modulation of 5 dB, and an insertion loss of 4 dB with a voltage swing from −4 V to −22 V.

FIG. 2D shows a principle of operation to switch between 0 and 0.82π phase shift to realize binary phase shift keying (BPSK) in an example WSe₂-graphene platform.

FIG. 2E shows a frequency response (S₂₁) of the WSe₂-graphene based SiN phase modulator at 1538.7 nm, showing an electro-optic bandwidth of 15 GHz.

FIG. 3A shows a measured electro-optic response of an example g-WSe₂ composite material.

FIG. 3B shows the optimized percent of the ring covered with graphene-TMD capacitor (Len_{g-TMD} (μm)) as a function of SiN propagation loss (dB/cm), to achieve π/2 phase shift with minimal amplitude modulation, low insertion loss (IL) and maximum electro-optic bandwidth.

FIG. 4A shows experimentally measured normalized transmission (bottom) and theoretical fit phase spectra (top) of a microring resonator with 25 μm long WSe₂—Al₂O₃-graphene capacitor for different voltages applied across monolayer graphene and WSe₂.

FIG. 4B shows extracted phase change of π/2 radians with an amplitude modulation of ˜2 dB and insertion loss of 3 dB, at a probe wavelength of 1646.192 nm with a voltage swing from 10 V to 30 V.

FIG. 4C shows a principle of operation to switch between 0/π (phase shift to realize binary phase shift keying (BPSK) in WSe₂-graphene platform.

FIG. 5 shows a fabrication flow for the composite g-TMD capacitor on SiN waveguide.

FIG. 6A shows change in the imaginary (top) and real (bottom) part of the normalized conductivity of graphene

$$( \frac{{σ}_{G}}{{σ}_{0}} )$$

with voltage, extracted from the change in effective index using COMSOL Multiphysics simulations.

FIG. 6B shows that the Δα_{g} due to graphene from COMSOL simulation closely matches the experimentally measured Δα_{eff}, since the change in loss is dominated by the graphene response.

FIG. 6C shows change in the real part of the refractive index of monolayer WSe₂ (Δn_{WSe2}) with applied voltage.

FIG. 6D shows change in the index and absorption of propagating mode, extracted theoretically from COMSOL simulation and measured experimentally (squares with errorbar).

FIG. 7 is a block diagram illustrating an example computing device.

FIG. 8A shows normalized transmission (T_{Ring}) and phase response (φ_{T}) of a ring resonator embedded with a conventional material that undergoes a strong change in index i.e.

$$\frac{Δ n}{Δ k} \sim - 20.$$

FIG. 8B shows T_{Ring} and φ_{T} of a ring resonator embedded with a hybrid material that undergoes simultaneous index and loss change i.e.

$$\frac{Δ n}{Δ k} \sim 1.$$

FIG. 8C shows a composite SiN-2D hybrid platform with monolayer Gr and WSe₂ to tune the loss and index of SiN waveguide, respectively.

FIG. 9A shows phase change (Δφ_{T} in radians) in the top panel and transmission modulation (ΔT_{Ring} in dB) in the bottom panel at probe wavelength detuning NO, for different voltages applied across two Gr—Al₂O₃—WSe₂ capacitors embedded in a SiN ring resonator of 50 μm radius.

FIG. 9B shows normalized frequency response (S₂₁) of device I at 1569.6 nm for a bias voltage at 8 V.

FIG. 10A shows change in the real (top) and imaginary (bottom) part of the effective index (Δn_{eff} and Δk_{eff} in refractive index units (RIU)) of the composite SiN-2D waveguide at different voltages, extracted from the normalized T_{Ring} of device II.

FIG. 10B shows change in the imaginary (top) and real (bottom) part of the normalized optical conductivity of monolayer graphene

$$( \frac{{σ}_{G}}{{σ}_{0}} )$$

that imparts a proportional change in the Δn_{eff} and Δk_{eff} of the propagating mode, respectively.

FIG. 10C shows change in the real (top) and imaginary (bottom) part of the refractive index of monolayer WSe₂ (Δn_{WSe2} and Δk_{WSe}_{₂} in RIU) with voltage.

FIG. 11 shows a comparison of insertion loss (IL_{π/2}) vs. phase modulation efficiency (i.e. voltage length product (V_{π/2}·L_{π/2}) for various electro-optic phase modulators.

FIG. 12 shows Effective index change (Δn_{eff}) and length required for π/2 phase shift

$$( {L}_{\frac{π}{2}} )$$

for phase modulators based on bulk, plasmonic and 2D material.

FIG. 13 shows change in the real (Δn) and imaginary part (Δk) of the refractive index of the waveguide, required for strong phase change with minimal transmission modulation, as a function of different unloaded quality factor (Q₀_{_{UC}}) of the ring operating in the slightly under-coupled regime.

FIG. 14A shows that for

$$\frac{Δ n}{Δ k} \sim - 100 ,$$

the T_{Ring} and ϕ_{T} shows a strong shift in the resonance wavelength due to the large Δn.

FIG. 14B shows the effect of

$$\frac{Δ n}{Δ k} = - 20$$

on the T_{Ring} and φ_{T}.

FIG. 14C shows the effect of

$$\frac{Δ n}{Δ k} = - 1$$

and finds that the loss in the ring increases as fast as the index, causing the linewidth of the resonance to broaden and the ring to become strongly under-coupled with

$$\frac{1}{{τ}_{0}} ≫ \frac{1}{{τ}_{e}} .$$

FIG. 14D shows an investigation of the effect of a Δn/Δk of 1 on the T_{Ring} and ϕ_{T}.

FIG. 14E shows as we increase Δn/Δk to 10, the lower Δk results in a minimal decrease in the loss of the ring, causing the ring to become more critically coupled i.e.

$$( \frac{1}{{τ}_{0}} \approx \frac{1}{{τ}_{e}} ) .$$

FIG. 14F shows further increasing Δn/Δk barely changes the T_{Ring} and ϕ_{T}, since Δk<<Δn that does not change the coupling appreciably.

FIG. 15A shows the measured normalized ring transmission (T_{Ring}) in the top panel and the measured phase response (Φ_{T-Meas}) in the bottom panel, for different voltages applied across the Gr-WSe₂ capacitor.

FIG. 15B shows normalized ring transmission (T_{Ring}−top panel) and extracted phase change (Φ_{T-Ext}−bottom panel) as a function of the applied voltage applied across a 40 μm long Gr—WSe₂ capacitor embedded on a SiN ring resonator of radius 50 μm.

FIG. 16 shows using the transfer length method (TLM) to calculate the sheet and contact resistance for monolayer graphene.

FIG. 17 shows measured propagation loss in SiN ring resonator with no integrated capacitor.

FIG. 18 shows change in the measured propagation loss of SiN waveguide with voltage for different lengths of Gr—WSe₂ capacitor embedded in a ring resonator of radius 50 μm.

FIG. 19 shows unloaded quality factor (Q₀) and loaded quality factor (Q_{L}) for different voltages applied across the 40 μm long Gr—WSe₂ capacitor, embedded in a ring resonator of radius 50 μm.

FIG. 20 shows unloaded quality factor (Q₀) and loaded quality factor (Q_{L}) for different voltages applied across the 25 μm long Gr—WSe₂ capacitor, embedded in a ring resonator of radius 50 μm. The probe wavelength is 1646.18 nm.

FIG. 21 shows T_{Ring} (dB) and extracted phase (φ_{T-Ext}) vs. wavelength in 25 μm device for various voltages applied across the Gr—WSe₂ capacitor.

FIG. 22 shows an experimental setup for measuring phase in TMD-graphene based composite waveguide embedded in a ring resonator.

FIG. 23 shows an experimental setup with equations for measuring phase in TMD-graphene based composite waveguide embedded in a ring resonator.

FIG. 24A top panel shows the normalized MZI transmission (T_{MZI}) from 1510 nm-1600 nm for two different bias voltages of 4 V and 21 V applied across the capacitor. The bottom panel of FIG. 24A shows the normalized ring response (T_{Ring}), showing the two regime of operation, when the ring is undercoupled at 4 V and then overcoupled at 21 V.

FIG. 24B shows an expanded view of the MZI response in the wavelength range from 1536-1545 nm, showing an MZI fringe that corresponds to a 200 μm±10% path length difference between the chip and reference arm.

FIG. 24C shows T_{MZI} and T_{Ring} from 1538.4 nm to 1539 nm, showing the regime of operation where the T_{MZI} experiences a high extinction with minimal change in T_{Ring}, thereby indicating that the phase changed strongly by 0.82π with minimal amplitude modulation between 4 V and 21 V.

FIG. 25A shows extracted phase and measured transmission spectra as a function of different voltages applied across the capacitor.

FIG. 25B shows change in the real and imaginary part of the effective index of the propagating mode (Δn_{eff} and Δk_{eff}) in refractive index units (RIU) with the orange hexagonal marker, indicating the voltage at which critical coupling occurs, i.e. the decay rate in the ring matches the coupling rate between the bus waveguide and ring resonator

$$( \frac{1}{{τ}_{0}} = \frac{1}{{τ}_{e}} ) .$$

FIG. 26A shows extracted phase and measured transmission spectra as a function of different voltages applied across the capacitor.

FIG. 26B shows Δn_{eff} and Δk_{eff} in RIU with the orange hexagonal marker, indicating the voltage of 8.5 V at which critical coupling occurs.

FIG. 27 shows experimentally achieved Δn_{eff}/Δk_{eff} in our composite SiN-2D platform.

FIG. 28A shows change in the imaginary (top) and real (bottom) part of the normalized conductivity of graphene

$$( \frac{{σ}_{G}}{{σ}_{0}} )$$

with voltage, extracted from the change in effective index using COMSOL Multiphysics simulations.

FIG. 28B shows that the Δα_{g} due to graphene from COMSOL simulation closely matches the experimentally measured Δα_{eff}, since the change in loss is dominated by the graphene response.

FIG. 29A shows change in the real part of the refractive index of monolayer WSe₂ (Δn_{WSe2}) with applied voltage.

FIG. 29B shows change in the index and absorption of propagating mode, extracting theoretically from COMSOL simulation (in shaded region) and measured experimentally (squares with errorbar).

FIG. 30 shows comparison of insertion loss (IL_{π/2}) vs. phase modulation efficiency (V_{π/2}·L_{π/2}) to achieve a phase shift of π/2 radians for various electro-optic modulators.

FIG. 31 shows comparison of phase shifter length required to achieve π/2 phase shift (L_{π/2}) vs. phase modulation efficiency (V_{π/2}·L_{π/2}) for various electro-optic modulators.

FIG. 32A shows the coverage area of the Au assisted transferred WSe₂ on planarized SiN waveguides in FIGS. 32A-B, indicating the rings patterned with 40 μm long Gr—Al₂O₃—WSe₂ capacitor.

FIG. 32B shows the coverage area of the Au assisted transferred WSe₂ on planarized SiN waveguides, indicating the rings patterned with 25 μm long Gr—Al₂O₃—WSe₂ capacitor.

FIG. 33 shows normalized PL spectra for monolayer WSe₂ using gold-assisted transfer onto planarized SiN waveguides.

FIG. 34 shows Raman spectroscope of the top graphene monolayer.

FIG. 35A shows digital phase change between the under-coupled at 4 V and over-coupled regime of operation at 21 V.

FIG. 35B also shows digital phase change between the under-coupled at 4 V and over-coupled regime of operation at 21 V.

FIG. 36 shows digital phase change between the under-coupled at 8 V and over-coupled regime of operation at 30 V, in the 25 μm Gr—WSe₂ capacitor embedded in a ring resonator of radius 50 μm.

### DETAILED DESCRIPTION OF ILLUSTRATIVE EMBODIMENTS

The need of the hour is to demonstrate compact phase shifters that can enable a large phase change with minimal amplitude modulation, low insertion loss and high operation bandwidth. We show an approach of leveraging index and loss modulation in ring resonators to design ultra-compact phase modulators. The approach involves operating the ring resonator near the critically coupled regime, and tuning the coupling between the waveguide and ring resonator from the under-coupled to over-coupled regime or vice versa, to allow access to a large phase change. The coupling between the waveguide and ring resonator can be tuned by electrostatically doping, using thermal control, using electro-optic materials (e.g. lithium niobate) or plasmonic materials. The compactness of the phase modulator stems from the increase in the effective optical propagation length due to the finesse of the high-Q optical cavity.

We leverage this theoretical concept to demonstrate a platform for electrically reconfiguring the coupling between a bus waveguide and ring resonator, by tuning the index and loss of a microring resonator using a combination of the strong electro-refractive response in monolayer transition metal dichalcogenides (TMDs—in this case WSe₂, but inclusive of all TMD semiconductors such as MoS₂, WSe₂, MoSe₂, WSe₂, and MoTe₂ among others) and strong electro-absorptive property of graphene, respectively. We optimize our device design to demonstrate a compact 25 μm long WSe₂-graphene capacitor embedded in a silicon nitride (SiN) ring resonator configuration of radius 50 μm (i.e. 8% of the ring is covered with the WSe₂-graphene capacitor), can perform an analog optical phase modulation of π/2 with minimal amplitude modulation of 2 dB, accompanied with an insertion loss of 2.5 dB and a 3 dB electro-optic bandwidth of 15 GHz. We further show that this platform is capable of performing digital binary shift keying (DPSK), where the phase of the optical signal can switch between 0 and π radians with no amplitude modulation and an insertion loss of 5 dB.

Main Claim: We show and provide a theoretical construct of designing ultra-compact phase modulators by leveraging an interplay of index and loss modulation in ring resonator. We further implement the design principle by relying on the strong electro-refractive response in TMDs (WSe₂) [1] and strongly tunable absorption in graphene [2] to enable ultra-compact phase shifter (length of ˜25 μm), which consists of a WSe₂—alumina (Al₂O₃)-graphene capacitor placed atop an optical microring resonator. We further report that our devices support an electro-optic bandwidth of 15 GHz (e.g., ˜50 times higher than the electro-optic bandwidth reported on a TMD platform to date).

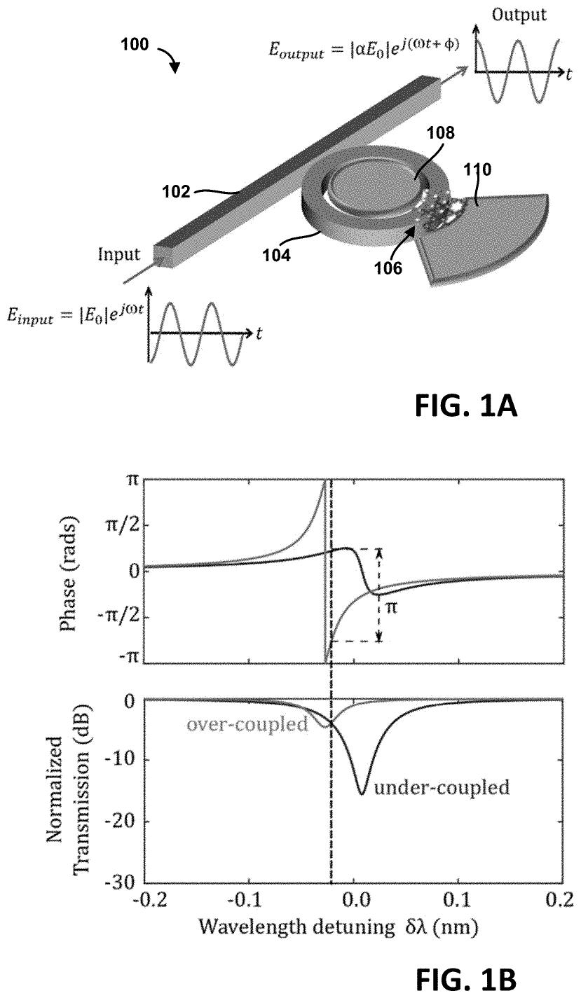

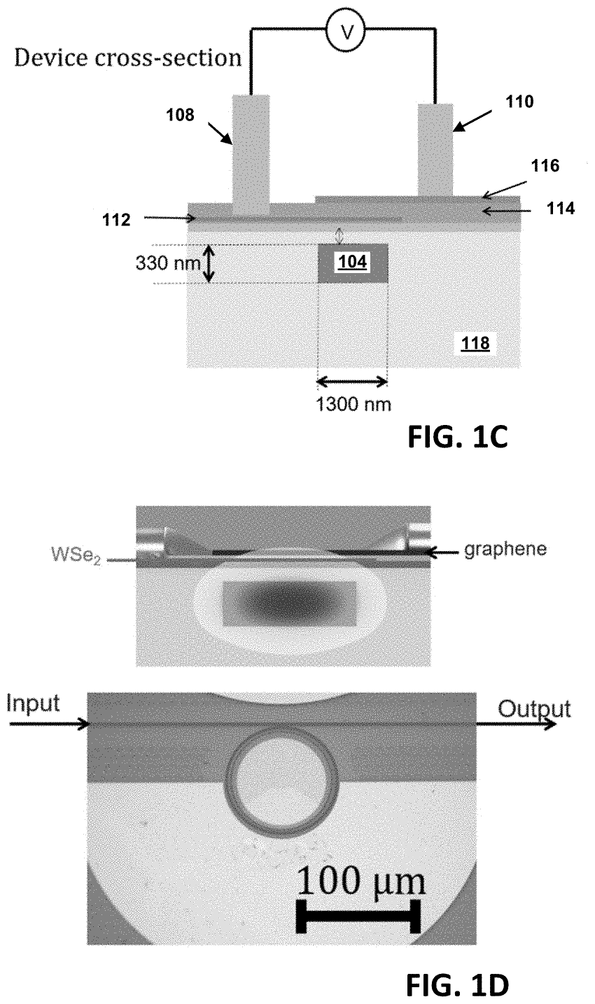

The principle of operation: Microring resonators have revolutionized silicon photonics and are currently extensively used as intensity modulators in a host of applications [3]. Microring resonators operating in the critical coupling (CC) condition enhance any small change in the waveguide response as they increase the effective propagation length of the optical mode with the finesse with the cavity. However, to date the ring resonators in the CC mode of operation, have not been used to amplify phase response, because the phase and amplitude in a resonator are intrinsically linked to one another through the Kramers-Kronig relation, such that at resonance (i.e. maximum extinction), the system is highly dispersive and transmission is minimal. Here, we show that we can use index and loss modulation in ring resonators, operating near the CC regime to modulate phase of the incident light with minimal change in the amplitude response, low insertion loss while maintaining the high operation bandwidth (see FIG. 1A).

In order to modulate index and loss in the ring, we design a hybrid waveguide that can modulate index and loss simultaneously to similar extents. This induces detuning in the resonance wavelength (index change) and changes the coupling condition in the ring resonator from the under-coupled (UC) regime to the over-coupled (OC) condition (loss change), under electrostatic gating. One can see from FIG. 1B, that the coupling change from the UC to OC regime allows accessibility to strong phase tunability, thereby altering the phase drastically at a probe wavelength (shown in dashed lines of FIG. 1B), with minimal amplitude modulation and low insertion loss.

FIGS. 1A-D shows the principle of operation and design of an example device in accordance with the present disclosure.

FIG. 1A shows a schematic representation of a phase modulator based on a microring resonator coupled to a bus waveguide, where both the loss and index in the ring cavity is modulated simultaneously (dimensions not to scale). This results in a phase change of ϕ (radians) and an amplitude modulation of α.

The device 100 may comprise a waveguide 102. The waveguide 102 may comprise silicon nitride. The device 102 may comprise a resonator 104. The resonator 104 may be optically coupled to the waveguide 102. The resonator 104 may comprise a ring resonator, microresonator, or a combination thereof.

The device 102 may comprise at least one layer 106. The at least one layer 106 may comprise an electro-optic material. The at least one layer 106 may have an electro-refractive property and electro-absorptive property. The at least one layer 106 may be disposed adjacent the resonator 104, on the resonator 104, within the resonator 104, or a combination thereof. The at least one layer 106 may comprise a monolayer, such as a monolayer of an electro-optic material, a monolayer of an electro-refractive material, a monolayer of an electro-absorptive material, or a monolayer of an electro-refractive material and the electro-absorptive material. The at least one layer 106 may comprise a capacitor structure, such as the structure shown in FIG. 1C.

The electro-optic material may comprise an electro-absorptive material. The electro-absorptive material may comprise one or more of graphene, silicon, or a plasmonic material. The electro-optic material may comprise an electro-refractive material. The electro-refractive material may comprise one or more of transition metal dichalcogenide, silicon, indium gallium arsenide (InGaAs), or a plasmonic material. The electro-optic material may comprise a plasmonic material having both the electro-refractive property and electro-absorptive property. The electro-optic material may comprise a transition metal dichalcogenide having both the electro-refractive property and electro-absorptive property at or near an excitonic resonance.

The device 100 may cause phase modulation to optical signals. The device 100 may cause phase modulation to optical signals based on using the at least one layer to tune a coupling of the waveguide 102 and the resonator 104 between being under-coupled and being over-coupled (e.g., or vice versa). The phase modulation may be caused based on simultaneously modulating, using the at least one layer, both an index of refraction of the resonator and an insertion loss of the resonator. The phase modulation may be caused based on modulating, using the electro-refractive property of the electro-optic material, an index of refraction of the resonator. The phase modulation may be caused based on modulating, using the electro-absorptive property of the electro-optic material, an insertion loss of the resonator. The phase modulation may be caused based on changing a voltage applied between an electro-refractive portion of the electro-optic material and an electro-absorptive portion of the electro-optic material. Changing the voltage applied between the electro-refractive portion of the electro-optic material and the electro-absorptive portion of the electro-optic material may comprise changing the voltage to cause a tuning of the coupling of the waveguide and the resonator between being under-coupled and being over-coupled. The electro-refractive portion may comprise a layer of transition metal dichalcogenide. The electro-absorptive portion may comprise a layer of graphene. An optical mode of the resonator may overlap at least partially with the electro-optic material. The electro-optic material may comprise an electro-refractive material and an electro-absorptive material. The optical mode of the resonator may overlap at least partially with the electro-refractive material and the electro-absorptive material.

An optical mode of the resonator 104 may overlap at least partially with the electro-optic material. The electro-optic material may comprise an electro-refractive material and an electro-absorptive material. The optical mode of the resonator 104 may overlap at least partially with the electro-refractive material and the electro-absorptive material.

FIG. 1B shows a theoretical simulation of the phase response (top panel) and the normalized transmission (bottom panel) at the output of the ring resonator when both the index and loss in the ring resonator is modulated simultaneously. The loss modulation changes the coupling condition from the under-coupled regime to the over-coupled state, and the index change causes a shift in the resonance wavelength, thereby allowing access to a large dynamic range in phase modulation at the probe wavelength (see dashed line) with minimal absorption modulation and low insertion loss.

FIG. 1C shows a cross-sectional view of the example device of FIG. 1A. The device 100 may comprise a first layer 112. The first layer 112 may comprise a monolayer. The first layer 112 may comprise an electro-refractive material. The electro-refractive material may comprise one or more of transition metal dichalcogenide, silicon, indium gallium arsenide (InGaAs), or a plasmonic material. The device 100 may comprise second layer 114. The second layer 114 may comprise a monolayer. The second layer 114 may comprise an insulator, such as aluminum oxide. The second layer 114 may be adjacent (e.g., below, above, in contact with, next to, in the same material stack) the first layer 112. The device 100 may comprise a third layer 116. The third layer 116 may comprise a monolayer. The third layer 116 may comprise an electro-absorptive material. The electro-absorptive material may comprise one or more of graphene, silicon, or a plasmonic material. The third layer 116 may be adjacent (e.g., below, above, in contact with, next to, in the same material stack) the second layer 114.

The device 100 may comprise a first electrode 108. The first electrode 108 may be adjacent (e.g., below, above, in contact with, next to, in the same material stack) the first layer 112. The first electrode 108 may comprise a conductive material, such as chromium, gold, or a combination thereof. The device 100 may comprise a second electrode 110. The second electrode 110 may be adjacent (e.g., below, above, in contact with, next to, in the same material stack) the third layer 116. The second electrode 110 may comprise a conductive material, such as chromium, palladium, gold, or a combination thereof.

The at least one layer 106 show in FIG. 1A may comprise the first layer 112, the second layer 114, the third layer 116, the first electrode 108, the second electrode 110, or any combination thereof. The at least one layer may comprise an additional insulator layer 118, such as a silicon oxide layer. The additional insulator layer 118 may at least partially enclose the resonator 104. One or more additional layers be between the additional insulator layer 118 and the at least one layer (e.g., the third layer 116, the second layer 114).

The device cross section may show an example implementation of a WSe₂—Al₂O₃-graphene capacitor on a 1300 nm wide×330 nm high silicon nitride (SiN) waveguide. It should be appreciated that the present disclosure is not limited to the example dimensions (e.g., 1300 nm width, 330 nm height for resonator 104), structure, or materials shown in FIG. 1C. Any other dimensions may be used as appropriate to meet design specifications. The device in FIG. 1C may be a practical demonstration of the disclosed approach that leverages two-dimensional materials (2Ds) to tune the loss and index in the ring resonator. Monolayer graphene may be used to modulate loss. Monolayer WSe₂ may be used to change the index in the ring resonator.

FIG. 1D shows in the top panel the position of an example monolayer TMD (WSe₂) and graphene in the mode-profile of the waveguide configuration. The bottom panel of FIG. 1D shows the optical micrograph of a fabricated device with 40 μm long WSe₂—Al₂O₃-graphene capacitor embedded in a 50 μm radius ring resonator.

In order to tune the index/loss of the effective propagating mode, on may leverage the electro-optic properties of monolayer WSe₂ and monolayer graphene, simultaneously, and embed the 2D materials on a 1300 nm wide×330 nm high SiN waveguide covered with 210 nm of silicon dioxide (Sift), where the optical mode may be allowed to overlap partially with both the monolayers (as seen in top image of FIGS. 1C and 1D (mode image)). Charges may be injected into the monolayers by applying a voltage across the 40 nm thick Al₂O₃ dielectric (ε_{R}=6.3) separating the WSe₂ and graphene monolayers (e.g., FIG. 1C). This hybrid waveguide of different lengths (25 μm and 40 μm) may be embedded in a ring resonator of radius 50 μm (e.g., FIG. 1D) and transmission response of the composite waveguide may be probed at the output of the bus waveguide. The index tuning may be dominated by the electro-refractive effect of monolayer WSe₂ which is stronger at high doping densities, where the loss modulation that changes the coupling between the bus waveguide and ring resonator is dominated by the electro-absorptive property of monolayer graphene at low-doping densities. In order to ensure high operation bandwidth of the phase modulator, the capacitive nature of the electro-optic device may be leveraged to reduces DC power consumption while still having a speed of operation exceeding 15 GHz (e.g., which may be mainly limited by the contact resistance between monolayer TMD and metallic contacts to TMD).

Example applications of the disclosed device may include optical switches, optical phased array, optical memory, optical neural networks, optical modulators, optical delay lines, all optical signal processing applications, or any combination thereof.

Comparison with State of Art:

Plasma dispersion effect based silicon modulators based on electro-refractive effect suffer from the tradeoff between phase modulation and amplitude change, since the real and imaginary part of the refractive index in silicon changes in tandem with doping. On the other hand, silicon phase modulators based on thermo-optic effect can perform pure phase modulation, but are at a disadvantage due to their electrical power consumption and low operation bandwidth. The length of these conventional devices for absorption modulation varies from 250 μm to 5 mm, with an insertion loss varying from 12 dB to 2 dB for a π/2 phase change [4-9]. Our 25 μm device is capable of performing π/2 phase shift with a low insertion loss of 3 dB.

Lithium Niobate based Electro-optic modulators have a long device length required for phase shift, difficult to integrate with silicon platforms [10-12]. Phase modulators based on thermo-optic effect have high electrical power consumption (milliwatts), and low speed. Ring resonator based thermal phase shifters operate in the strongly overcoupled regime, which does not benefit from the increased finesse of the optical cavity, thereby necessitating longer lengths [13,14].

Prototype Demonstration:

Initial Design and Demonstration

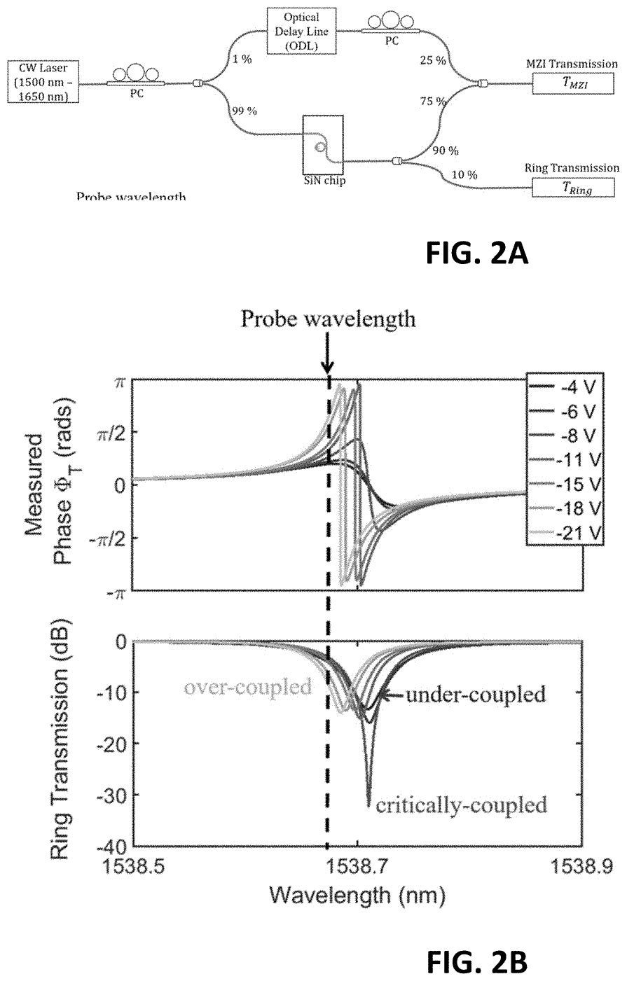

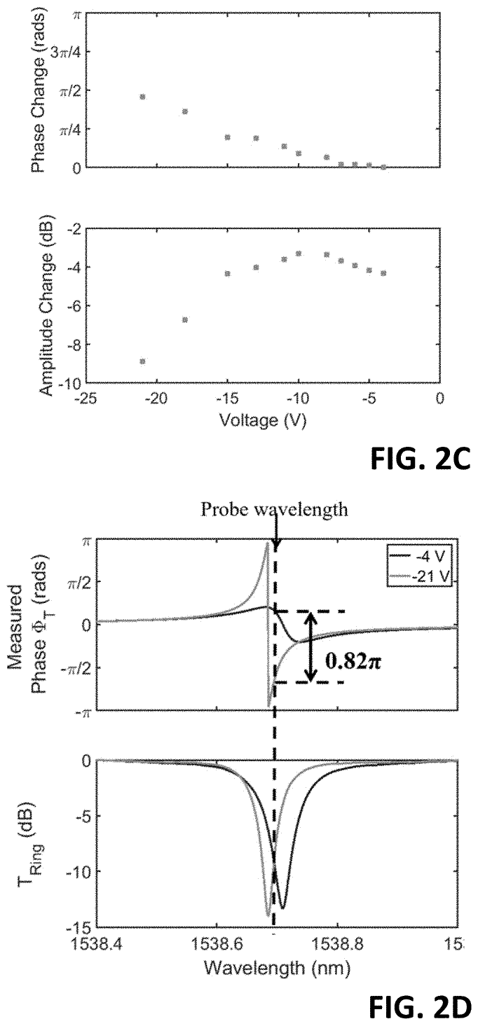

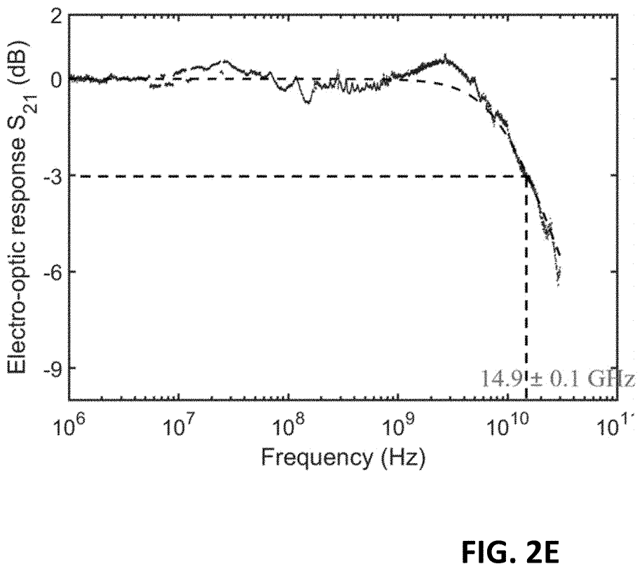

We measure the phase response of a 40 μm long WSe₂-graphene composite waveguide embedded in a ring resonator of radius 50 μm, by placing the SiN chip with the TMD-graphene platform in the arms of an external fiber Mach-Zehnder interferometer (MZI) configuration. FIG. 2A shows the schematic of the experimental setup (details of the setup provided in the appendix). This external setup can be replaced by an integrated configuration of an on-chip MZI. We show the experimentally measured phase response (ϕ_{T} (rads)) in the top panel of FIG. 2B and the normalized ring transmission (T_{Ring}) in the bottom panel of FIG. 2B, for different voltages applied across the 40 μm capacitor. The phase ϕ_{T} is computed from the measured MZI transmission response (T_{MZI}) and T_{Ring} using the following relation, where C₁, C₄ and βΔL are already known from the splitting ratio in the MZI arms and the fringe spacing in the MZI spectral response, respectively.

T_{MZI}=|C₁e^{jβΔL}+C₄\sqrt{T_{Ring}}e^{jϕ}^{_{T}}|²|Eᵢₙ|²

One can see from the T_{Ring} spectra in the bottom panel of FIG. 2B, that the ring is initially in the undercoupled (UC) state at −4 V, and as we increase the voltage, the ring becomes critically coupled (CC) to the bus waveguide at −8 V, finally entering the over-coupled (OC) regime beyond −9 V. We attribute the change in coupling to the reduction in loss of graphene at high doping densities, which causes Pauli blocking in monolayer graphene and reduction in the propagation loss of the ring. One can also see that in addition to the change in coupling, the resonance wavelength shows a remarkable blue shift with increased doping, which can be attributed to the strong electro-refractive response of monolayer TMDs. The measured phase response in the top panel of the FIG. 2B, shows an evolution of the phase response from the low-dispersive regime in UC condition to the strongly dispersive condition in OC regime, thereby allowing access to a large dynamic phase shift.

We find from the measured phase response (e.g., FIG. 2C), that our 40 μm device induces a phase change of π/2 radians with a voltage swing from −6 V to −22 V at a probe wavelength of 1538.68 nm with an amplitude modulation of 6 dB and an insertion loss of 4 dB. We further show in FIG. 2D, that this modulator is also capable of performing digital phase shift keying, by inducing an optical phase shift of 0.82π radians at a probe wavelength of 1538.69 nm while transitioning from the UC state at −4V to the OC regime at −21 V, with no amplitude modulation and an insertion loss of 9 dB. We measure the electro-optic bandwidth of the 40 μm WSe₂-graphene device and find that our device is RC limited to a 3 dB operating frequency of 15 GHz (e.g., FIG. 2E). We can further improve the operating bandwidth of the device by engineering the metal-TMD and metal-graphene contacts.

FIGS. 2A-E show phase measurement using an external Mach-Zehnder interferometer with a 40 μm long WSe₂—Al₂O₃-graphene capacitor embedded in a microring resonator of 50 μm, embedded in one arm of the MZI.

FIG. 2A shows a fiber-based MZI experimental setup for measuring phase in a SiN chip with 40 μm long WSe₂—Al₂O₃ capacitor embedded in a ring resonator of 50 μm.

FIG. 2B shows experimentally measured phase response ϕ_{T} in radians (top panel) and normalized ring transmission (bottom panel) as function of wavelength (in nm) for various voltages applied across the 40 μm capacitor in the ring resonator. The device may initially start in the under-coupled state (shown in purple) and move to the critically coupled condition (shown in blue) with an applied voltage of −8 V since the loss in graphene is strongly modulated. At this point the phase spectra (top panel) may become highly dispersive. As the applied voltage (|V|>8 Volts) is increased, both the loss and index may be modulated strongly, such that the device enters the over-coupled regime (shown in yellow) and the resonance wavelength encounters a blue-shifts. The strong change in coupling can be attributed to the loss modulation in monolayer graphene, while the index change retains contributions from both the monolayer WSe₂ and graphene electro-refractive response.

FIG. 2C shows extracted phase change of π/2 radians at the probe wavelength (marked with a dashed line in FIG. 2B) with an amplitude modulation of 5 dB, and an insertion loss of 4 dB with a voltage swing from −4 V to −22 V.

FIG. 2D shows a principle of operation to switch between 0 and 0.82π phase shift to realize binary phase shift keying (BPSK) in an example WSe₂-graphene platform. One can see that by tuning between the undercoupled regime at −4 V and over-coupled condition at −21 V, an abrupt phase shift may be realized of n rads at a probe wavelength of 1538.7 nm with insignificant amplitude modulation and an insertion loss of 8 dB.

FIG. 2E shows a frequency response (S₂₁) of the WSe₂-graphene based SiN phase modulator at 1538.7 nm, showing an electro-optic bandwidth of 15 GHz.

Design Optimization.

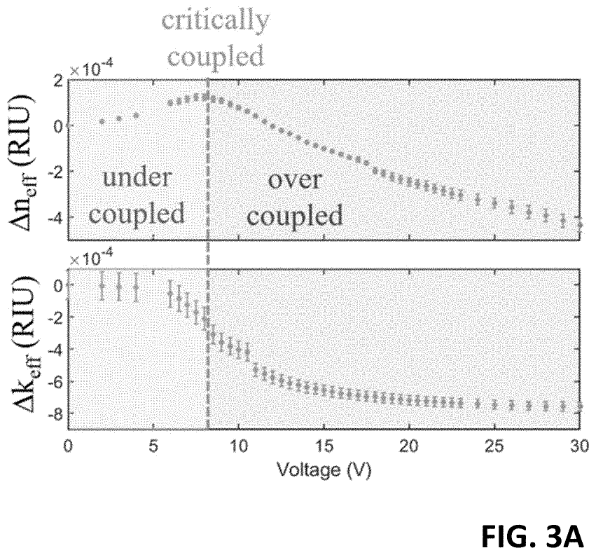

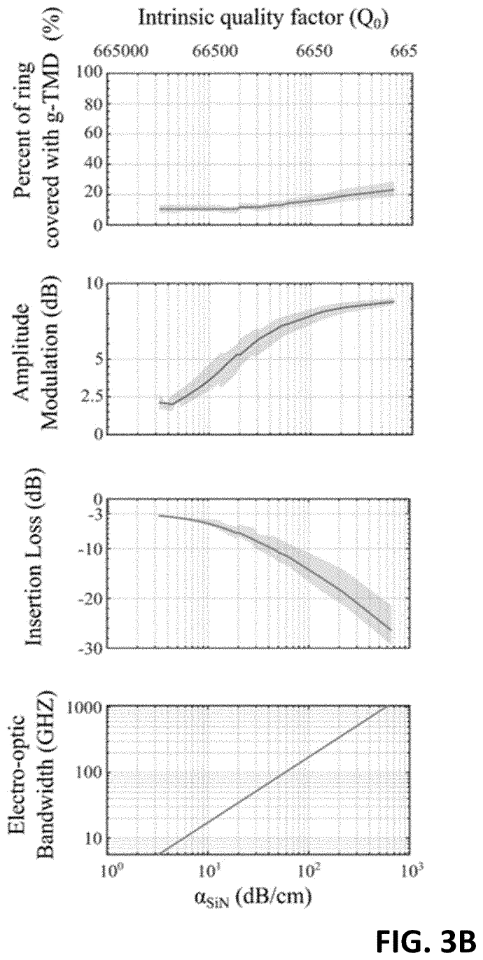

FIGS. 3A-B shows electro-optic response of g-TMD composite waveguide and theory of Device Design Optimization. FIG. 3A shows a measured electro-optic response of an example g-WSe₂ composite material. The operating principle of the disclosed compact modulator may rely on switching the coupling condition from the UC to the OC regime electrostatically. The simulations shows that the device performance may be optimal if the ring resonator is critically-coupled at a voltage where the slope of Δk_{eff}/ΔV is maximum and the Δn_{eff} is maximally red detuned, the position is as indicated by the orange dashed lines in both the panels of FIG. 3A. The device is in the UC condition at V<8 V and OC beyond 8 V.

FIG. 3B shows the optimized percent of the ring covered with graphene-TMD capacitor (Len_{g-TMD} (μm)) as a function of SiN propagation loss (dB/cm), to achieve π/2 phase shift with minimal amplitude modulation, low insertion loss (IL) and maximum electro-optic bandwidth.

Here, we show that one can design for an optimum length of the g-TMD capacitor in a ring resonator, to achieve strong phase modulation with low amplitude modulation and low insertion loss at a probe wavelength λₚ (nm), given a certain propagation loss of the SiN waveguide without the g-TMD composite material (α_{SiN} (dB/cm)) and the electro-optic response of the composite material (Δn_{eff}+iΔk_{eff} (RIU)). We measure the electro-optic response of the composite material by measuring the change in the real and imaginary part of the effective index (Δn_{eff} and Δk_{eff}) with varying voltages, from the change in the resonance wavelength and change in the propagation loss of the ring resonator, respectively. These parameters are obtained from the normalized ring transmission spectral response of the ring resonator coupled to the bus waveguide, at different voltages applied across the capacitor, as shown in the bottom panel of FIG. 2B.

The operating principle of our compact modulator relies on switching the coupling condition from the UC to the OC regime electrostatically. We find from our simulations that the device performance is optimal if the ring resonator is critically-coupled at a voltage where the slope of Δk_{eff}/ΔV is maximum and the Δn_{eff} is maximally red detuned, the position is as indicated by the orange dashed lines in both the panels of FIG. 3A. This allows for the device to be in the UC regime below 8 V (see shaded yellow region), which reaches critical coupling near 8 V with red detuning of resonance wavelength (orange dashed line) and then progressively becomes over-coupled with strong blue-detuning (shaded green region). The critical coupling at 8.5 V for 40 nm of dielectric can be achieved when the coupling between the bus waveguide and ring resonator equals the propagation loss in the ring resonator with the g-TMD material, i.e.

$$\frac{1}{{τ}_{e}} \approx \frac{1}{{τ}_{0}} {\vert}_{8.5 V} .$$

Since the SiN fabrication step determines the coupling rate

$$( \frac{1}{{τ}_{e}} ) ,$$

one can tailor the length of the g-TMD capacitor (Len_{g-TMD}), such that the CC condition is achieved at the desired voltage (in this case,

$$\frac{1}{{τ}_{e}} \approx \frac{1}{{τ}_{0}} {\vert}_{8.5 V} ) .$$

We plot in the top panel of FIG. 3B, the percent of the ring that should be covered with the g-TMD composite material (i.e.

$$\frac{L e {n}_{g - TMD}}{2 π R} ,$$

where R is the radius of the ring resonator) to achieve a phase modulation of π/2 radians at λₚ, as a function of the propagation loss in SiN waveguide without the composite material (α_{SiN} (dB/cm)). We additionally show the maximum amplitude modulation, insertion loss and the maximum electro-optic bandwidth of the phase modulator accompanying the phase change. We calculate the phase shift at a probe wavelength that is blue detuned by 10 pm from the resonance wavelength at 30 V (λₚ—the probe wavelength changes as a function of Len_{g-TMD}, and the resonance wavelength at 30 V undergoes stronger blue detuning with an increase in Len_{g-TMD}). One can see from the plots in FIG. 3B, that the percent of the ring covered with the g-TMD composite material reduces with low α_{SiN}. At low α_{SiN}, the quality factor and finesse of the cavity increases, thereby increasing the propagation length of the optical mode interacting with the g-TMD capacitor which in turn enhances phase change. Additionally, in high Q SiN cavities, the bus coupled ring resonator experiences lower loss in the over-coupled regime of operation, due to lower photon decay rates in the cavity. However, low loss comes with a tradeoff in terms of the electro-optic bandwidth, since low-loss ring resonator cavities are associated with longer photon lifetimes. High loss SiN cavities, require longer portion of the ring coverage, and have high amplitude modulation and high insertion loss.

Optimized Device Performance—25 μm g-TMD capacitor on SiN waveguide.

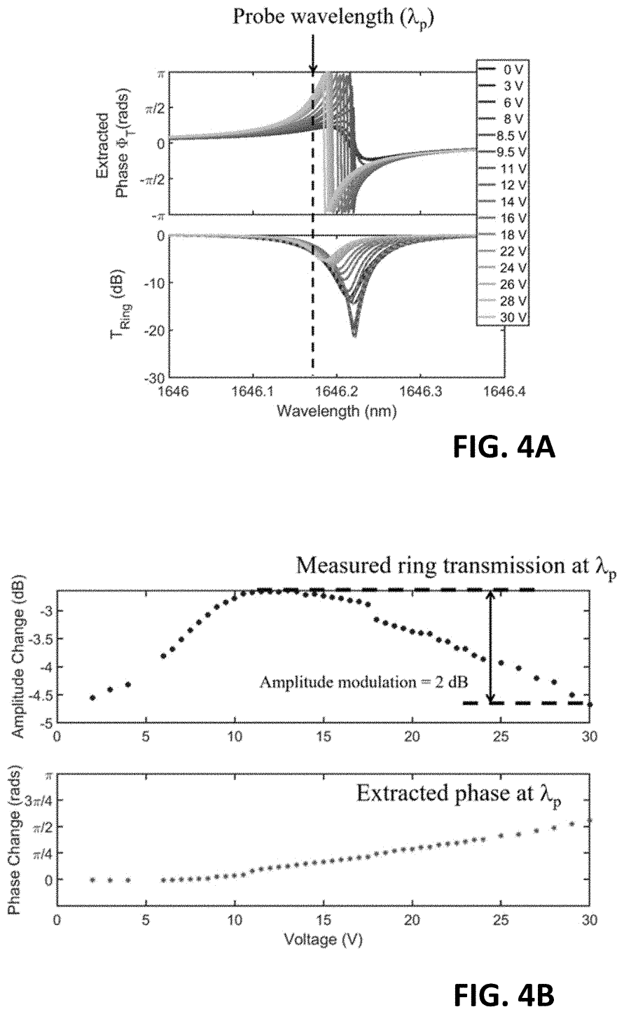

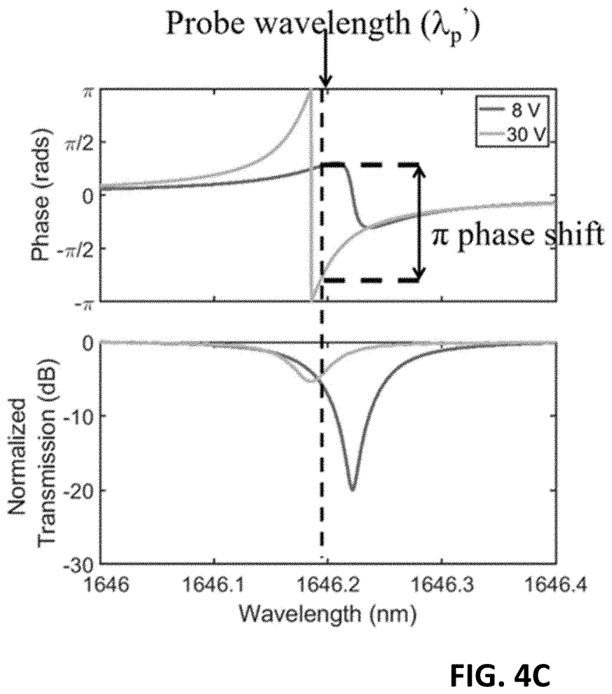

We optimize our device design to fabricate SiN ring resonators with propagation loss α_{SiN} of 5.93 dB/cm and pattern a 25 μm long g-TMD composite material in the ring resonator of radius 50 μm (i.e. 8% of the ring is covered with the composite material, in accordance with the theoretical plot in FIG. 3b). We measure a phase shift of π/2 radians, with a maximum amplitude modulation of 1.84 dB and an insertion loss IL of 2.5 dB at a wavelength of 1646.175 nm (see FIG. 4b). We further show in FIG. 4C, that this modulator is also capable of performing DPSK by inducing an optical phase shift of π radians with an insertion loss of 5 dB and insignificant amplitude modulation. We find a remarkable improvement in terms of amplitude modulation and insertion loss in our optimized device, compared to the 40 μm initial device. The low performance of the 40 μm device was due to the high propagation loss in fabricated SiN waveguide (α_{SiN}=11.58 dB/cm). We find that these devices also operate at 15 GHz electro-optic bandwidth.

FIGS. 4A-C show phase and amplitude response of an example optimized device with 25 μm long WSe2-graphene capacitor embedded in SiN microring resonators. FIG. 4A shows experimentally measured normalized transmission (bottom) and theoretical fit phase spectra (top) of a microring resonator with 25 μm long WSe₂—Al₂O₃-graphene capacitor for different voltages applied across monolayer graphene and WSe₂. The strong change in coupling can be attributed to the change in absorption in monolayer graphene, while the shift in the resonance wavelength is due to a combination of monolayer WSe₂ and graphene electro-refractive response.

FIG. 4B shows extracted phase change of π/2 radians with an amplitude modulation of ˜2 dB and insertion loss of 3 dB, at a probe wavelength of 1646.192 nm with a voltage swing from 10 V to 30 V.

FIG. 4C shows a principle of operation to switch between 0/π (phase shift to realize binary phase shift keying (BPSK) in WSe₂-graphene platform. One can see that by tuning between the undercoupled regime at 8 V and over-coupled condition at 30 V, an abrupt phase shift may be realized of π rads at a probe wavelength of 1646.194 nm with insignificant amplitude modulation and an insertion loss of 5 dB.

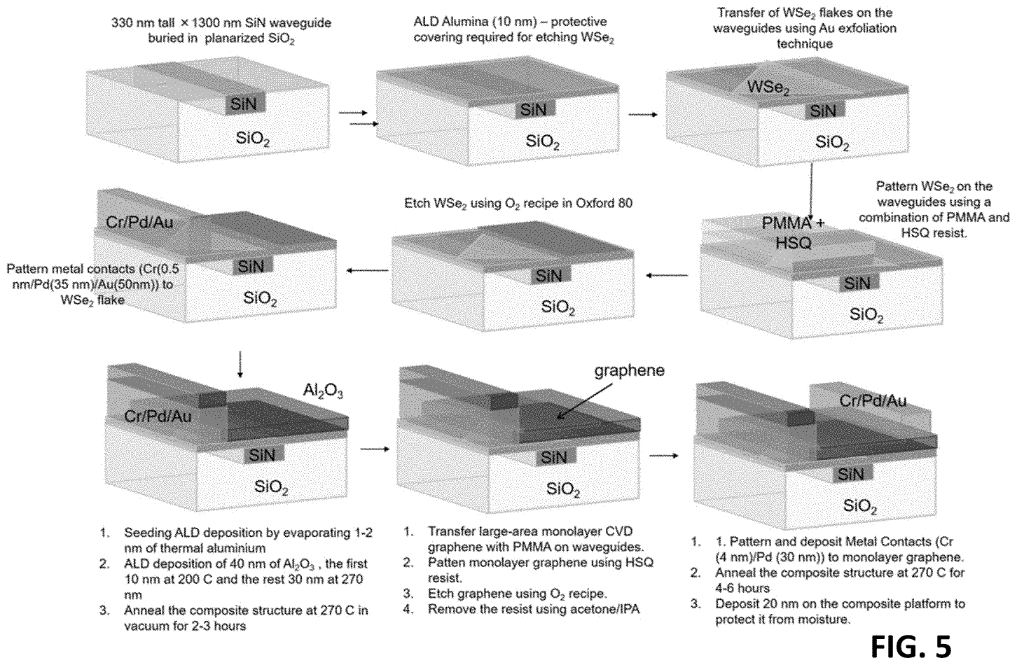

FIG. 5 shows a fabrication flow for the composite g-TMD capacitor on SiN waveguide. The fabrication flow may be for a WSe₂-graphene on SiN based phase modulator.

At step 1, we lithographically defined 1.3 μm wide waveguides on 330 nm high silicon nitride (SiN), deposited using Low Pressure Chemical Vapor Deposition (LPCVD) at 800° C. and annealed at 1200° C. for 3 hours on 4.2 μm thermally oxidized SiO2, using a combination of deep ultraviolet (DUV) lithography to define the chemical planarization (CMP) pillars of 5 μm length×5 μm width, with 33% fill factor in the wafer area, surrounding the waveguides and ebeam lithography (EBL) to define the waveguides.

At step 2, in order to obtain low-loss SiN waveguides at near infrared (NIR) wavelengths, we leverage an optimized etch recipe, described in Ref [7] to reduce the surface roughness of SiN waveguides that contributes to the propagation loss in low confinement SiN waveguides.

At step 3, we etch the SiN waveguides and CMP patterns using an optimized CHF₃/O₂ recipe with increased oxygen flow to reduce in situ polymer formation in Oxford 100 Plasma ICP RIE, using 360 nm of PECVD SiO₂ as a hard mask for etching the SiN thin film. We remove the residual SiO₂ hard mask using a 100:1 buffered oxide etch solution (BOE) to reduce the roughness due to etch, followed by deposition of 600 nm of Plasma Enhanced Chemical Vapor Deposition (PECVD) silicon dioxide (Sift) on the waveguides for planarization.

At step 4, we planarize the SiO2 to 180 nm±15 nm above the SiN waveguides using standard CMP techniques to create a planar surface for the transfer of monolayer TMD such as WSe₂ and to prevent the WSe₂ film from breaking at the waveguide edges. Planarization is critical for subsequent 2D material processing to prevent slippage and breaking of TMD and graphene monolayers at the edges of the waveguides and to establish contact with the monolayers on top of waveguides for capacitor design.

At step 5, we clean the planarized surface with Piranha solution at 100 C to remove the slurry particles that settle during CMP process. The 180 nm SiO₂ layer additionally aids in reducing the optical propagation loss introduced by the interaction of the undoped graphene monolayer with the optical mode.

At step 6, a 15 nm of sacrificial thermal atomic layer-deposited (ALD) alumina (Al₂O₃) is deposited on top of SiO2 to isolate the SiN waveguides from the subsequent fabrication steps required for the patterning of monolayer TMDs.

At step 7, following the WSe₂ transfer and patterning steps described below, the metal contacts are lithographically patterned using EBL, and 0.5 nm/30 nm/80 nm of Cr/Pd/Au was deposited using electron-beam evaporation, followed by liftoff in acetone.

At step 8, a 10 nm/30 nm layer of thermal ALD Al₂O₃ at 200°/270° C. is then deposited to form the dielectric of the WSe₂—Al₂O₃-graphene capacitor.

At step 9, in order to reduce the metal-WSe₂ contact resistance for high-speed photonic devices, we anneal the SiN waveguide with Al₂O₃ covered WSe₂ at 275° C. for 4 hours in vacuum.

At step 10, we then transfer and pattern monolayer graphene, as described in the section above, followed by vacuum annealing the composite WSe₂-AL₂O₃-graphene on SiN waveguide at 275° C. for 4 hours in vacuum to remove PMMA residue left on graphene monolayer after the transfer and patterning.

At step 11, following this, the metal contacts to the graphene layer is patterned using EBL and 5 nm/20 nm/50 nm of Cr/Pd/Au is then deposited using electron-beam evaporation, followed by liftoff in acetone.

At step 12, we protect our devices by depositing 10-20 nm of ALD alumina from moisture which can dope the top graphene layer

At step 13, finally, we define and wet etch (100:1 BOE) the vias to open the metal electrodes in contact with WSe₂ and graphene, for testing.

WSe₂ transfer and patterning—We leverage the facile method described in Ref [5] to exfoliate large-area monolayer WSe₂ onto our SiN waveguides, covered with 180 nm of planarized SiO2. We start with an atomically flat gold film, deposited by evaporating 150 nm thin Au films onto an ultra-flat surface of highly polished silicon wafer, where the gold film is stripped away off the substrate using a combination of the thermal release tape with a polyvinylpyrrolidone (PVP) interfacial layer. The ultra-flat gold tape allows for a uniform contact between the gold and monolayer WSe₂ crystal surface, exfoliating a complete monolayer that can be transferred onto our planarized SiN waveguides. We remove the thermal release tape by heating our substrate to 100° C., washing off the PVP layer and etching the gold with a mild solution of gold etchant (I₂/I⁻). We pattern a 50 μm long WSe₂ monolayer by spinning a dual resist mask of 400 nm/120 nm PMMA/HSQ (XR-1561 6%) film, followed by baking the pattern at 180° C. for 15 mins (PMMA)/4 mins (HSQ), respectively, patterning using EBL and reactive ion etching (RIE) based O₂ plasma treatment for 4 min 30 secs to etch the residual PMMA and monolayer WSe₂. After the etch, we strip the resist in acetone, where it dissolves the PMMA, cleanly removing the HSQ mask.

Graphene transfer and patterning—We use chemical vapor deposited (CVD) graphene grown on 3-inch×3-inch copper films (e.g., Grolltex). We prepare the graphene samples for transfer by first spinning PMMA 495 A6 at 1000 rpm and drying the 500 nm PMMA coated graphene on Cu film overnight in ambient conditions. We electrochemically delaminate the PMMA/graphene stack from the Cu film using the process described in Ref [6]. We prepare 1M NaOH aqueous solution as an electrolyte and delaminate the PMMA/Gr stack by using the PMMA/Gr on Cu foil as the cathode, and a bare Cu foil as the anode. The delaminated PMMA/Gr stack is then transferred to a fresh water bath and this process is repeated a few times, before being transferred onto the SiN substrate. We enhance the hydrophilicity of the substrate and remove moisture/polymer contamination by performing O₂ plasma clean on the sample for 30 minutes prior to the transfer. Following the transfer, we vacuum dry the as transferred sample overnight in a vacuum desiccator, followed by baking the sample at 180° C. for 2 hours. Finally, the PMMA is dissolved away in acetone solution by submerging the chip in acetone for about 4 hours.

Extracted electro-optic response of monolayer graphene and WSe₂.

We use the 2D sheet conductivity model to extract the electro-optic response of monolayer graphene and monolayer semiconductor WSe₂, as is commonly done when modelling graphene monolayers. The change in real part of effective index of the propagating mode (see Δn_{eff}(V) in the top panel of FIG. 3A is a combination of the electro-refractive response of graphene (imaginary part of

$$\frac{{σ}_{G}}{{σ}_{0}} )$$

and monolayer WSe₂(Δn_{WSe2}). We attribute the change in imaginary part of the effective index of the propagating mode in our devices (see Δk_{eff} (V) in the bottom panel of FIG. 3A) to the change in real part of the normalized complex conductivity (σ_{G}/σ₀) of graphene with voltage. The

$$Re \{ \frac{{σ}_{G}}{{σ}_{0}} \}$$

is related to me imaginary part of dielectric permittivity, that contributes to absorption, whereas the imaginary part of σ_{G}/σ₀ is related to the real part of dielectric permittivity, that contributes to the change in index of monolayer graphene.

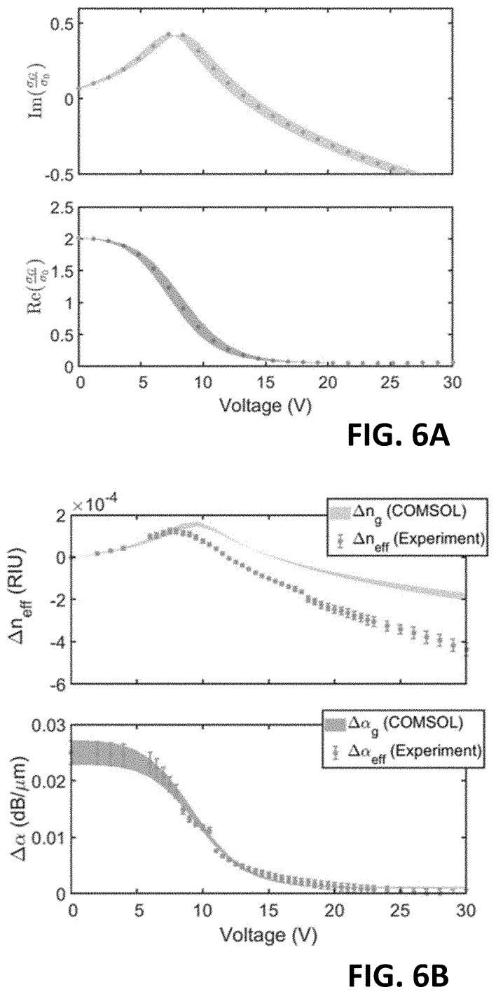

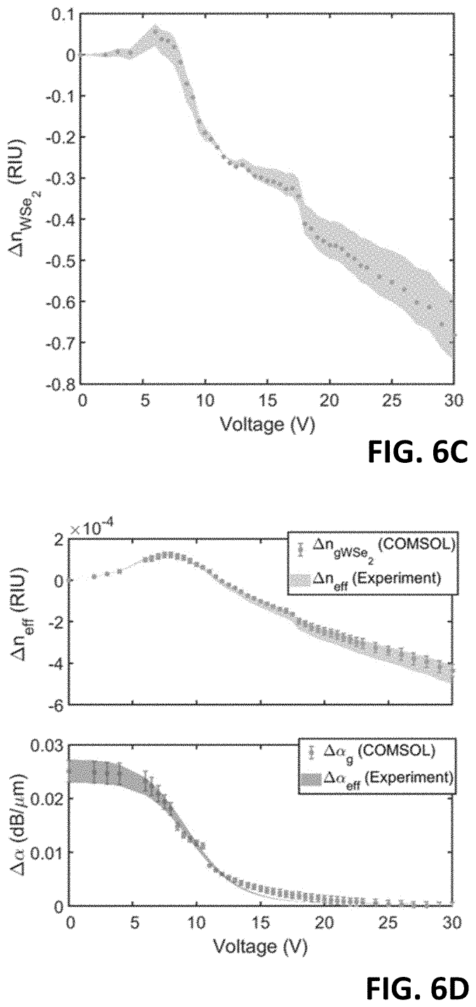

FIGS. 6A-B show extracted normalized conductivity of graphene. FIG. 6A shows change in the imaginary (top) and real (bottom) part of the normalized conductivity of graphene

$$( \frac{{σ}_{G}}{{σ}_{0}} )$$

with voltage, extracted from the change in effective index using COMSOL Multiphysics simulations. The image

$$\{ \frac{{σ}_{G}}{{σ}_{0}} \}$$

is related to the real part of the dielectric permittivity, that contributes to change in the index, whereas the real

$$\{ \frac{{σ}_{G}}{{σ}_{0}} \}$$

is related to me imaginary part or the dielectric permittivity, that contributes to absorption. The shaded portion indicates the theoretical error that includes the rms error in the measurement.

FIG. 6B shows that the Δα_{g} due to graphene from COMSOL simulation closely matches the experimentally measured Δα_{eff}, since the change in loss is dominated by the graphene response. However, the numerically computed Δn_{g} has a remarkable departure from the experimentally measured Δn_{eff}. The difference in the Δn_{eff} can be attributed to the change in the index of monolayer WSe₂, which is known to exhibit strong electro-refractive response at high doping densities.

FIGS. 6C-D show extracted change in index of monolayer WSe₂. FIG. 6C shows change in the real part of the refractive index of monolayer WSe₂ (Δn_{WSe2}) with applied voltage. One can see that the index of monolayer WSe₂ changes strongly with doping. FIG. 6D shows change in the index and absorption of propagating mode, extracted theoretically from COMSOL simulation (in red and blue shaded region) and measured experimentally (blue squares with errorbar).

Due to the capacitive nature of our device, the DC power consumption is a few nanowatts, which is significantly lower than that of thermal or plasma-dispersion modulators. We find that the TMD-graphene composite waveguide in a ring resonator performs as a remarkable tuning knob that can tune the coupling strongly, which can only be compared to thermal device reported in Ref [16], which are orders of magnitude slower and consumes a lot of power. We can further lower the voltage of operation by reducing the thickness of the Al₂O₃ dielectric and improving its quality. Improved interface between monolayers and Al₂O₃ will lower the operation voltage further and enhance the stability. We expect that the TMD-graphene platform will enable novel photonic functionalities based on the composite graphene/TMD photonic waveguides, where optoelectronic properties are endowed to traditionally passive materials.

Extension to Systems Beyond 2 Materials

The principle of leveraging index and loss modulation in ring resonators to design ultra-compact phase shifters can be extended to other electro-optic materials at wavelengths where the index and loss of the propagating mode can be modulated to the same degree (i.e. Δn_{eff}/Δk_{eff}>0.1 to 1).

In this case, the device is based on graphene, where the loss decreases with applied electrostatic gating. This principle of operation can also be extended to composite structures where the loss increases with gating. In this condition, the device is initially over-coupled and as the loss increases, the device becomes under-coupled, still allowing access to the large dynamic range of phase modulation. The initial condition would require significant over-coupling that can be obtained by designing race-track resonators to increase coupling or extremely small gaps.

The loss modulation extends to the possibility of using gain in ring resonators. If such a material is incorporated that has gain (either through gating or non-linearity), such that the coupling can be tuned from UC to OC or vice versa, one can also leverage the same principle to design ultra-compact phase modulators using this technique.

Experimental Setup for Measuring Phase.

We couple TE polarized light from a tunable near infrared (NIR) laser (1510 nm-1600 nm) using a polarization controller (PC) to the input of a 99-1% fiber splitter. We place the SiN waveguide with coupled ring resonator in the arm with 99% of the input power, to compensate for the 20 dB coupling loss from the lensed fiber to the SiN waveguide and back into the lensed fiber (10 dB coupling loss per facet) at the output of the chip. We monitor the spectral response of the ring transmission (T_{Ring}) at the output of the SiN waveguide, by placing a 90-10% splitter in the chip arm, where 90% of the input power is routed back to the MZI arm, and 10% of the ring transmission is sent to a photodiode. The 1% input signal in the reference arm is first coupled to a free-space optical delay line (ODL) that manually controls the optical path length difference between the reference and the chip arm. In order to ensure that the polarization in the reference arm and chip arm are optimally matched for interference at the input of the output fiber coupler of MZI, the reference arm has an additional polarization controller (PC). The optical signal in the chip and the reference arm are coupled back using a 77-23% coupler at the output of the MZI, to compensate for the insertion loss and coupling loss due to the 90-10 splitter in the chip arm and the ODL and PC in the reference arm. The output of the MZI is monitored with the photodiode (T_{MZI}). We stabilize the external fiber MZI by taping down the fibers on an optical table with large bends and covering them with Styrofoam and bubble wrap and covering the PC's, fiber splitters and ODL with cardboard boxes.

The disclosure may comprise any combination of the following aspects.
Aspect 1. A device comprising: a waveguide; a resonator optically coupled to the waveguide; and at least one layer comprising an electro-optic material, wherein the at least one layer has an electro-refractive property and electro-absorptive property, wherein the device causes phase modulation to optical signals based on using the at least one layer to tune a coupling of the waveguide and the resonator between being under-coupled and being over-coupled.
Aspect 2. The device of Aspect 1, wherein the electro-optic material comprises an electro-absorptive material, wherein the electro-absorptive material comprises one or more of graphene, silicon, or a plasmonic material.
Aspect 3. The device of any one of Aspects 1-2, wherein the electro-optic material comprises an electro-refractive material, wherein the electro-refractive material comprises one or more of transition metal dichalcogenide, silicon, indium gallium arsenide (InGaAs), or a plasmonic material.
Aspect 4. The device of any one of Aspects 1-3, wherein the electro-optic material comprises a plasmonic material having both the electro-refractive property and electro-absorptive property.
Aspect 5. The device of any one of Aspects 1-4, wherein the electro-optic material comprises transition metal dichalcogenide having both the electro-refractive property and electro-absorptive property at or near an excitonic resonance.
Aspect 6. The device of any one of Aspects 1-5, wherein the phase modulation is caused based on simultaneously modulating, using the at least one layer, both an index of refraction of the resonator and an insertion loss of the resonator.
Aspect 7. The device of any one of Aspects 1-6, wherein the phase modulation is caused based on modulating, using the electro-refractive property of the electro-optic material, an index of refraction of the resonator.
Aspect 8. The device of any one of Aspects 1-7, wherein the phase modulation is caused based on modulating, using the electro-absorptive property of the electro-optic material, an insertion loss of the resonator.
Aspect 9. The device of any one of Aspects 1-8, wherein the phase modulation is caused based on changing a voltage applied between an electro-refractive portion of the electro-optic material and an electro-absorptive portion of the electro-optic material.
Aspect 10. The device of Aspect 9, wherein the electro-refractive portion comprises a layer of transition metal dichalcogenide and the electro-absorptive portion comprises a layer of graphene.
Aspect 11. The device of any one of Aspects 9-10, wherein changing the voltage applied between the electro-refractive portion of the electro-optic material and the electro-absorptive portion of the electro-optic material comprises changing the voltage to cause a tuning of the coupling of the waveguide and the resonator between being under-coupled and being over-coupled.
Aspect 12. The device of any one of Aspects 1-11, wherein the at least one layer is disposed adjacent the resonator, on the resonator, within the resonator, or a combination thereof
Aspect 13. The device of any one of Aspects 1-12, wherein the at least one layer comprises a monolayer of an electro-refractive material.
Aspect 14. The device of any one of Aspects 1-13, wherein the at least one layer comprises a monolayer of an electro-absorptive material.
Aspect 15. The device of any one of Aspects 1-14, wherein the at least one layer comprises a capacitor structure comprising a first layer having an electro-refractive material, a second layer comprising an insulator, a third layer comprising an electro-absorptive material, a first electrode adjacent the first layer, and a second electrode adjacent the third layer.
Aspect 16. The device of any one of Aspects 1-15, wherein an optical mode of the resonator overlaps at least partially with the electro-optic material.
Aspect 17. The device of any one of Aspects 1-16, wherein the electro-optic material comprises an electro-refractive material and an electro-absorptive material, and wherein the optical mode of the resonator overlaps at least partially with the electro-refractive material and the electro-absorptive material.
Aspect 18. The device of any one of Aspects 1-17, wherein the resonator comprises a ring resonator.
Aspect 19. A method comprising: supplying, via a waveguide, an optical signal to a resonator optically coupled to the waveguide; modulating a phase of the optical signal based on at least one layer comprising an electro-optic material having an electro-refractive property and an electro-absorptive property, wherein the modulating of the phase is based on using the at least one layer to tune a coupling of the waveguide and the resonator between being under-coupled and being over-coupled; and outputting, via the waveguide, the modulated optical signal.
Aspect 20. The method of Aspect 19, wherein the electro-optic material comprises an electro-absorptive material, wherein the electro-absorptive material comprises one or more of graphene, silicon, or a plasmonic material.
Aspect 21. The method of any one of Aspects 19-20, wherein the electro-optic material comprises an electro-refractive material, wherein the electro-refractive material comprises one or more of transition metal dichalcogenide, silicon, indium gallium arsenide (InGaAs), or a plasmonic material.
Aspect 22. The method of any one of Aspects 19-21, wherein the electro-optic material comprises a plasmonic material having both the electro-refractive property and electro-absorptive property.
Aspect 23. The method of any one of Aspects 19-22, wherein the electro-optic material comprises transition metal dichalcogenide having both the electro-refractive property and electro-absorptive property at or near an excitonic resonance.
Aspect 24. The method of any one of Aspects 19-23, wherein modulating the phase of the optical signal comprises simultaneously modulating, using the at least one layer, both an index of refraction of the resonator and an insertion loss of the resonator.
Aspect 25. The method of any one of Aspects 19-24, wherein modulating the phase of the optical signal comprises modulating, using the electro-refractive property of the electro-optic material, an index of refraction of the resonator.
Aspect 26. The method of any one of Aspects 19-25, wherein modulating the phase of the optical signal comprises modulating, using the electro-absorptive property of the electro-optic material, an insertion loss of the resonator.
Aspect 27. The method of any one of Aspects 19-26, wherein modulating the phase of the optical signal comprises changing a voltage applied between an electro-refractive portion of the electro-optic material and an electro-absorptive portion of the electro-optic material.
Aspect 28. The method of Aspect 27, wherein the electro-refractive portion comprises a layer of transition metal dichalcogenide and the electro-absorptive portion comprises a layer of graphene.
Aspect 29. The method of any one of Aspects 27-28, wherein changing the voltage applied between the electro-refractive portion of the electro-optic material and the electro-absorptive portion of the electro-optic material comprises changing the voltage to cause a tuning of the coupling of the waveguide and the resonator between being under-coupled and being over-coupled.
Aspect 30. The method of any one of Aspects 19-29, wherein the at least one layer is disposed adjacent the resonator, on the resonator, within the resonator, or a combination thereof
Aspect 31. The method of any one of Aspects 19-30, wherein the at least one layer comprises a monolayer of an electro-refractive material.
Aspect 32. The method of any one of Aspects 19-31, wherein the at least one layer comprises a monolayer of an electro-absorptive material.
Aspect 33. The method of any one of Aspects 19-32, wherein the at least one layer comprises a capacitor structure comprising a first layer having an electro-refractive material, a second layer comprising an insulator, a third layer comprising an electro-absorptive material, a first electrode adjacent the first layer, and a second electrode adjacent the third layer.
Aspect 34. The method of any one of Aspects 19-33, wherein an optical mode of the resonator overlaps at least partially with the electro-optic material.
Aspect 35. The method of any one of Aspects 19-34, wherein the electro-optic material comprises an electro-refractive material and an electro-absorptive material, and wherein the optical mode of the resonator overlaps at least partially with the electro-refractive material and the electro-absorptive material.
Aspect 36. The method of any one of Aspects 19-35, wherein the resonator comprises a ring resonator.
Aspect 37. The method of any one of claims 19-36, wherein the material forming the resonator comprises a passive material (e.g., SiN or AlN), an active material (e.g., bulk silicon or InGaAs), or an electro-optic material (e.g., LiNbO3).
Aspect 38. A system comprising: one or more devices according to any one of Aspects 1-18; and a computing device configured to control the one or more devices to phase modulate optical signals.
Aspect 39. A device comprising: one or more processors; and a memory storing instructions that, when executed by the one or more processors, cause the device to perform the methods of any one of Aspects 19-37.
Aspect 40. A non-transitory computer-readable medium storing instructions that, when executed by one or more processors, cause a device to perform the methods of any one of Aspects 19-37.

### REFERENCES

[1] I. Datta, S. H. Chae, G. R. Bhatt, M. A. Tadayon, B. Li, Y. Yu, C. Park, J. Park, L. Cao, D. N. Basov, J. Hone, M. Lipson, Low-loss composite photonic platform based on 2D semiconductor monolayers, ArXiv190600459 Phys. (2019). http://arxiv.org/abs/1906.00459 (accessed Jul. 10, 2019).
[2] C. T. Phare, Y.-H. D. Lee, J. Cardenas, M. Lipson, Graphene electro-optic modulator with 30 GHz bandwidth, Nat. Photonics. 9 (2015) 511-514. https://doi.org/10.1038/nphoton.2015.122.
[3] Q. Xu, B. Schmidt, S. Pradhan, M. Lipson, Micrometre-scale silicon electro-optic modulator, Nature. 435 (2005) 325-327. https://doi.org/10.1038/nature03569.
[4] S. Akiyama, T. Usuki, High-speed and efficient silicon modulator based on forward-biased pin diodes, Front. Phys. 2 (2014). https://doi.org/10.3389/fphy.2014.00065.
[5] W. M. J. Green, M. J. Rooks, L. Sekaric, Y. A. Vlasov, Ultra-compact, low RF power, 10 Gb/s silicon Mach-Zehnder modulator, Opt. Express. 15 (2007) 17106-17113. https://doi.org/10.1364/OE.15.017106.
[6] S. Akiyama, T. Baba, M. Imai, T. Akagawa, M. Takahashi, N. Hirayama, H. Takahashi, Y. Noguchi, H. Okayama, T. Horikawa, T. Usuki, 12.5-Gb/s operation with 0.29-V·cm VπL using silicon Mach-Zehnder modulator based-on forward-biased pin diode, Opt. Express. 20 (2012) 2911-2923. https://doi.org/10.1364/OE.20.002911.
[7] S. Akiyama, M. Imai, T. Baba, T. Akagawa, N. Hirayama, Y. Noguchi, M. Seki, K. Koshino, M. Toyama, T. Horikawa, T. Usuki, Compact PIN-Diode-Based Silicon Modulator Using Side-Wall-Grating Waveguide, IEEE J. Sel. Top. Quantum Electron. 19 (2013) 74-84. https://doi.org/10.1109/JSTQE.2013.2278438.
[8] M. Webster, K. Lakshmikumar, C. Appel, C. Muzio, B. Dama, K. Shastri, Low-power MOS-capacitor based silicon photonic modulators and CMOS drivers, in: 2015 Opt. Fiber Commun. Conf. Exhib. OFC, 2015: pp. 1-3. https://doi.org/10.1364/OFC.2015.W4H.3.
[9] F. Y. Gardes, D. J. Thomson, N. G. Emerson, G. T. Reed, 40 Gb/s silicon photonics modulator for TE and TM polarisations, Opt. Express. 19 (2011) 11804-11814. https://doi.org/10.1364/OE.19.011804.
[10] C. Wang, C. Langrock, A. Marandi, M. Jankowski, M. Zhang, B. Desiatov, M. M. Fejer, M. Lončar, Ultrahigh-efficiency wavelength conversion in nanophotonic periodically poled lithium niobate waveguides, Optica. 5 (2018) 1438-1441. https://doi.org/10.1364/OPTICA.5.001438.
[11] C. Wang, M. Zhang, B. Stem, M. Lipson, M. Lončar, Nanophotonic lithium niobate electro-optic modulators, Opt. Express. 26 (2018) 1547-1555. https://doi.org/10.1364/OE.26.001547.
[12] C. Wang, M. Zhang, X. Chen, M. Bertrand, A. Shams-Ansari, S. Chandrasekhar, P. Winzer, M. Lončar, Integrated lithium niobate electro-optic modulators operating at CMOS-compatible voltages, Nature. 562 (2018) 101-104. https://doi.org/10.1038/s41586-018-0551-y.
[13] G. Liang, H. Huang, S. Shrestha, I. Datta, M. Lipson, N. Yu, Efficient Pure Phase Optical Modulator Based on Strongly Over-Coupled Resonators, in: Conf. Lasers Electro-Opt. 2019 Pap. STh3H1, Optical Society of America, 2019: p. STh3H.1. https://doi.org/10.1364/CLEO_SI.2019.STh3H.1.
[14] H. Larocque, H. Larocque, L. Ranzani, J. Leatham, J. Tate, A. Niechayev, T. Yengst, T. Komljenovic, C. Fodran, D. Smith, M. Soltani, Beam steering with ultracompact and low-power silicon resonator phase shifters, Opt. Express. 27 (2019) 34639-34654. https://doi.org/10.1364/OE.27.034639.
[15] C. Manolatou, M. J. Khan, S. Fan, P. R. Villeneuve, H. A. Haus, J. D. Joannopoulos, Coupling of modes analysis of resonant channel add-drop filters, IEEE J. Quantum Electron. 35 (1999) 1322-1331. https://doi.org/10.1109/3.784592.
[16] M. J. Strain, C. Lacava, L. Meriggi, I. Cristiani, M. Sorel, Tunable Q-factor silicon microring resonators for ultra-low power parametric processes, Opt. Lett. 40 (2015) 1274-1277. https://doi.org/10.1364/OL.40.001274.

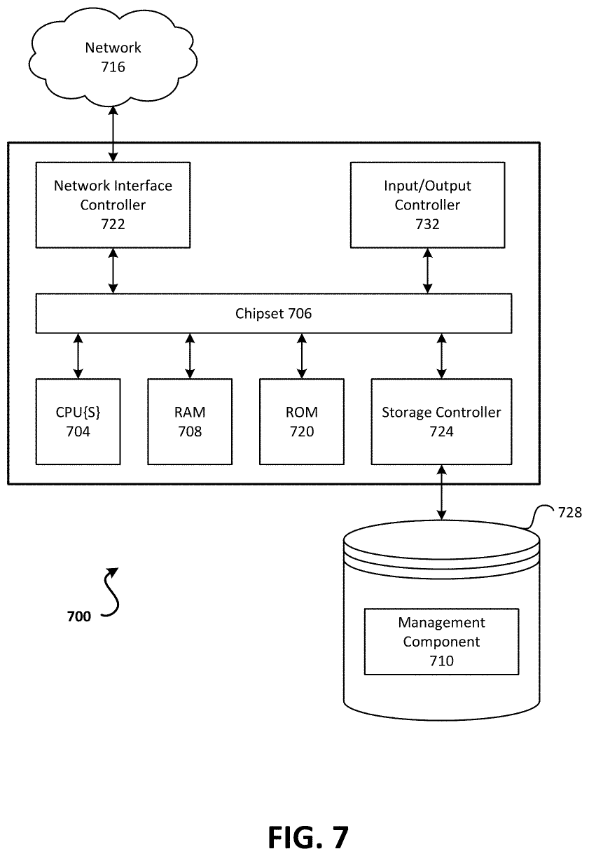

FIG. 7 depicts a computing device that may be used in various aspects, such as to control phase modulation of a device disclosed herein and/or to perform any of the methods described herein. The computer architecture shown in FIG. 7 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 700 may include a baseboard, or “motherboard,” which is a printed circuit board to which a multitude of components or devices may be connected by way of a system bus or other electrical communication paths. One or more central processing units (CPUs) 704 may operate in conjunction with a chipset 706. The CPU(s) 704 may be standard programmable processors that perform arithmetic and logical operations necessary for the operation of the computing device 700.

The CPU(s) 704 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 704 may be augmented with or replaced by other processing units, such as GPU(s) 705. The GPU(s) 705 may comprise processing units specialized for but not necessarily limited to highly parallel computations, such as graphics and other visualization-related processing.

A chipset 706 may provide an interface between the CPU(s) 704 and the remainder of the components and devices on the baseboard. The chipset 706 may provide an interface to a random access memory (RAM) 708 used as the main memory in the computing device 700. The chipset 706 may further provide an interface to a computer-readable storage medium, such as a read-only memory (ROM) 720 or non-volatile RAM (NVRAM) (not shown), for storing basic routines that may help to start up the computing device 700 and to transfer information between the various components and devices. ROM 720 or NVRAM may also store other software components necessary for the operation of the computing device 700 in accordance with the aspects described herein.

The computing device 700 may operate in a networked environment using logical connections to remote computing nodes and computer systems through local area network (LAN) 716. The chipset 706 may include functionality for providing network connectivity through a network interface controller (NIC) 722, such as a gigabit Ethernet adapter. A NIC 722 may be capable of connecting the computing device 700 to other computing nodes over a network 716. It should be appreciated that multiple NICs 722 may be present in the computing device 700, connecting the computing device to other types of networks and remote computer systems.

The computing device 700 may be connected to a mass storage device 728 that provides non-volatile storage for the computer. The mass storage device 728 may store system programs, application programs, other program modules, and data, which have been described in greater detail herein. The mass storage device 728 may be connected to the computing device 700 through a storage controller 724 connected to the chipset 706. The mass storage device 728 may consist of one or more physical storage units. A storage controller 724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 700 may store data on a mass storage device 728 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 728 is characterized as primary or secondary storage and the like.

For example, the computing device 700 may store information to the mass storage device 728 by issuing instructions through a storage controller 724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 700 may further read information from the mass storage device 728 by detecting the physical states or characteristics of one or more particular locations within the physical storage units.

In addition to the mass storage device 728 described above, the computing device 700 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 700.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 728 depicted in FIG. 7, may store an operating system utilized to control the operation of the computing device 700. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 728 may store other system or application programs and data utilized by the computing device 700.

The mass storage device 728 or other computer-readable storage media may also be encoded with computer-executable instructions, which, when loaded into the computing device 700, transforms the computing device from a general-purpose computing system into a special-purpose computer capable of implementing the aspects described herein. These computer-executable instructions transform the computing device 700 by specifying how the CPU(s) 704 transition between states, as described above. The computing device 700 may have access to computer-readable storage media storing computer-executable instructions, which, when executed by the computing device 700, may perform the methods described herein for phase modulation, index modulation, and/or loss modulation.

A computing device, such as the computing device 700 depicted in FIG. 7, may also include an input/output controller 732 for receiving and processing input from a number of input devices, such as a keyboard, a mouse, a touchpad, a touch screen, an electronic stylus, or other type of input device. Similarly, an input/output controller 732 may provide output to a display, such as a computer monitor, a flat-panel display, a digital projector, a printer, a plotter, or other type of output device. It will be appreciated that the computing device 700 may not include all of the components shown in FIG. 7, may include other components that are not explicitly shown in FIG. 7, or may utilize an architecture completely different than that shown in FIG. 7.

As described herein, a computing device may be a physical computing device, such as the computing device 700 of FIG. 7. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

The following sections provide additional examples, features, and information. The disclosed techniques are not limited to these examples only, but are provided for purposes of illustration. Any of the features described below may be combined with any of the features described above.

### ADDITIONAL INFORMATION

Compact, high-speed electro-optic phase modulators play a vital role in various large-scale applications including phased arrays, quantum and neural networks, and optical communication links. Conventional phase modulators suffer from a fundamental tradeoff between device length and optical loss that limits their scaling capabilities. High-finesse ring resonators have been traditionally used as compact intensity modulators, but their use for phase modulation have been limited due to the high insertion loss associated with the phase change. Here, we show that high-finesse resonators can achieve a strong phase change with low insertion loss by simultaneous modulation of the real and imaginary parts of the refractive index, to the same extent. To implement this strategy, we utilize a hybrid platform that combines a low-loss SiN ring resonator with electro-absorptive graphene (Gr) and electro-refractive WSe₂. We achieve a phase modulation efficiency (V_{π/2}·L_{π/2}) of 0.045 V·cm with an insertion loss (IL_{π/2}) of 4.7 dB for a phase change of π/2 radians, in a 25 μm long Gr—Al₂O₃—WSe₂ capacitor embedded on a SiN ring of 50 μm radius. We find that our Gr—Al₂O₃—WSe₂ capacitor can support an electro-optic bandwidth of 14.9±0.1 GHz. We further show that the V_{π/2}·L_{π/2} of our SiN-2D platform is at least an order of magnitude lower than that of electro-optic phase modulators based on silicon, III-V on silicon, graphene on silicon and lithium niobate. This SiN-2D hybrid platform provides the impetus to design compact and high-speed reconfigurable circuits with graphene and transition metal dichalcogenide (TMD) monolayers that can enable large-scale photonic systems.

### INTRODUCTION

Conventional photonic materials used in phase modulators, typically exhibit low index change ranging from 0.01% in lithium niobate (LiNbO₃) to 0.1% for semiconductors such as silicon and III-V (see supplementary section I). This low index change requires hundreds of microns of interaction length for a phase change of π radians¹⁻²⁵. In high-speed intensity modulators^{26,16,27,28}, it is possible to achieve effective modulation in a compact form-factor by using high-finesse ring resonators to increase the interaction length and enhance modulation depth.

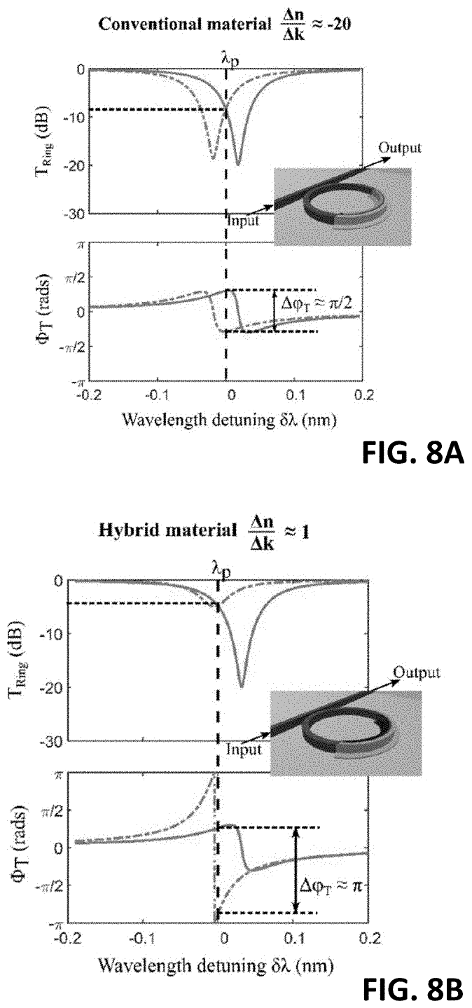

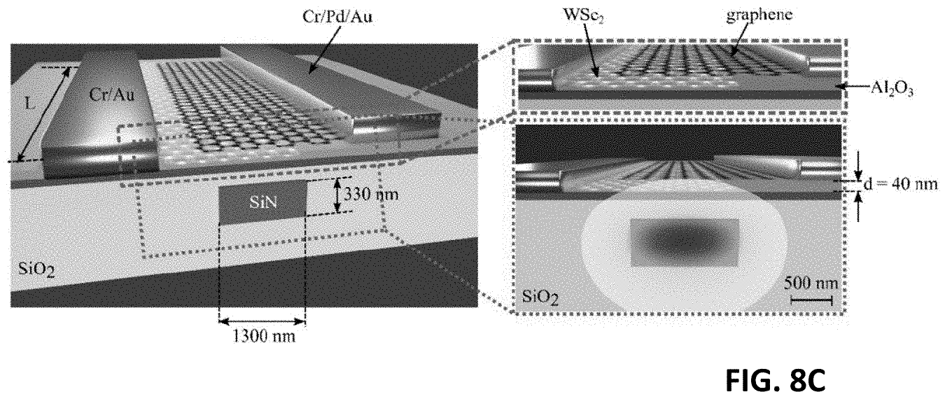

However, high-finesse ring resonators have not been successfully implemented for phase modulation, due to the associated large insertion loss and undesired intensity modulation. This loss arises due to the effect of a large mismatch between the change in real (Δn) and imaginary part (Δk) of the index for conventional materials used for phase modulation in ring resonators. As an example, in FIG. 8A, we show the transmission (T_{Ring}) and phase response (φ_{T}) of a ring resonator embedded with an active material that undergoes a strong change in index i.e.

$$\frac{Δ n}{Δ k} ∼ - 20 ,$$

typically observed in silicon. The ring is critically-coupled with a loaded quality factor (Q_{L}) of ˜20,000 and undergoes a Δn of −6×10⁻⁴ RIU (refractive index units), as is commonly reported in silicon-based electro-refractive modulators²⁸⁻³⁰. The index change in the active material induces a shift in the resonance wavelength of the ring response. At a probe wavelength of λₚ, the cavity experiences a phase change of ˜π/2 radians that is accompanied by an unacceptably high insertion loss of 9 dB. Previous demonstrations have leveraged low-finesse over-coupled ring resonators for phase modulation^{31,32}. However, these modulators require high index change and therefore, must rely on the thermo-optic effect which is an inherently slow and power-hungry mechanism.

Here, we demonstrate an alternative strategy for achieving strong phase change in resonators with low insertion loss and minimal transmission variation. This strategy requires that the ratio of the index change (Δn) to the loss change (Δk) has to be approximately equal to unity, i.e.

$$\frac{Δ n}{Δ k} ∼ 1$$

(see Supplementary section II). In FIG. 8B, we show the T_{Ring} and φ_{T} at the output of a ring resonator utilizing an embedded hybrid active material with

$$\frac{Δ n}{Δ k} ∼ 1 ,$$

operating near the critically-coupled regime with an initial Q_{L} of ˜20000 and a Δn of −6×10⁻⁴ RIU. In this case, Δn causes resonance detuning, while Δk results in an enhancement of the coupling between the ring resonator and the bus waveguide. One can see from the phase profile in FIG. 1B, that these effects transform the φ_{T} from a gradual phase variation near the critically-coupled condition to a strongly dispersive phase profile in the over-coupled regime with a detuning of the resonance wavelength. When probed at λₚ, one can achieve a strong phase change of −π radians with an insertion loss as low as 4.5 dB. However, no known dielectric material exhibits a

$$\frac{Δ n}{Δ k} ∼ 1$$

at near-infrared (NIR) wavelengths.

To enable simultaneous tuning of both the real and imaginary part of the effective index, we utilize a capacitive stack of monolayer tungsten disulphide (WSe₂) and graphene (Gr) integrated in a low-loss dielectric ring resonator. FIG. 1C shows a schematic of the structure consisting of the stack of the 2D materials (Gr—Al₂O₃—WSe₂) embedded on a 1300 nm wide×330 nm high silicon nitride (SiN) waveguide covered with 180±15 nm of planarized silicon dioxide (SiO₂). We tune the electro-optic properties of the 2D materials by applying a voltage across the dielectric alumina (Al₂O₃) that is sandwiched between the two monolayers. Our design benefits from the electro-absorptive properties of Gr³⁴⁻³⁶ (which effectively tunes the ring-bus coupling) and the electro-refractive properties of monolayer transition metal-dichalcogenide (TMD) such as WSe₂³⁷ (which changes the resonance wavelength). The ratio between the real (Δn_{eff}) and imaginary part (Δk_{eff}) of the effective index in a composite SiN-2D waveguide, is determined by the relative overlap of the propagating mode with each of the 2D monolayers. The overlap with Gr influences both the initial propagation loss and Δk_{eff}, while the overlap with the monolayer WSe₂ predominantly contributes to the Δn_{eff}. The bare SiN resonator with a radius of 50 μm, is fabricated with an intrinsic quality factor (Q₀) of ˜112,000 (i.e. α_{SiN}˜5.98±0.38 dB/cm). The ring resonator is designed to achieve critical-coupling with a Q_{L} of ˜20,870 at 8 V, by embedding a 40 μm long Gr—Al₂O₃—WSe₂ capacitor in the ring with a ring-bus gap of 350 nm (hereafter, referred to as device I). The SiO₂-clad SiN waveguides were fabricated using standard techniques, and then planarized to permit the mechanical transfer and lithographic patterning of the Gr—Al₂O₃—WSe₂ capacitor with metal contacts in the SiN ring resonator. We estimate a linear induced charge density of (0.85±0.03)×10¹² cm⁻² per volt on both the monolayers, based on the thickness (45 nm) and the extracted dielectric permittivity of Al₂O₃ (6.9±0.2) (see Methods).

Results

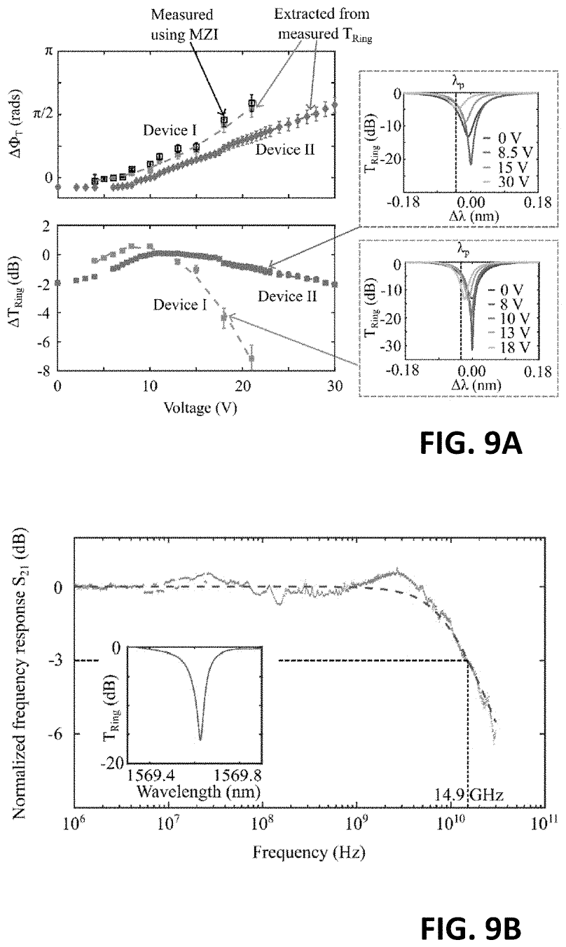

We measure a continuous phase change (Δφ_{T}) of (0.46±0.05) π radians with an insertion loss (IL) of 4.78±0.40 dB. This Δφ_{T}, is accompanied with a transmission variation (ΔT_{Ring}) of 4.37±0.70 dB for an applied voltage swing from 6 V to 18 V. In FIG. 9A, we show using blue square markers, the Δφ_{T} (top panel) and the ΔT_{Ring} (bottom panel) for different voltages applied across the Gr—Al₂O₃—WSe₂ capacitor. We probe the Δφ_{T} and ΔT_{Ring} at a wavelength detuning λₚ, where the phase change is maximum while ensuring a low IL and ΔT_{Ring}. In this case, λₚ is 0.03 nm blue-detuned from the resonance at critical coupling (1538.71 nm). The ΔT_{Ring} for different voltages is normalized with respect to the IL, measured at an initial bias voltage of 6 V. One can confirm from the T_{Ring} spectra of device I in the bottom right inset of FIG. 9A, that the ring is initially in the under-coupled regime at 0 V. As we increase the applied voltage to 8 V, the resonator becomes critically-coupled and at voltages exceeding 10 V, the ring becomes over-coupled with a strong blue detuning of the resonance wavelength (for detailed results, see Supplementary section III).

We measure a 3 dB electro-optic bandwidth of 14.9±0.1 GHz in the composite SiN-2D waveguide. In FIG. 9B, we show the frequency response of device I, which we measure using a 70 GHz fast photodiode and an electrical vector network analyzer (VNA) at 1569.6 nm for a bias voltage of 8 V with a RF voltage swing of 10 dBm. One can see from the measured T_{Ring} at 1569.6 nm in the inset of FIG. 9B, that the optical bandwidth supported by the device at 8 V is 15.8 GHz (Q_{L}˜12000). We ensure that the optical bandwidth supported by the device at 8 V is higher than the measured electro-optic bandwidth (14.9 GHz) that is currently limited by the contact resistance of monolayer Gr and WSe₂ (see supplementary section IV).

We show that the voltage dependent phase and transmission change in ring resonators can be tailored with the device geometry. We engineer the length of Gr—Al₂O₃—WSe₂ capacitor to achieve a similar phase change of (0.50±0.05) 7E radians as observed in device I, while ensuring a comparatively lower IL of 2.96±0.34 dB and low ΔT_{Ring} of 1.73±0.20 dB. The optimized device (hereafter, referred to as device II) consists of a 25 μm-long Gr—Al₂O₃—WSe₂ capacitor embedded in the SiN ring, with a ring-bus gap of 450 nm. The shorter capacitor exhibits lower pin-hole defects that results in an increase of the breakdown voltage from 22 V in device I to 30 V in device II. The high breakdown fields enable a higher degree of transparency in SiN waveguide, thereby facilitating strong tuning of the coupling regime (see Supplementary section V). Similar to the configuration of device I, the ring achieves critical coupling with a Q_{L} of ˜18,730 at 8.5 V. We probe the Δφ_{T} (top panel of FIG. 9A) and ΔT_{Ring} (bottom panel of FIG. 9A) at a λₚ, that is blue detuned by 0.04 nm with respect to the resonance wavelength at critical coupling (1646.22 nm). The Δφ_{T} of the ring are extracted from the measured T_{Ring} for different voltages applied across the capacitor (see Supplementary section VI). We further confirm that the Δφ_{T} extracted from the T_{Ring} is in strong agreement with the Δφ_{T} measured using an external Mach-Zehnder interferometer (MZI) configuration (often used for phase measurements)^{38,39,31}. We measure Δφ_{T} by simultaneously probing both the T_{Ring}, and the transmission at the output of an MZI (T_{MZI}) when device I is embedded in one of the arms of a fiber-based MZI. Supplementary section VII details the experimental setup used for measuring the phase response of our devices, while supplementary section VIII shows the measured T_{Ring} and T_{MZI} at the output of the ring resonator, for different voltages applied across the Gr—Al₂O₃—WSe₂ capacitor.

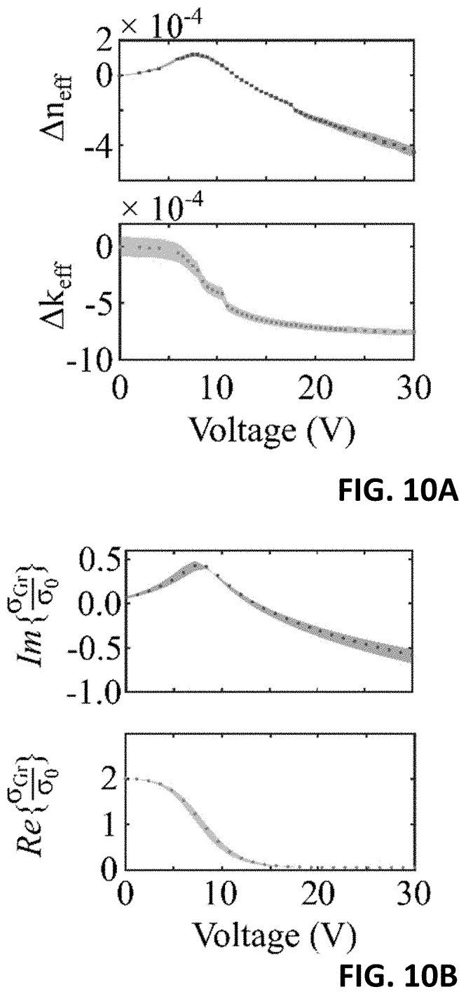

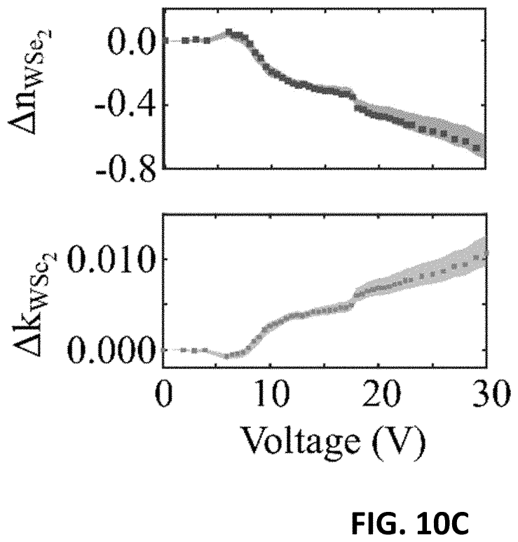

We verify that the ratio between the Δn_{eff} and Δk_{eff} of the composite SiN-2D waveguide is close to unity. FIG. 10A shows the measured Δn_{eff} and Δk_{eff} of the ring, which is extracted from the measured T_{Ring} for various voltages applied across the 25 μm long Gr—Al₂O₃—WSe₂ capacitor in device II (see Supplementary section IX). One can see that the Δk_{eff} decreases progressively with an increase in the gate voltage and Δn_{eff} shows an initial increase leading to a red-shift in the resonance wavelength, followed by a strong decrease which leads to a strong blue detuning. The maximum Δn_{eff} and Δk_{eff} for an applied voltage of 30 V is −6.0×10⁻⁴ RIU and −7.8×10⁻⁴ RIU respectively, which corresponds to a

$$\frac{Δ {n}_{eff}}{Δ {k}_{eff}} ∼ 0.7 8 .$$

We extract the contribution of the electro-optic response of each of the 2D layers to the Δn_{eff} and Δk_{eff}, by modeling the monolayers as a hybrid 2D sheet integrated on a SiN waveguide using finite element model (see Methods and Supplementary Section X). FIG. 10B shows the change in the normalized imaginary and real part of the optical conductivity of monolayer graphene

$$( \frac{{σ}_{G}}{{σ}_{0}} )$$

that imparts a proportional change in the Δn_{eff} and Δk_{eff} of the propagating mode, respectively. From the modeling of the Gr monolayer, we find that the Gr is initially p-doped with (5.20±0.30)×10¹² cm⁻² carriers (i.e. E_{F}_{ᵢₙᵢₜ}=0.240±0.006 eV) and becomes completely transparent at voltages exceeding 25 V. FIG. 10C shows the change in the real and imaginary part of the refractive index of WSe₂ (Δn_{WSe2} and Δk_{WSe2}) as a function of the applied voltage. For a maximum electron doping of (2.54±0.74)×10¹³ cm⁻² at 30 V, the Δn_{WSe2} reaches −0.69±0.05 RIU, while Δk_{WSe}_{₂} (which induces insertion loss) remains below 0.010±0.002 RIU.

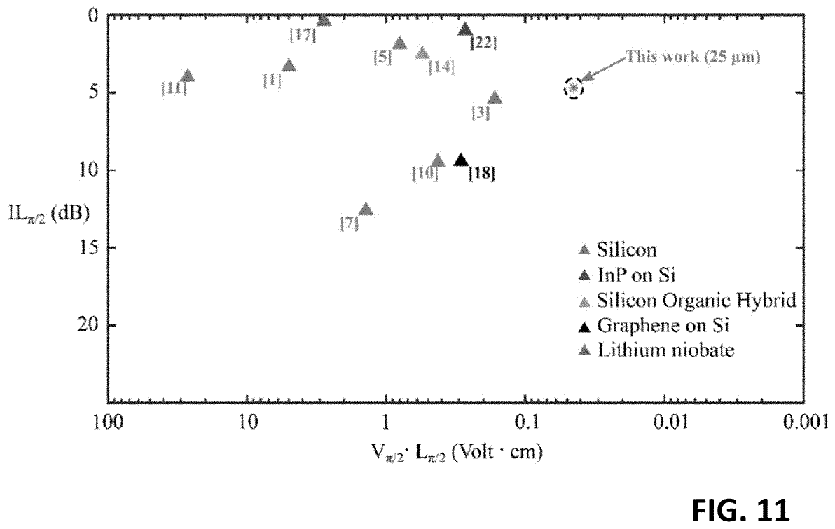

We measure a phase modulation efficiency (V_{π/2}·L_{π/2}) of 0.045 V·cm with an insertion loss (IL_{π/2}) of 4.7 dB for a phase change of π/2 radians. We show in FIG. 11 and Supplementary section XI, that device II performs with a significantly lower V_{π/2}·L_{π/2} (i.e., enhanced phase modulation efficiency) and lower IL_{π/2}, when compared to the existing phase modulation technologies. We find that the V_{π/2}·L_{π/2} for our SiN-2D hybrid platform is at least an order of magnitude lower than the one of electro-refractive phase modulators based on dielectric materials such as silicon PN, PIN and MOS capacitors^{1,3,7,9-11}, III-V on silicone²², graphene on silicon modulators¹⁸ and lithium niobate (LN) devices^{16,17}, and can be achieved with a relatively low IL_{π/2}. In FIG. 11, we show a comparison with current state-of-art phase modulation technologies. One can see that by overcoming the traditional tradeoff between propagation length and insertion loss through simultaneous index and loss modulation in ring resonators, our SiN-2D platform facilitates the development of compact phase modulators with low V_{π/2}·L_{π/2} and minimal optical loss.

The SiN-2D hybrid platform enables the design of compact and highly reconfigurable photonic circuits with tunable coupling and the ability to achieve phase modulation at several gigahertz of electro-optic bandwidth. We show a novel paradigm of designing efficient and compact phase modulators by leveraging cavities embedded with a hybrid material that has a Δn/Δk close to unity. Alternately, one can realize high-speed intensity modulation with low insertion loss using the same SiN-2D platform, by probing the response at the resonance wavelength^{40,41}. The potential of our SiN-2D platform to become transparent with doping and the ability to modify the coupling in cavities at several gigahertz of electro-optic bandwidth enables its use in various applications such as optical memories, frequency combs and optical communication systems⁴¹.

FIGS. 8A-C show a SiN-2D platform leveraging loss and index change for phase modulation. FIG. 8A shows normalized transmission (T_{Ring}) and phase response (φ_{T}) of a ring resonator embedded with a conventional material that undergoes a strong change in index i.e.

$$\frac{Δ n}{Δ k} ∼ - 20.$$

The inset snows me schematic of a ring resonator with a portion (˜8%) of the ring covered with the active conventional material. For a ring operating near the critically-coupled regime with a loaded quality factor (Q_{L}) of ˜20000, the Δn of −6×10⁻⁴ RIU induces a blue shift in the resonance wavelength of the ring response. At a probe wavelength of λₚ, the cavity experiences a strong phase change that is accompanied with a prohibitively high insertion loss. FIG. 8B shows T_{Ring} and φ_{T} of a ring resonator embedded with a hybrid material that undergoes simultaneous index and loss change i.e.

$$\frac{Δ n}{Δ k} ∼ 1.$$

For a similar ring with ˜8% of the ring covered with the hybrid material, with the ring Q_{L} of ˜20000 and a Δn of −6×10⁻⁴ RIU, one can observe a strong blue shift in the resonance wavelength with drastic change in the coupling regime. When probed at λₚ, one can achieve a strong phase change at of ˜π radians with an insertion loss as low as 4.5 dB. FIG. 8C shows a composite SiN-2D hybrid platform with monolayer Gr and WSe₂ to tune the loss and index of SiN waveguide, respectively. Device cross-section showing Gr—Al₂O₃—WSe₂ capacitor, embedded on a 1300 nm wide×330 nm high SiN waveguide. Top right inset shows the Gr—Al₂O₃—WSe₂ parallel plate capacitor configuration which electrostatically gates both the monolayers by applying a voltage across the dielectric. Bottom right inset indicates the position of the monolayer Gr and WSe₂ in the mode-profile of the SiN waveguide.

FIGS. 9A-B show phase measurement and electro-optic bandwidth of SiN-2D hybrid waveguide embedded in a SiN ring resonator. FIG. 9A shows phase change (Δφ_{T} in radians) in the top panel and transmission modulation (ΔT_{Ring} in dB) in the bottom panel at probe wavelength detuning (λₚ), for different voltages applied across two Gr—Al₂O₃—WSe₂ capacitors embedded in a SiN ring resonator of 50 μm radius. The blue markers show the extracted Δφ_{T} and measured ΔT_{Ring} for device I. One can see a continuous phase change (Δφ_{T}) of (0.46±0.05) π radians in device I with an insertion loss (IL) of 4.78±0.40 dB and ΔT_{Ring} of 4.37±0.70 dB for an applied voltage swing from 6 V to 18 V. The orange markers show the extracted Δφ_{T} and measured ΔT_{Ring} for device II. One can see that the device II can enable a Δφ_{T} of (0.50±0.05) π radians with a comparatively lower IL of 2.96±0.34 dB and lower ΔT_{Ring} of 1.73±0.20 dB. The T_{Ring} spectra for device I and II shows that the rings are initially in the under-coupled regime at 0 V, becomes critically-coupled at 8.5 V and enters the over-coupled regime at voltages exceeding 10 V. We further confirm using device I, that the Δφ_{T} extracted from the T_{Ring} correlates strongly with the Δφ_{T} measured using a Mach-Zehnder interferometer (MZI) configuration (see black markers). FIG. 9B shows normalized frequency response (S₂₁) of device I at 1569.6 nm for a bias voltage at 8 V.

FIGS. 10A-C shows change in complex effective index of the mode and relative contribution of the Gr and WSe₂ monolayers. FIG. 10A shows change in the real (top) and imaginary (bottom) part of the effective index (Δn_{eff} and Δk_{eff} in refractive index units (RIU)) of the composite SiN-2D waveguide at different voltages, extracted from the normalized T_{Ring} of device II. The shaded area represents the root-mean-square (r.m.s.) error from the numerical fit³³ (see Supplementary section X). FIG. 10B shows change in the imaginary (top) and real (bottom) part of the normalized optical conductivity of monolayer graphene

$$( \frac{{σ}_{G}}{{σ}_{0}} )$$

that imparts a proportional change in the Δn_{eff} and Δk_{eff} of the propagating mode, respectively. The shaded area includes the r.m.s error in the effective index and the error in the extracted initial doping of monolayer graphene, dielectric permittivity of Al₂O₃ and the variation in the height of the SiO₂ cladding separating the capacitive stack from the SiN waveguide (180±10 nm). FIG. 10C shows change in the real (top) and imaginary (bottom) part of the refractive index of monolayer WSe₂ (Δn_{WSe2} and Δk_{WSe}_{₂} in RIU) with voltage. The shaded region incorporates the r.m.s error in the complex effective index, error in the

$$( \frac{{σ}_{G}}{{σ}_{0}} )$$

of graphene and a ±0.05 nm variation in the thickness of the monolayer WSe₂ (h_{WSe}_{₂}˜0.65 nm)^{42,43}.

FIG. 11 shows a comparison of insertion loss (IL_{π/2}) vs. phase modulation efficiency (i.e. voltage length product (V_{π/2}·L_{π/2}) for various electro-optic phase modulators. We show that the V_{π/2}·L_{π/2} of our device II (0.045 V·cm) is at least an order of magnitude lower than conventional electro-refractive phase modulators based on silicon^{1,3,5,7,10,11}, III-V materials such as InP on silicon²², graphene on silicon¹⁸, slot-based silicon-organic hybrid material¹⁴. Low-loss phase modulation can be achieved by using LN devices^{16,17}, which comes at the expense of a V_{π/2}·L_{π/2} that is almost two-orders of magnitude higher than our device.

### REFERENCES FOR ADDITIONAL INFORMATION

1. Liu, A. et al. A high-speed silicon optical modulator based on a metal—oxide—semiconductor capacitor. Nature 427, 615-618 (2004).
2. Liao, L. et al. High speed silicon Mach-Zehnder modulator. Opt. Express 13, 3129-3135 (2005).
3. Green, W. M. J., Rooks, M. J., Sekaric, L. & Vlasov, Y. A. Ultra-compact, low RF power, 10 Gb/s silicon Mach-Zehnder modulator. Opt. Express 15, 17106-17113 (2007).
4. Chen, H.-W., Kuo, Y. & Bowers, J. E. High speed hybrid silicon evanescent Mach-Zehnder modulator and switch. Opt. Express 16, 20571-20576 (2008).
5. Feng, N.-N. et al. High speed carrier-depletion modulators with 1.4V-cm Vzi, integrated on 0.25 μm silicon-on-insulator waveguides. Opt. Express 18, 7994-7999 (2010).
6. Reed, G. T., Mashanovich, G., Gardes, F. Y. & Thomson, D. J. Silicon optical modulators. Nat. Photonics 4, 518-526 (2010).
7. Thomson, D. J. et al. High contrast 40 Gbit/s optical modulation in silicon. Opt. Express 19, 11507-11516 (2011).
8. Ziebell, M. et al. 40 Gbit/s low-loss silicon optical modulator based on a pipin diode. Opt. Express 20, 10591-10596 (2012).
9. Baehr-Jones, T. et al. Ultralow drive voltage silicon traveling-wave modulator. Opt. Express 20, 12014-12020 (2012).
10. Brimont, A. et al. High-contrast 40& #x2009;& #x2009; Gb/s operation of a 500& #xA0;& #x3BC; m long silicon carrier-depletion slow wave modulator. Opt. Lett. 37, 3504-3506 (2012).
11. Tu, X. et al. 50-Gb/s silicon optical modulator with traveling-wave electrodes. Opt. Express 21, 12776-12782 (2013).
12. Reed, G. T. et al. Recent breakthroughs in carrier depletion based silicon optical modulators. Nanophotonics 3, 229-245 (2013).
13. Xiao, X. et al. High-speed, low-loss silicon Mach-Zehnder modulators with doping optimization. Opt. Express 21, 4116-4125 (2013).
14. Alloatti, L. et al. 100 GHz silicon-organic hybrid modulator. Light Sci. Appl. 3, e173-e173 (2014).
15. Abraham, A., Olivier, S., Marris-Morini, D. & Vivien, L. Evaluation of the performances of a silicon optical modulator based on a silicon-oxide-silicon capacitor. in 11th International Conference on Group IV Photonics (GFP) 3-4 (2014). doi:10.1109/Group4.2014.6961999.
16. Wang, C., Zhang, M., Stern, B., Lipson, M. & LonCar, M. Nanophotonic lithium niobate electro-optic modulators. Opt. Express 26, 1547-1555 (2018).
17. Wang, C. et al. Integrated lithium niobate electro-optic modulators operating at CMOS-compatible voltages. Nature 562, 101 (2018).
18. Sorianello, V. et al. Graphene-silicon phase modulators with gigahertz bandwidth. Nat. Photonics 12, 40-44 (2018).
19. Kieninger, C. et al. Ultra-high electro-optic activity demonstrated in a silicon-organic hybrid modulator. Optica 5, 739-748 (2018).
20. Hiraki, T. et al. Heterogeneously integrated III-V/Si MOS capacitor Mach-Zehnder modulator. Nat. Photonics 11, 482-485 (2017).
21. Han, J.-H. et al. Efficient low-loss InGaAsP/Si hybrid MOS optical modulator. Nat. Photonics 11, 486-490 (2017).
22. Ogiso, Y. et al. Over 67 GHz Bandwidth and 1.5 V Vπ InP-Based Optical IQ Modulator With n-i-p-n Heterostructure. J. Light. Technol. 35, 1450-1455 (2017).
23. Weigel, P. O. et al. Bonded thin film lithium niobate modulator on a silicon photonics platform exceeding 100 GHz 3-dB electrical modulation bandwidth. Opt. Express 26, 23728-23739 (2018).
24. He, M. et al. High-performance hybrid silicon and lithium niobate Mach-Zehnder modulators for 100 Gbit s−1 and beyond. Nat. Photonics 13, 359-364 (2019).
25. Xu, M. et al. High-performance coherent optical modulators based on thin-film lithium niobate platform. Nat. Commun. 11, 3911 (2020).
26. Xu, Q., Schmidt, B., Pradhan, S. & Lipson, M. Micrometre-scale silicon electro-optic modulator. Nature 435, 325-327 (2005).
27. Chen, L., Xu, Q., Wood, M. G. & Reano, R. M. Hybrid silicon and lithium niobate electro-optical ring modulator. Optica 1, 112-118 (2014).
28. Xu, Q., Manipatruni, S., Schmidt, B., Shakya, J. & Lipson, M. 12.5 Gbit/s carrier-injection-based silicon micro-ring silicon modulators. Opt. Express 15, 430-436 (2007).
29. Preble, S. F., Xu, Q. & Lipson, M. Changing the colour of light in a silicon resonator. Nat. Photonics 1, 293-296 (2007).
30. Xu, Q., Dong, P. & Lipson, M. Breaking the delay-bandwidth limit in a photonic structure. Nat. Phys. 3, 406-410 (2007).
31. Liang, G. et al. Efficient Pure Phase Optical Modulator Based on Strongly Over-Coupled Resonators. in Conference on Lasers and Electro-Optics (2019), paper STh3H.1 STh3H.1 (Optical Society of America, 2019). doi:10.1364/CLEO_SI.2019.STh3H.1.
32. Larocque, H. et al. Beam steering with ultracompact and low-power silicon resonator phase shifters. Opt. Express 27, 34639-34654 (2019).
33. Manolatou, C. et al. Coupling of modes analysis of resonant channel add-drop filters. IEEE J. Quantum Electron. 35, 1322-1331 (1999).
34. Wang, F. et al. Gate-Variable Optical Transitions in Graphene. Science 320, 206-209 (2008).
35. Liu, M. et al. A graphene-based broadband optical modulator. Nature 474, 64-67 (2011).
36. Phare, C. T., Lee, Y.-H. D., Cardenas, J. & Lipson, M. Graphene electro-optic modulator with 30 GHz bandwidth. Nat. Photonics 9, 511-514 (2015).
37. Datta, I. et al. Low-loss composite photonic platform based on 2D semiconductor monolayers. Nat. Photonics 14, 256-262 (2020).
38. Cardenas, J. et al. Linearized silicon modulator based on a ring assisted Mach Zehnder inteferometer. Opt. Express 21, 22549-22557 (2013).
39. Aldaya, I., Gil-Molina, A., Fragnito, H. L. & Dainese, P. Time-domain interferometric characterization of nonlinear and thermal-induced phase-shift in silicon waveguides. in 2016 Conference on Lasers and Electro-Optics (CLEO) 1-2 (2016).
40. Datta, I. et al. Platform for ultra-strong modulation in hybrid silicon nitride/2D material photonic structures. in Conference on Lasers and Electro-Optics (2020), paper SF2J.4 SF2J.4 (Optical Society of America, 2020). doi:10.1364/CLEO_SI.2020.SF2J.4.
41. Datta, I., Gordillo, O. A. J., Chae, S. H., Hone, J. & Lipson, M. Platform for electrically reconfigurable ring resonator based on TMD-graphene composite waveguides. in Conference on Lasers and Electro-Optics (2021), paper STh5B.1 STh5B.1 (Optica Publishing Group, 2021). doi:10.1364/CLEO_SI.2021.STh5B.1.
42. Fang, H. et al. High-Performance Single Layered WSe₂ p-FETs with Chemically Doped Contacts. Nano Lett. 12, 3788-3792 (2012).
43. Li, Z. et al. Layer Control of WSe₂ via Selective Surface Layer Oxidation. ACS Nano 10, 6836-6842 (2016).
44. Liu, F. et al. Disassembling 2D van der Waals crystals into macroscopic monolayers and reassembling into artificial lattices. Science 367, 903-906 (2020).
45. Zhu, Y. et al. Monolayer Molybdenum Disulfide Transistors with Single-Atom-Thick Gates. Nano Lett. (2018) doi:10.1021/acs.nanolett.8b01091.
46. Ji, X. et al. Ultra-low-loss on-chip resonators with sub-milliwatt parametric oscillation threshold. Optica 4, 619-624 (2017).

Methods

WSe2 Transfer and Patterning

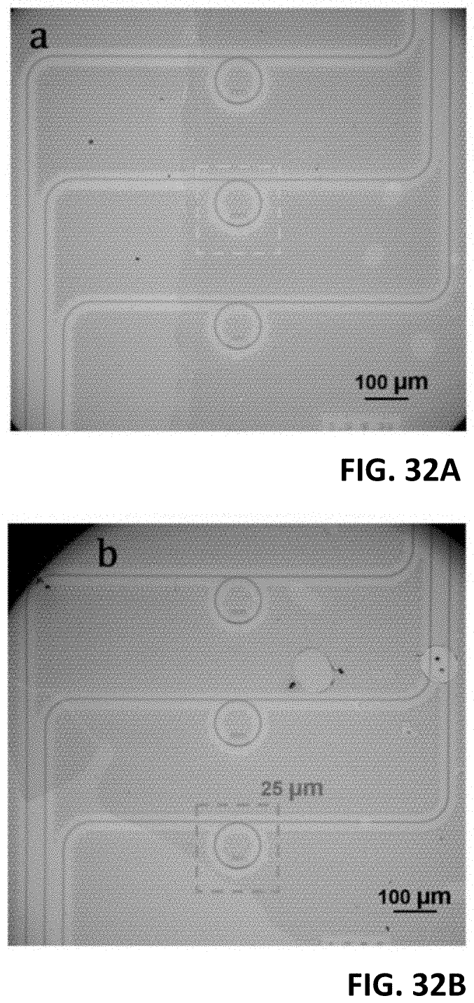

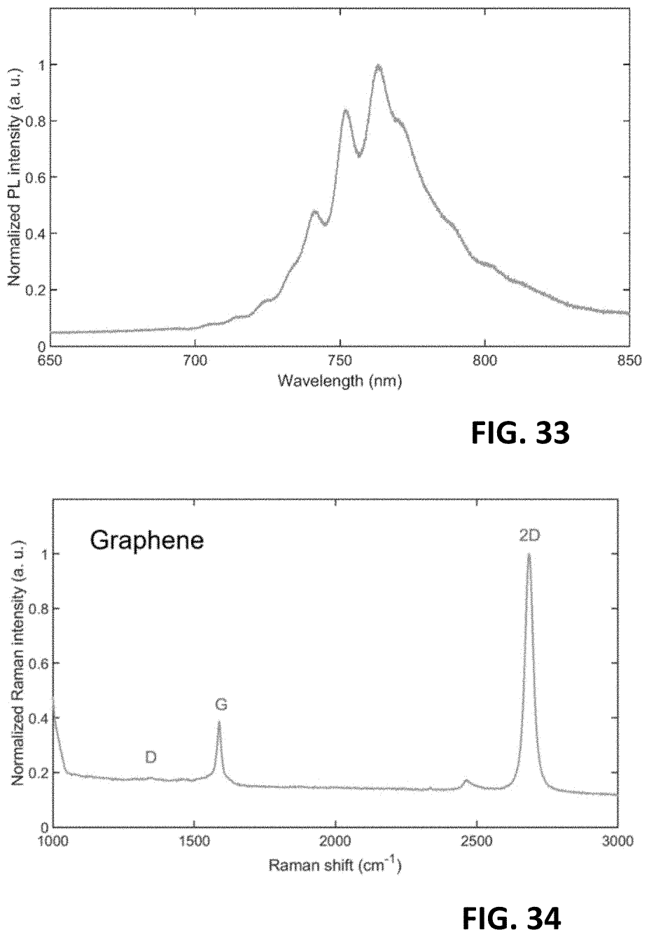

We leverage the facile method described in Ref⁴⁴ to exfoliate large-area monolayer WSe₂ onto our SiN waveguides, covered with 180 nm of planarized SiO₂. We start with an atomically flat gold film, deposited by evaporating 150 nm thin Au films onto an ultra-flat surface of highly polished silicon wafer, where the gold film is stripped away off the substrate using a combination of the thermal release tape with a polyvinylpyrrolidone (PVP) interfacial layer. The ultra-flat gold tape allows for a uniform contact between the gold and monolayer WSe₂ crystal surface (HQ Graphene—http://www.hqgraphene.com/WSe2.php), exfoliating a complete monolayer that can be transferred onto our planarized SiN waveguides. We remove the thermal release tape by heating our substrate to 100° C., washing off the PVP layer and etching the gold with a mild solution of gold etchant (I₂/I⁻). FIGS. 32A-B show the extent of the coverage of monolayer WSe₂ after the gold assisted transfer of WSe₂ onto our planarized SiN substrates. FIG. 33 shows the photoluminescence (PL) spectrum of as transferred monolayer WSe₂ on our SiO2 covered SiN substrate using a Renishaw InVia Micro-Raman spectrometer at an excitation wavelength of 532 nm.

We pattern a 50 μm long WSe₂ monolayer by spinning a dual resist mask of 400 nm/120 nm PMMA/HSQ (XR-1561 6%) film, followed by baking the pattern at 180° C. for 15 mins (PMMA)/4 mins (HSQ), respectively, patterning using EBL and reactive ion etching (RIE) based O₂ plasma treatment for 4 min 30 secs to etch the residual PMMA and monolayer WSe₂. After the etch, we strip the resist in acetone, where it dissolves the PMMA, cleanly removing the HSQ mask.

Graphene Transfer and Patterning

We use chemical vapor deposited (CVD) graphene grown on 3-inch×3-inch copper films (e.g., Grolltex). We prepare the graphene samples for transfer by first spinning PMMA 495 A6 at 1000 rpm and drying the 500 nm PMMA coated graphene on Cu film overnight in ambient conditions. We electrochemically delaminate the PMMA/graphene stack from the Cu film using the process described in Ref⁴⁵. We prepare 1M NaOH aqueous solution as an electrolyte and delaminate the PMMA/Gr stack by using the PMMA/Gr on Cu foil as the cathode, and a bare Cu foil as the anode. The delaminated PMMA/Gr stack is then transferred to a fresh water bath and this process is repeated a few times, before being transferred onto the SiN substrate. We enhance the hydrophilicity of the substrate and remove moisture/polymer contamination by performing O₂ plasma clean on the sample for 30 minutes prior to the transfer. Following the transfer, we vacuum dry the as transferred sample overnight in a vacuum desiccator, followed by baking the sample at 180° C. for 2 hours. Finally, the PMMA is dissolved away in acetone solution by submerging the chip in acetone for about 4 hours. FIG. 34 shows the Raman spectra of the top graphene sheet after the transfer.

We pattern a 25 μm/40 μm long graphene monolayer by spinning a composite resist mask of 400 nm/120 nm PMMA/HSQ (XR-1561 6%) film, followed by baking the pattern at 180° C. for 15 mins (PMMA)/4 mins (HSQ), respectively, patterning using EBL and reactive ion etching (RIE) based O₂ plasma treatment for 1 min 30 secs to etch the residual PMMA and graphene. After the etch, we strip the resist in acetone, where it dissolves the PMMA, cleanly removing the HSQ mask.

Device fabrication for Gr—Al₂O₃—WSe₂ based capacitive SiN photonic device.

We lithographically defined 1.3 μm wide waveguides on 330 nm high silicon nitride (SiN), deposited using Low Pressure Chemical Vapor Deposition (LPCVD) at 800° C. and annealed at 1200° C. for 3 hours on 4.2 μm thermally oxidized SiO2, using a combination of deep ultraviolet (DUV) lithography to define the chemical planarization (CMP) pillars of 5 μm length×5 μm width, with 33% fill factor in the wafer area, surrounding the waveguides and ebeam lithography (EBL) to define the waveguides. In order to obtain low-loss SiN waveguides at near infrared (NIR) wavelengths, we leverage an optimized etch recipe, described in Ref₄₆ to reduce the surface roughness of SiN waveguides that contributes to the propagation loss in low confinement SiN waveguides. We etch the SiN waveguides and CMP patterns using an optimized CHF₃/O₂ recipe with increased oxygen flow to reduce in situ polymer formation in Oxford 100 Plasma ICP RIE, using 360 nm of PECVD SiO2 as a hard mask for etching the SiN thin film. We remove the residual SiO2 hard mask using a 100:1 buffered oxide etch solution (BOE) to reduce the roughness due to etch, followed by deposition of 600 nm of Plasma Enhanced Chemical Vapor Deposition (PECVD) silicon dioxide (SiO₂) on the waveguides for planarization. We planarize the SiO2 to 180 nm±15 nm above the SiN waveguides using standard CMP techniques to create a planar surface for the transfer of monolayer TMD such as WSe₂ and to prevent the WSe₂ film from breaking at the waveguide edges. We clean the planarized surface with Piranha solution at 100 C to remove the slurry particles that settle during CMP process. The 180 nm SiO₂ layer additionally aids in reducing the optical propagation loss introduced by the interaction of the undoped graphene monolayer with the optical mode. A 15 nm of sacrificial thermal atomic layer-deposited (ALD) alumina (Al₂O₃) is deposited on top of SiO2 to isolate the SiN waveguides from the subsequent fabrication steps required for the patterning of monolayer TMDs. Following the WSe₂ transfer and patterning steps described above, the metal contacts are lithographically patterned using EBL, and 0.5 nm/30 nm/80 nm of Cr/Pd/Au was deposited using electron-beam evaporation, followed by liftoff in acetone. The metal contacts to WSe₂ monolayer are placed at a distance of 1.5 μm away from the SiN waveguide, in order to reduce the propagation loss and minimize sheet resistance. A 10 nm/35 nm (100 loops/375 loops) layer of thermal ALD Al₂O₃ at 200°/270° C. is then deposited to form the dielectric of the Gr—Al₂O₃—WSe₂ capacitor. In order to reduce the metal-WSe₂ contact resistance, we anneal the SiN waveguide with Al₂O₃ covered WSe₂ at 270° C. for 4 hours in vacuum. We then transfer and pattern monolayer graphene, as described in the section above, followed by vacuum annealing the composite Gr—Al₂O₃—WSe₂ on SiN waveguide at 275° C. for 4 hours in vacuum to remove PMMA residue left on graphene monolayer after the transfer and patterning. Following this, the metal contacts to the graphene layer is patterned using EBL and 5 nm/20 nm/50 nm of Cr/Pd/Au is then deposited using electron-beam evaporation, followed by liftoff in acetone. Similar to the metal placement configuration on WSe₂ monolayers, the metal contacts are placed at an offset of 1.5 μm from the SiN waveguide. Finally, we define and wet etch (100:1 BOE) the vias to open the metal electrodes in contact with WSe₂, for testing. We achieve high electro-optic bandwidth in our devices by optimizing the graphene transfer process, involving multiple annealing steps in our device fabrication, depositing a 45 nm thick dielectric that minimizes pin-hole defects and finally optimizing the metal contacts to both the monolayer to reduce the contact resistance.

Optical Sheet Conductivity of Monolayer WSe₂ and Graphene.

We use the 2D sheet conductivity model to extract the electro-optic response of monolayer Gr and monolayer semiconductor WSe₂, as is commonly done when modelling graphene monolayers. The change in real part of the effective index of the composite SiN-2D waveguide (Δn_{eff}) in the top panel of FIG. 10A is a combination of the electro-refractive response of graphene i.e.

$$Im \{ \frac{{σ}_{G}}{{σ}_{0}} \}$$

and monolayer WSe₂ (Δn_{WSe2}). We predominantly attribute the change in the imaginary part of the effective index (Δk_{eff}) in the bottom panel of FIG. 10A, to the change in real part of the normalized complex conductivity i.e.

$$Re \{ \frac{{σ}_{G}}{{σ}_{0}} \}$$

of graphene with voltage. In accordance with the relation in equation (A1), the

$$Re \{ \frac{{σ}_{G}}{{σ}_{0}} \}$$

is related to the imaginary part of dielectric permittivity, that contributes to absorption, whereas the

$$Im \{ \frac{{σ}_{G}}{{σ}_{0}} \}$$

is related to the real part of dielectric permittivity, that contributes to the change in index of monolayer graphene.

σ_{G}(ω)=jωt_{d}ε₀(ω)−1) (A1)

Since the electro-optic response of graphene predominantly affects the Δk_{eff}, we extract the normalized sheet conductivity of monolayer graphene as a function of applied voltage, by comparing the measured Δk_{eff} in our experiments to the simulated change obtained using COMSOL Multiphysics finite element model. We model the monolayer graphene as a conductive sheet, with surface charge density (J=σ_{G}(ω)·E), with conductivity given by equation (A3). The optical properties of graphene can be tuned by doping graphene electrostatically [47], [48] i.e. by applying a voltage across the Gr—Al₂O₃—WSe₂ capacitor. The doping of graphene induces a shift in the fermi energy level of graphene (E_{F}), given by

$${E}_{F} = ℏ {v}_{F} \sqrt{( π ( \frac{{ε}_{0} {ε}_{R} V}{de} + {n}_{initial} ) )} \qquad ( A 2 )$$

where, ε₀ is the vacuum permittivity, ε_{R} is the relative permittivity of the dielectric Al₂O₃ separating the two monolayers, e is the electronic charge, ν_{F} is the fermi velocity in graphene, and nᵢₙᵢₜᵢₐₗ is the initial chemical doping of the graphene layer (which is dependent on the processing of graphene and on the substrate). The normalized optical conductivity of graphene

$$( \frac{{σ}_{G}}{{σ}_{0}} )$$

is related to the fermi level through the following equation

$$\frac{{σ}_{G} ( ω )}{{σ}_{0}} = \frac{1}{2} ( tanh ( \frac{ℏ ω + 2 {E}_{F}}{4 {k}_{B} T} ) + tanh ( \frac{ℏ ω - 2 {E}_{F}}{4 {k}_{B} T} ) - \frac{i}{π} ( log ( \frac{{( ℏ ω + 2 {E}_{F} )}^{2}}{{( ℏ ω - 2 {E}_{F} )}^{2} + {( 2 {k}_{B} T )}^{2}} ) ) + \frac{i 8}{π} ( \frac{{E}_{F}}{ℏ ω + i ℏ Υ} ) ) \qquad ( A 3 )$$

where σ₀ is the universal conductivity of graphene, h is the reduced Planck's constant, ω is the optical frequency, k_{B} is the Boltzmann constant, T is the temperature and γ is the intra-band carrier relaxation rate, assumed to be 100 fs, as predicted for similar structures. We find from our simulations that the graphene is initially p-doped with (5.2±0.3)×10¹² cm⁻² carriers (E_{Finit}=0.24±0.006 eV)) and the slope of Δk_{eff} indicates that the εᵣ=6.9±0.2. We model monolayer WSe₂, similar to graphene and is explained in detail in Ref [39]. We extract a change of ˜18% in the refractive index of monolayer WSe₂ with an electron doping density of (2.54±0.74)×10¹³ cm⁻² at 30 V.

Supplementary Information

Section I: Electro-optic coefficient and phase shifter length in conventional photonic platforms

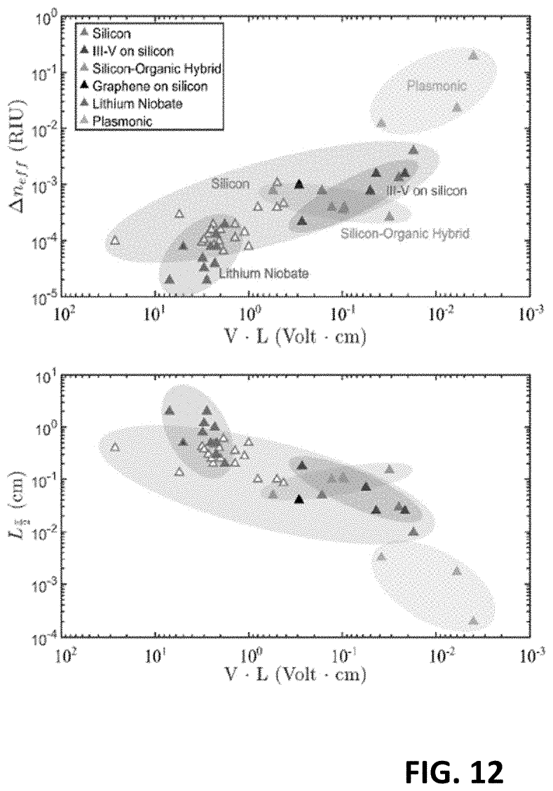

FIG. 12 shows Effective index change (Δn_{eff}) and length required for π/2 phase shift

$$( {L}_{\frac{π}{2}} )$$

for phase modulators based on bulk, plasmonic and 2D material. Conventional semiconductor materials such as silicon (Si)[1]-[20], silicon-organic hybrid[21]-[24], graphene on Si[25], and III-V on Si[26]-[29] exhibit Δn_{eff} in the range 10⁻⁴ to 10⁻³ RIU (refractive index units), requiring device lengths that span from ˜100 μm in the injection mode to ˜1 cm for the phase modulator operating in the depletion mode. Silicon phase modulators based on PN, PIN, MOS and III-V on Si achieve phase change by altering the carrier concentration in the silicon waveguide. However, introducing carriers influences both the real and imaginary part of the index, which alters phase at the expense of high transmission modulation and insertion loss. On the other hand, high-speed and low-loss phase change relies on the induced electro-optic χ⁽²⁾ effect in lithium niobate (LiNBO₃) that has Δn_{eff} in the range 10⁻⁵ to 10⁻⁴ RIU, thereby requiring several millimeters of device length for π/2 phase change[30]-[35]. This fundamental tradeoff between the phase shifter length and optical loss limits the scalability of large-scale systems including light detection and ranging (LIDAR), quantum and optical neural networks and optical communication link. Ultra-compact, micron-scale efficient phase modulators can be engineered using plasmonic materials with very high Δn_{eff}; however, these modulators suffer from extremely high insertion loss[36]-[38]. In this figure, we have considered devices with electro-optic speed exceeding 100 MHz, excluding our work on TMD based modulators[39].

Section II: Effect of various Δn/Δk on the transmission and phase response of microring resonator.

Mathematical Principle

We achieve strong phase change with low optical loss, by switching the coupling regime in ring resonator from the slightly under-coupled (UC) to the highly perturbative over-coupled (OC) regime. The change in the coupling regime transforms the ring phase response from the gradual profile in the UC condition to the strongly dispersive response in the OC configuration. Here, we find the condition that enables a strong phase change of π radians with minimal transmission modulation, while changing the coupling regime in a ring resonator. We use the analytical expression for the ring transmission from Ref [40], to show the ring transmission response in the UC and OC condition (equation (1) and (2), respectively):

$${T}_{{Ring}_{UC}} ( ω ) = {e}^{- j β d} ( 1 - \frac{2 / {τ}_{{e}_{UC}}}{j ( ω - {ω}_{{0}_{UC}} ) + 1 / {τ}_{{0}_{UC}} + 1 / {τ}_{{e}_{UC}}} ) \qquad ( II - 1 )$$

$${T}_{{Ring}_{OC}} ( ω ) = {e}^{- j β d} ( 1 - \frac{2 / {τ}_{{e}_{OC}}}{j ( ω - {ω}_{{0}_{OC}} ) + 1 / {τ}_{{0}_{OC}} + 1 / {τ}_{{e}_{OC}}} ) \qquad ( II - 2 )$$

where, ω₀_{_{UC}} and ω₀_{_{OC}} is the resonant frequency, 1/τ₀_{_{UC}} and 1/τ₀_{_{OC}} are the decay rates due to the loss in the cavity and 1/τₑ_{_{UC}} and 1/τₑ_{_{OC}} are the rates of decay between the bus and ring for the ring in the UC and OC condition, respectively. Since, the coupling between the ring resonator and waveguide is usually a fixed quantity, predominantly determined by the geometry and fabrication of the photonic circuit, one can assume that the 1/τₑ_{_{UC}}≈1/τₑ_{_{OC}}=1/τₑ. In order to obtain a phase shift of it radians with minimal transmission modulation between the two coupling regimes at a probe wavelength λₚ (ωₚ), the following two conditions must be satisfied:

$$∠ \frac{{T}_{{Ring}_{OC}} ( {ω}_{p} )}{{T}_{{Ring}_{UC}} ( {ω}_{p} )} = π ; and \qquad CONDITION I$$

$$\vert \frac{{T}_{{Ring}_{OC}} ( {ω}_{p} )}{{T}_{{Ring}_{UC}} ( {ω}_{p} )} \vert \approx 1 \qquad CONDITION II$$

Using the two conditions and modifying equation (II-1) and (II-2), we get

$$\frac{{T}_{{Ring}_{OC}} ( {ω}_{p} )}{{T}_{{Ring}_{UC}} ( {ω}_{p} )} = \frac{1 - \frac{2 / {τ}_{e}}{j ( {ω}_{p} - {ω}_{{0}_{UC}} ) + 1 / {τ}_{{0}_{UC}} + 1 / {τ}_{e}}}{1 - \frac{2 / {τ}_{e}}{j ( {ω}_{p} - {ω}_{{0}_{OC}} ) + 1 / {τ}_{{0}_{OC}} + 1 / {τ}_{e}}} \approx - {e}^{j π} \qquad ( II - 3 )$$

Solving for equation (II-3), we find the relation shown in equation (II-4) that establishes the connection between ω₀_{_{UC}}, ω₀_{_{OC}}, 1/τ₀_{_{UC}} and 1/τ₀_{_{UC}}.

j(ωₚ−ω₀_{_{OC}})+1/τ₀_{_{OC}}≈j(ωₚ−ω₀_{_{UC}})+1/τ₀_{_{UC}}

k(ω₀_{_{UC}}−ω₀_{_{OC}})≈1/τ₀_{_{UC}}−1/τ₀_{_{OC}} (II-4)

Further simplifying equation (II-4), and substituting ω=2πc/λ and 1/τ=αc/ng=2πkc/λn_{g}, where α=2πk/λ is the loss in the ring with k being the imaginary part of the refractive index of the waveguide, we get equation (II-5):

j(2πc/λ₀_{_{UC}}−2πc/λ₀_{_{OC}})≈2πk_{UC}c/λ₀_{_{UC}}n_{g}−2πk_{OC}c/λ₀_{_{OC}}n_{g} (II-5)

Here, we can assume that Δλ=λ₀_{_{UC}}−λ₀_{_{OC}}<<λ₀_{_{UC}}, λ₀_{_{OC}} and λ₀_{_{UC}}, λ₀_{_{OC}}≈λ₀ with the group index n_{g} remaining constant for both the UC and OC condition. Substituting, we find that equation (II-5) simplifies to,

j(2πcΔλ/λ₀²)≈2πc(k_{UC}−k_{OC})/λ₀n_{g}

j(Δλn_{g}/λ₀)≈(k_{UC}−k_{OC}) (II-6)

The relative change in resonance wavelength Δλ/λ₀ is an effect of the change in real part of the index of the waveguide (Δn) with the coupling, the relation being Δn=n_{OC}−n_{UC}=Δλn_{g}/λ₀.

Equation (II-6) and (II-7) shows the relation between the change in the real (Δn) and imaginary part (Δk) of the index of the waveguide for a strong phase shift of π radians with minimal transmission modulation at probe wavelength λₚ=λ₀:

j(Δn)≈(Δk) (II-7)

One can therefore see that only when the change in real part of the index is approximately equal to the change in imaginary part, one can leverage rings to accomplish this strong phase change with minimal transmission modulation.

Requirement of a moderately high-Q microring resonator.

From taking the absolute of the relation in equation (II-6), one can find a relation between the Δn and quality factor of the ring (Q) required to achieve this phase change, i.e. |Δn|≈|Δk|, where k=n_{g}/2Q₀ and thereby, Δk=n_{g}/2Q₀²ΔQ₀,

|Δn|≈|n_{g}/2Q₀²ΔQ₀| (II-8)

For a ring in the UC regime, the coupling rate between the bus waveguide and ring resonator 1/τₑ is much smaller than the photon decay rate in the cavity 1/τ₀_{_{UC}}, i.e. 1/τₑ<1/τ₀_{_{UC}}. On the other hand, the two decay rates for the over-coupled condition are related through lire 1/τₑ>1/τ₀_{_{OC}}. For a bus-ring coupled system with a constant 1/τₑ set by device fabrication, lowering the losses in the cavity induces the relation 1/τ₀_{_{OC}}<1/τ₀_{_{UC}} between the two photon decay rates in the UC and OC regime. In the limit where Q₀_{_{OC}}>>Q₀_{_{UC}}, the equation (II-8) simplifies to

|Δn|≈|n_{g}(Q₀_{_{OC}}−Q₀_{_{UC}})/2Q₀_{_{UC}}²| (II-9)

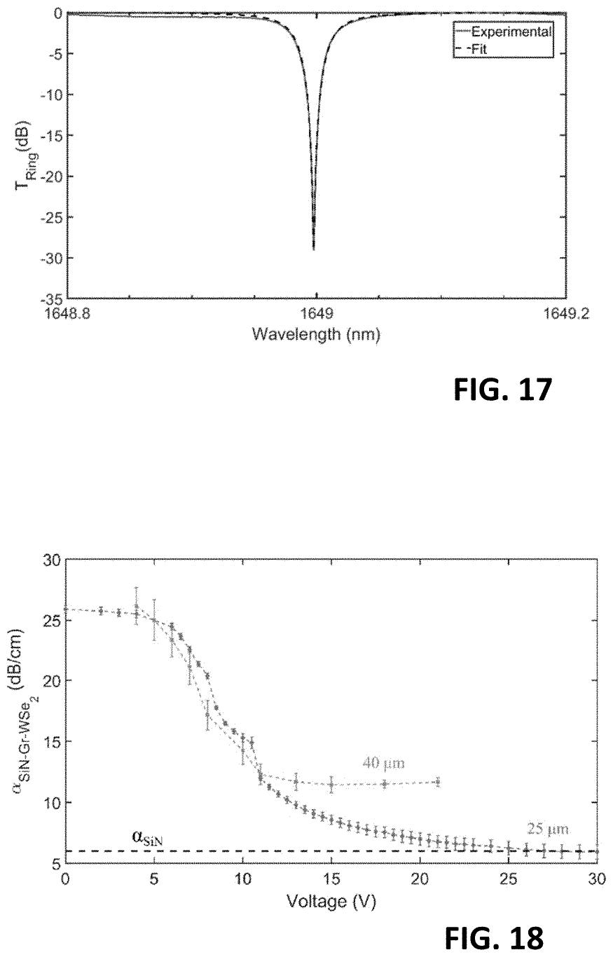

The relation between Δn and Q clearly shows that as one lowers the quality factor of the ring, the change in the real part of the index has to be substantially increased to achieve strong phase change. According to equation (II-7), one can see that the sign of Δn and Δk has to be same, which suggests that if Δn is negative, the Δk has to be negative too. A negative Δk suggests that as we dope the material, the material become less lossy. Since the material turns transparent with doping, we assume that the Q₀_{_{OC}}. becomes comparable to the Q₀ for a bare SiN waveguide with doping. In our case, we measure Q₀ is ˜112,000 (see FIG. 17). The equation II-9 further simplifies to

|Δn|≈|n_{g}(Q₀_{_{OC}})/2Q₀_{_{UC}}²| (II-10)

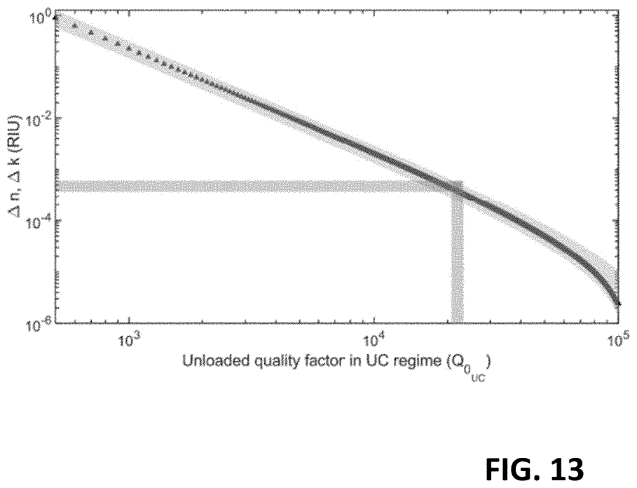

FIG. 13 shows the Δn and Δk required to achieve the strong phase change with low transmission modulation, for SiN rings with n_{g}=2.01 (measured in our devices), Q₀_{_{OC}}≈112,000 as a function of various unloaded quality factor Q₀_{_{UC}}. One can see that the Δn, Δk required increases with lower Q₀_{_{UC}}, which can be explained from equation (II-9). Larger the difference between Q₀_{_{UC}} and Q₀_{_{OC}}, larger is the Δn required for the operation of ring based phase modulator. However, despite significantly low Δn, Δk required for higher Q₀_{_{UC}}, the high Q₀_{_{UC}} significantly limits the operating electro-optic bandwidth of the ring. If we consider an achievable Δn, Δk in the range ˜−4 to −6×10⁻⁴ (RIU), we find from our simulations that the unloaded Q₀_{_{UC}} of our device has to be between 20,000-28,000. In this paper, we achieve a compromise between the Q₀_{_{UC}} and low Δn, Δk, by designing our rings to operate with a unloaded quality factor of Q₀_{_{UC}}˜28,000 and a loaded quality factor Q_{L}˜18000 in the slightly under-coupled regime, that necessitates our platform to achieve a Δn, Δk˜−6×10⁻⁴ (RIU) as shown using the blue lines in the figure.

FIG. 13 shows change in the real (Δn) and imaginary part (Δk) of the refractive index of the waveguide, required for strong phase change with minimal transmission modulation, as a function of different unloaded quality factor (Q₀_{_{UC}}) of the ring operating in the slightly under-coupled regime. One can see that Δn, Δk required increases with lower Q₀_{_{UC}}, which can be explained from equation (II-10). Larger the difference between Q₀_{_{UC}} and Q₀_{_{OC}}, larger is the change required for the operation of ring based phase modulator. Despite significantly low Δn, Δk required for higher Q₀_{_{UC}}, the high Q₀_{_{UC}} significantly limits the electro-optical bandwidth of the ring. In this paper, we achieve a compromise between the Q₀_{_{UC}} and low Δn, Δk, by designing our rings to operate with a Q₀_{_{UC}}˜28000 with Q_{L}˜18000, as shown using the blue lines in the figure.

Numerical Simulation—Implication of the sign of Δn/Δk.

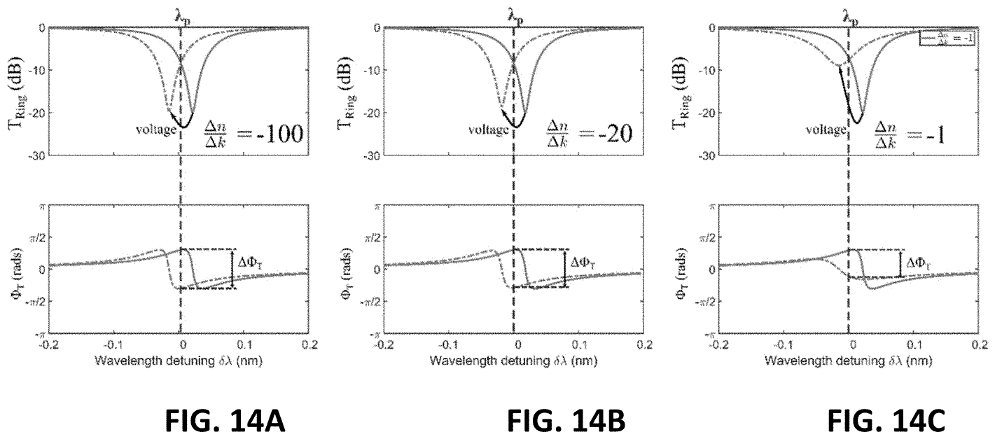

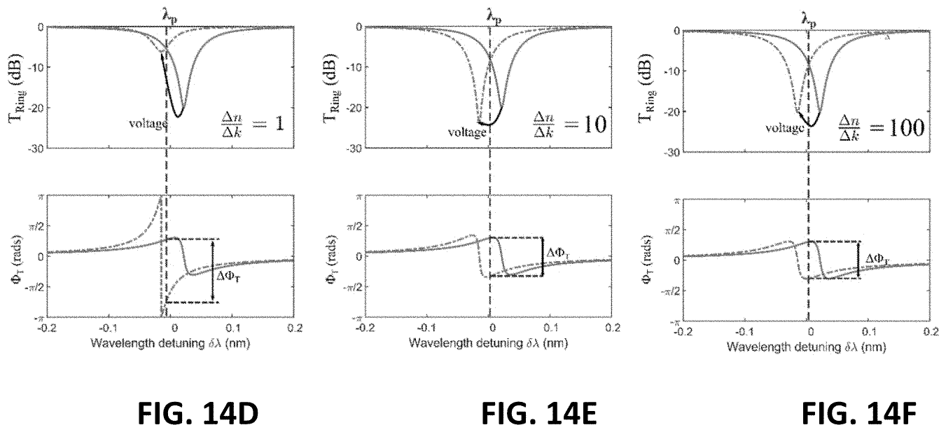

FIGS. 14A-F show the effect of varying degree of loss and index modulation on the transmission and phase response at the output of a ring resonator coupled to a bus waveguide. We show here that the sign of Δn/Δk is an important metric for the operating regime of the compact phase shifter. One can see that the maximum phase modulation of Δφ_{T} is observed in a ring resonator embedded with a hybrid material exhibiting

$$\frac{Δ n}{Δ k} = 1.$$

We show in FIGS. 14A-F, the effect of a voltage dependent Δk and Δn modulation on the normalized transmission response (T_{Ring}) and phase response (ϕ_{T}) at the output of a ring resonator. We model the ring resonator configuration, assuming an initial condition where the intrinsic quality factor (Q₀) of the ring is ˜28000 and the loaded quality factor (Q_{L}) is ˜18,000 in the under-coupled regime, with approximately 8% of the ring covered with an electro-optic material of varying Δn/Δk. The ring resonator is designed to operate in the under-coupled regime, close to critical coupling i.e.

$$( \frac{1}{{τ}_{0}} \sim \frac{1}{{τ}_{e}} )$$

so as to benefit from the high-finesse nature of optical cavities. We assume a fixed maximum voltage induced change in Δn of −6×10⁻⁴ RIU, which is typical of most electro-optic materials[3]-[5], [8]. The varying Δn/Δk influences Δk, which changes the absorption in the ring resonator. This in turn modulates the coupling between the bus waveguide and the resonator which alters the phase profile at the output of the ring.

We show in FIG. 14A, 14B, 14C the effect of a voltage dependent negative Δn/Δk on the T_{Ring} and ϕ_{T} of the ring resonator. Due to a negative Δn/Δk and a negative Δn, the induced Δk is positive, which implies that the loss in the ring increases with the applied voltage. In FIG. 14A, we see that for

$$\frac{Δ n}{Δ k} \sim - 100 ,$$

the T_{Ring} and ϕ_{T} shows a strong shift in the resonance wavelength due to the large Δn. Since Δk is two orders of magnitude lower than Δn, the change in ring absorption is minimal that barely alters the coupling condition and thereby the phase profile of the optical signal remains unchanged. The

$$\frac{Δ n}{Δ k} = - 100$$

and beyond is observed in electro-optic χ⁽²⁾ materials such as LiNbO₃ or BaTiO₃[22], [24], [30]-[35], [41] and electro-refractive III-V materials such as InP or InGaAsP on silicon [10], [26]-[28], [42], where the index change is significantly stronger than the loss modulation. This prohibits access to the regime of strong phase change in critically-coupled rings with low insertion loss. In FIG. 14B, the effect of

$$\frac{Δ n}{Δ k} = - 20$$

on the T_{Ring} and φ_{T} is shown. There is an increases in cavity losses that changes the ring coupling condition to the strongly under-coupled regime, where

$$\frac{1}{{τ}_{0}} > \frac{1}{{τ}_{e}} .$$

However, the phase profile of ϕ_{T} is barely modified due to the low Δk. This case is very similar to what is observed in conventional electro-refractive materials such as silicon[1], [12], [19], [43], [44], which renders it difficult to access the regime of high phase change with low insertion loss in critically coupled ring cavities. Finally in FIG. 14C, we explore the effect of

$$\frac{Δ n}{Δ k} = - 1$$

and find that the loss in the ring increases as fast as the index, causing the linewidth of the resonance to broaden and the ring to become strongly under-coupled with

$$\frac{1}{{τ}_{0}} ≫ \frac{1}{{τ}_{e}} .$$

However, since the phase profile of ϕ_{T} in the under-coupled regime remains gradual, the phase change Δϕ_{T} remains low with high insertion loss.

We show in FIGS. 14D, 14E, 14F, the effect of a positive Δn/Δk on the T_{Ring} and ϕ_{T} of the ring resonator. Due to a positive Δn/Δk and a negative Δn, the induced Δk is negative, which implies that the loss in the ring decreases with an applied voltage. We first investigate the effect of a Δn/Δk of 1 on the T_{Ring} and ϕ_{T} in FIG. 14D. Since Δk=Δn, the decrease in loss of the ring strongly alters the coupling between the bus waveguide and ring resonator. For the ring operating near the critically-coupled regime initially, the ring becomes over-coupled with

$$\frac{1}{{τ}_{0}} < \frac{1}{{τ}_{e}} .$$

These effects in tandem transforms the gradual phase profile in the under-coupled rings to the highly dispersive phase profile in over-coupled ring resonators. This allows access to a strong Δϕ_{T} with significantly low insertion loss at a probe wavelength λₚ. As we increase Δn/Δk to 10 shown in FIG. 14E, the lower Δk results in a minimal decrease in the loss of the ring, causing the ring to become more critically coupled i.e.

$$( \frac{1}{{τ}_{0}} \approx \frac{1}{{τ}_{e}} ) .$$

However, we lose access to the strong phase change due to the small modification in the phase profile of the ring. Further increasing Δn/Δk barely changes the T_{Ring} and ϕ_{T}, as seen in FIG. 14F, since Δk<<Δn that does not change the coupling appreciably.

Section III: Measured and extracted phase 4T as a function of wavelength for various voltages applied across the 40 μm long Gr—WSe₂ capacitor (device I).

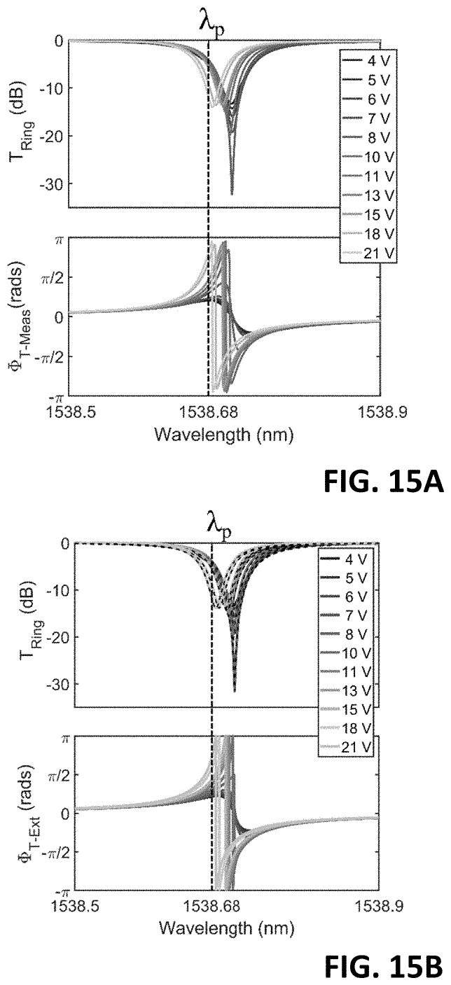

FIGS. 15A-B show normalized ring transmission (T_{Ring}) with measured and extracted phase in 40 μm device for various voltages applied across the Gr—WSe₂ capacitor. FIG. 15A shows normalized ring transmission (T_{Ring}−top panel) and measured phase change (Φ_{T-Meas}−bottom panel) as a function of the applied voltage applied across a 40 μm long Gr-WSe₂ capacitor embedded on a SiN ring resonator of radius 50 μm. The Φ_{T-meas} is measured by embedding the device I in one of the arms of an external fiber-based Mach-Zehnder interferometer. FIG. 15B shows normalized ring transmission (T_{Ring}−top panel) and extracted phase change (Φ_{T-Ext}−bottom panel) as a function of the applied voltage applied across a 40 μm long Gr—WSe₂ capacitor embedded on a SiN ring resonator of radius 50 μM The Φ_{T-Ext} is extracted from the measured T_{Ring} by fitting the normalized ring response to the ring resonator equation given in Ref [40]. One can see the strong correlation between the Φ_{T-Meas} and the Φ_{T-Ext}.

FIG. 15A shows the measured normalized ring transmission (T_{Ring}) in the top panel and the measured phase response (Φ_{T-Meas}) in the bottom panel, for different voltages applied across the Gr—WSe₂ capacitor. One can see from the T_{Ring} spectra, that the ring is initially in the undercoupled state at 4 V, and as we increase the voltage, the ring becomes critically coupled to the bus waveguide at 8 V, finally entering the over-coupled regime beyond 10 V. The Φ_{T-Meas} is measured by embedding the device I in the arms of a fiber-based Mach-Zehnder interferometer (MZI). The detail of the experimental setup and the measurement is provided in Supplementary section VII and VIII. One can see that the Φ_{T-Meas} evolves from the gradual response in the under-coupled regime to the strongly dispersed phase spectra in the over-coupled regime, with a blue-shift in the resonance wavelength due to the index tuning of monolayer WSe₂.

We show in the bottom panel of FIG. 15B, the extracted phase response (Φ_{T-Ext}) of device I. We extract the phase response of a ring resonator from the T_{Ring} by fitting it to the ring resonator equation, as shown in Ref [40] and solving for the decay rates due to loss in the ring resonator

$$( \frac{1}{{τ}_{0}} )$$

and the decay or coupling rate between the waveguide bus and ring resonator

$$( \frac{1}{{τ}_{e}} ) .$$

One can leverage the ring resonator equation in the critical coupling regime where

$$\frac{1}{{τ}_{0}} \approx \frac{1}{{τ}_{e}} ,$$

to determine the coupling rate or the decay rate between the bus waveguide and ring resonator. The ring resonator equation, as shown in equation III-1, is fit to the normalized transmission spectra measured at critical coupling (|T_{Ring}|), to find the decay rate

$$\frac{1}{{τ}_{e} ( C )}$$

in the critical coupling condition:

$${T}_{R i n g} = {\vert 1 - \frac{\frac{2}{{τ}_{e}}}{j ( ω - {ω}_{0} ) + \frac{1}{{τ}_{e}} + \frac{1}{{τ}_{0}}} \vert}^{2} \qquad ( III - 1 )$$

Once we obtain τₑ(V=V_{C}), we use nonlinear least-squares curve fitting in MATLAB simulation tool, to find the change in the decay rate of the ring resonator or cavity with voltage

$$( \frac{1}{{τ}_{0} ( V )} ) ,$$

since tuning the voltage changes the absorption of graphene, thereby changing the unloaded quality factor (Q₀ (V)). After extracting

$$\{ \frac{1}{{τ}_{0} ( V )} , \frac{1}{{τ}_{e} ( V )} \} ,$$

one can compute the phase response by finding the angle (T_{Ring}). We find strong agreement between the measured phase obtained from the MZI measurements and the phase extracted from the ring transmission by fitting the normalized ring transmission to the steady-state ring resonator equation.

Section IV: Electro-optic bandwidth limitation of SiN-2D platform.

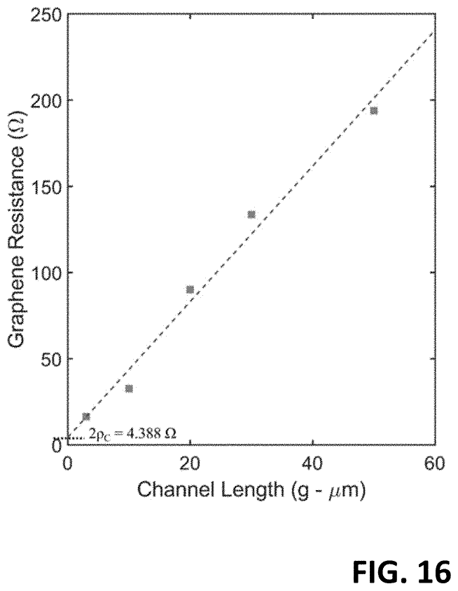

FIG. 16 shows using the transfer length method (TLM) to calculate the sheet and contact resistance for monolayer graphene.

We calculate the contact and sheet resistivity of the graphene monolayer by performing transfer length method (TLM) measurement on a 8 μm wide patterned monolayer that is transferred on to our substrates with different channel lengths. From the measured data shown in FIG. 16, we find that the contact resistivity of graphene (ρ_{c}) to be 2.193 kΩ·μm and a sheet resistivity (ρₛ) of 492 Ω/sq. From our fit to the slope of the Δk_{eff}, we extract the dielectric permittivity of the Al₂O₃ dielectric to be 6.9±0.2. We achieve high dielectric permittivity of the ALD Al₂O₃ by depositing a film of 45 nm thickness, with the first 10 nm at a low temperature of 200° C. to avoid damage to the monolayer WSe₂ and the subsequent 35 nm at a high temperature of 275° C. The capacitance of a 40 μm long×1.3 μm wide Gr—Al₂O₃—WSe₂ capacitor is 1.36 fF μm⁻². These numbers are in accordance with the data reported in Ref [45] that incorporates the same transfer technique for graphene on similar substrates. From the placement of the graphene contact metals at an offset of 1.5 μm from the SiN waveguides, we calculate a total contact resistance of 54.85Ω and a total sheet resistance of 18.4Ω for a 40 μm long capacitor. The RC-limited bandwidth can be expressed using the equation IV-1, assuming negligible pad and graphene quantum capacitance:

$${f}_{3 dB} = \frac{1}{2 π ( \frac{{ρ}_{c}}{L} + \frac{{ρ}_{s} g}{L} + {R}_{{Total}_{{WSe}_{2}}} ) C} \qquad ( IV - 1 )$$

We find from our calculation, that the total resistance that includes the contact and sheet resistance due to monolayer WSe₂ is 78 SI When compared to our previous work on phase modulators based on monolayer WS₂[39], we have reduced the total resistance by over an order of magnitude from 2 kΩ in Ref [39] to 78Ω in our current work. This drastic reduction in the TMD resistance has allowed us to push the bandwidth of our electro-optic modulators.

Section V: Propagation loss in SiN waveguide with different length of graphene capacitor as a function of applied voltage.

FIG. 17 shows measured propagation loss in SiN ring resonator with no integrated capacitor. We show in FIG. 17, the T Ring for a ring with no integrated Gr—WSe₂ capacitor. This device was co-fabricated with other devices to measure the propagation loss in the SiN waveguide with no monolayer graphene and WSe₂. We measure a propagation loss of 5.98±0.38 dB/cm at 1649 nm from the T_{Ring} spectra, with a Q_{loaded} of ˜56,000. Assuming the ring is in the critically coupled condition, the intrinsic quality factor Q₀ is ˜112,000.

FIG. 18 shows change in the measured propagation loss of SiN waveguide with voltage for different lengths of Gr—WSe₂ capacitor embedded in a ring resonator of radius 50 μm. The blue markers show that the measured propagation loss reaches 11.58 dB/cm with a maximum voltage of 22 V applied across a 40 μm long Gr—WSe₂ capacitor (device I). By reducing the length of the Gr—WSe₂ capacitor to 25 μm, one can lower the pin-hole defects which increases the capacitor breakdown voltage to 31 V. This enables higher degree of transparency in SiN waveguides with the Gr—WSe₂ capacitor down to 5.93 dB/cm at 30 V, with the measured loss reaching the limit of propagation loss in SiN waveguides without the Gr—WSe₂ capacitor (shown in black dashed lines).

We achieve higher degree of phase change with low optical loss in our 25 μm device, due to an increase in the breakdown voltage that enables higher degree of transparency in SiN waveguide with Gr—WSe₂ capacitor. One can see from the blue markers in supplementary FIG. 18, that the measured propagation loss in device I is 25.92 dB/cm (Q₀˜27300) at 4 Volts and decreases to 11.58 dB/cm (Q₀˜61500) for a maximum applied bias of 22 Volts. On the contrary, the measured propagation loss in device II reduces from 25.89 dB/cm (Q₀˜25600) at 0 V to 5.93 dB/cm (Q₀˜112,000) at 30 V (see orange markers in FIG. 18). The propagation loss measured at 30 V is similar to that of a SiN resonator reference device with no integrated capacitor co-fabricated on the same wafer/chip (shown in black dashed lines).

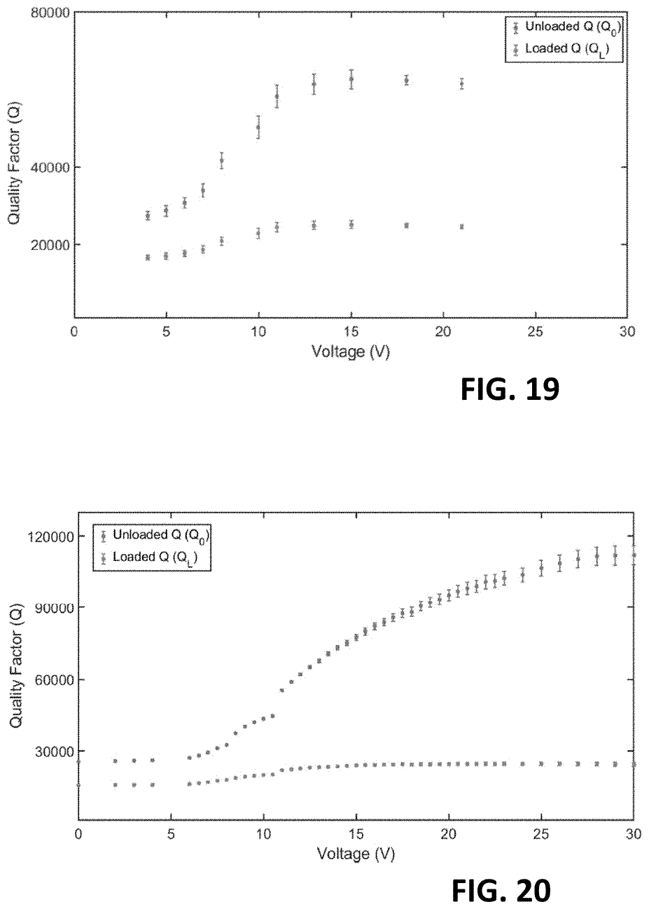

We measure and plot the voltage dependent unloaded (Q₀) and loaded (Q_{L}) quality factor of the ring resonator with the 40 μm and 25 μm Gr—WSe₂ capacitor embedded in the SiN ring resonator of radius 50 μm in FIG. 19 and FIG. 20, respectively. The propagation loss can be computed from the Q₀ using the equation α

$$( \frac{d B}{cm} ) = \frac{2 π {n}_{g}}{λ {Q}_{0}} \times 20 {log}_{10} e .$$

FIG. 19 shows unloaded quality factor (Q₀) and loaded quality factor (Q_{L}) for different voltages applied across the 40 μm long Gr—WSe₂ capacitor, embedded in a ring resonator of radius 50 μm. The probe wavelength is 1538.68 nm.

FIG. 20 shows Unloaded quality factor (Q₀) and loaded quality factor (Q_{L}) for different voltages applied across the 25 μm long Gr—WSe₂ capacitor, embedded in a ring resonator of radius 50 μm. The probe wavelength is 1646.18 nm.

Section VI: Extracted phase change in 25 μm device.

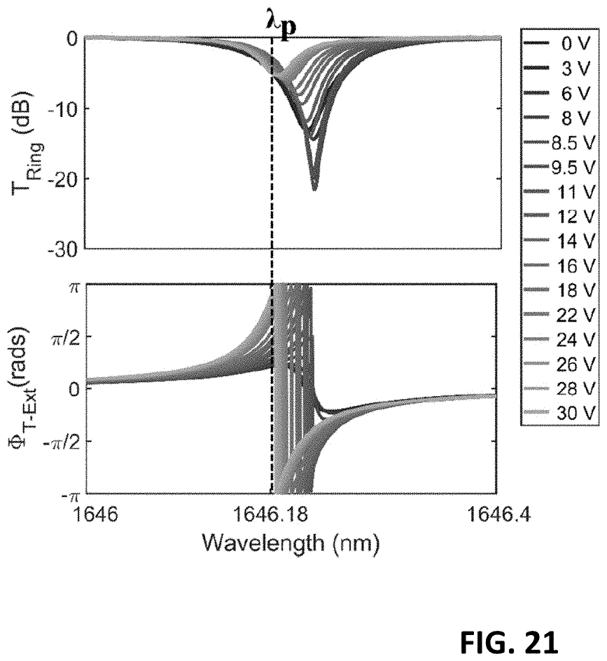

FIG. 21 shows T_{Ring} (dB) and extracted phase (φ_{T-Ext}) vs. wavelength in 25 μm device for various voltages applied across the Gr—WSe₂ capacitor.

We show in the top panel of FIG. 21, the measured T_{Ring} for various voltages applied across a 25 μm Gr—WSe₂ capacitor embedded in a ring resonator of 50 μm. We extract the (in. from the T_{Ring} by fitting T_{Ring} to the ring resonator equation, as explained in section III. We measure the phase modulation Δϕ_{T} (top panel) and the intensity modulation ΔT_{Ring} (bottom panel) of FIG. 9A, at a probe wavelength (λₚ) of 1646.18 nm, as indicated by the dashed lines in supplementary FIG. 21.

Section VII: Phase measurement in SiN-2D hybrid waveguide based phase modulator using external fiber MZI.

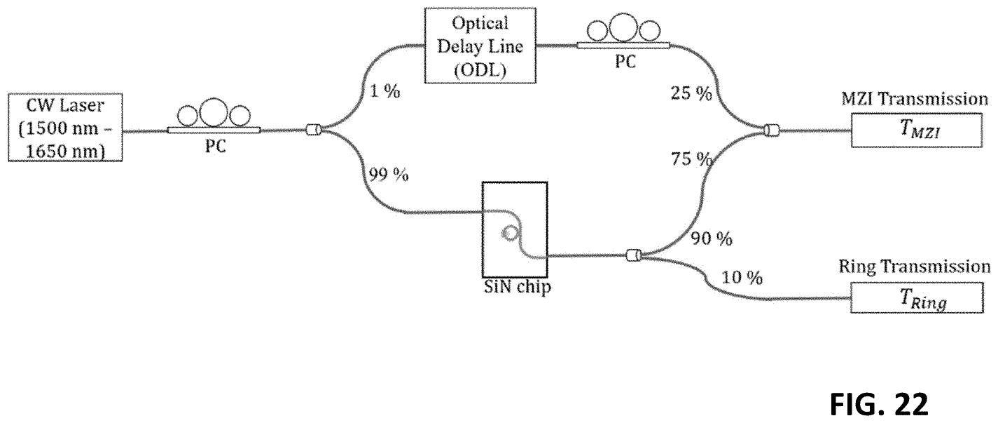

FIG. 22 shows an experimental setup for measuring phase in TMD-graphene based composite waveguide embedded in a ring resonator.

We measure the phase response of a device I by placing the SiN chip in one of the arms of an external fiber based Mach-Zehnder interferometer (MZI). FIG. 22 shows the schematic of the experimental setup for measuring the phase response. We couple TE polarized light from a tunable near infrared (NIR) laser (1510 nm-1600 nm) using a polarization controller (PC) to the input of a 99-1% fiber splitter. We place the SiN chip in the arm with 99% of the input power, to compensate for the 20 dB coupling loss from the lensed fiber to the SiN waveguide and back into the lensed fiber (10 dB coupling loss per facet) at the output of the chip. We monitor the spectral response of the ring transmission (T_{Ring}) at the output of the SiN waveguide, by placing a 90-10% splitter in the chip arm, where 90% of the input power is routed back to the MZI arm, and 10% of the ring transmission is sent to a photodiode. The 1% input signal in the reference arm is first coupled to a free-space optical delay line (ODL) that manually controls the optical path length difference between the reference and the chip arm. In order to ensure that the polarization in the reference arm and chip arm are optimally matched for interference at the input of the output fiber coupler of MZI, the reference arm has an additional polarization controller (PC). The optical signal in the chip and the reference arm are coupled back using a 77-23% coupler at the output of the MZI, to compensate for the insertion loss and coupling loss due to the 90-10 splitter in the chip arm and the ODL and PC in the reference arm. The output of the MZI is monitored with the photodiode (T_{MZI}). We stabilize the external fiber MZI by taping down the fibers on an optical table with large bends and covering them with Styrofoam and bubble wrap and covering the PC's, fiber splitters and ODL with cardboard boxes.

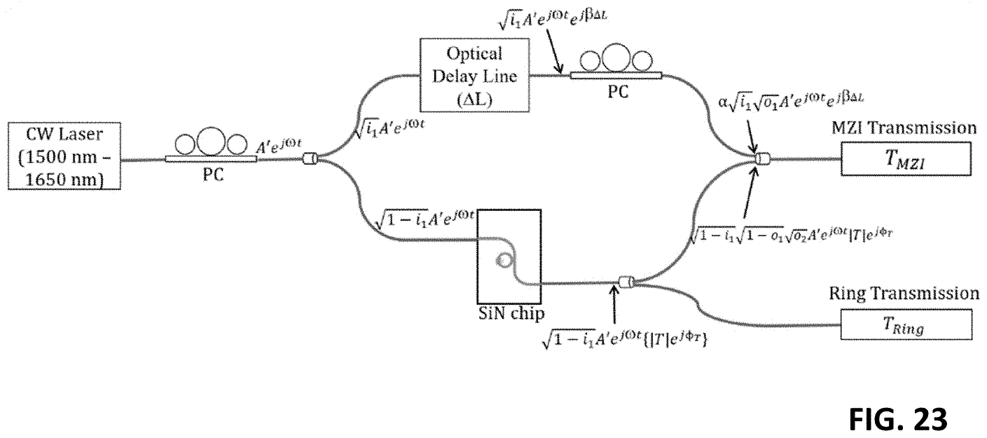

FIG. 23 shows an experimental setup with equations for measuring phase in TMD-graphene based composite waveguide embedded in a ring resonator.

FIG. 23 expands on the experimental setup with equations tracking the evolution of the optical signal at different position in the chip and reference arm and finally at the output of the MZI. We monitor both the T_{Ring} and MZI transmission (T_{MZI}) at the output of the SiN waveguide and fiber interferometer as a function of wavelength, respectively. The T_{MZI} (λ) and T_{Ring} (λ) are related to each other through the following set of equations (VII-1) and (VII-2):

T_{MZI}(λ)=|α\sqrt{i₁}\sqrt{o₁}e^{jωt}e^{jβ(λ)ΔL}+\sqrt{1−i₁}\sqrt{1−o₁}\sqrt{o₂}e^{jωt}|T(λ)|e^{jϕ}^{_{T}}^{(λ)}|²|Eᵢₙ|² (VII-1)

T_{Ring}(λ)=|\sqrt{1−i₁}\sqrt{1−o₂}e^{jωt}|T(λ)|e^{jϕ}^{_{T}}^{(λ)}|²|Eᵢₙ|² (VII-2)
where, i₁, o₁, and o₂ is the input power splitting percentage (99%), ring transmission splitting ratio (90%) and output fiber coupling ratio (77%) in the chip arm of the MZI. The optical path length difference (β(λ)·ΔL) between the reference and chip arm is reflected in the first term of the MZI response equation, and is a dispersive quantity reflected the wavelength dependent optical phase difference between the reference and chip arm. The additional loss due to ODL and PC is compensated using the term ‘α’. The ring resonator phase spectra ϕ_{T}(λ) is related to the frequency detuning using the following equation:

$${ϕ}_{T} ( λ ) = 2 {tan}^{- 1} ( \frac{Δ ω * A}{{( Δ ω * A )}^{2} + {B}^{2}} ) \qquad ( VII - 3 )$$

where, A and B are the terms that define the phase of the ring resonator at different voltage applied across the 45 nm Al₂O₃ dielectric, separating the two monolayers in the Gr—WSe₂ capacitor.

We can further simplify the equations (VII-1) and (VII-2) to find a simple relation that relates the MZI transmission and ring transmission in a single equation (VII-4):

T_{MZI}=|C₁e^{jβΔL}+C₄\sqrt{T_{Ring}}e^{jϕ}^{_{T}}|²|Eᵢₙ|² (VII-4)
where, C₁ and C₄ are constants derived from the other constants in (VII-1) and (VII-2).

Section VIII: Normalized MZI and ring transmission with different voltages applied across the Gr—WSe₂ capacitor embedded in a SiN ring resonator.

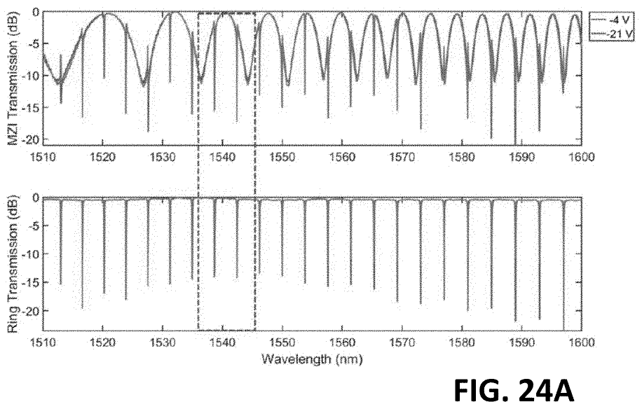

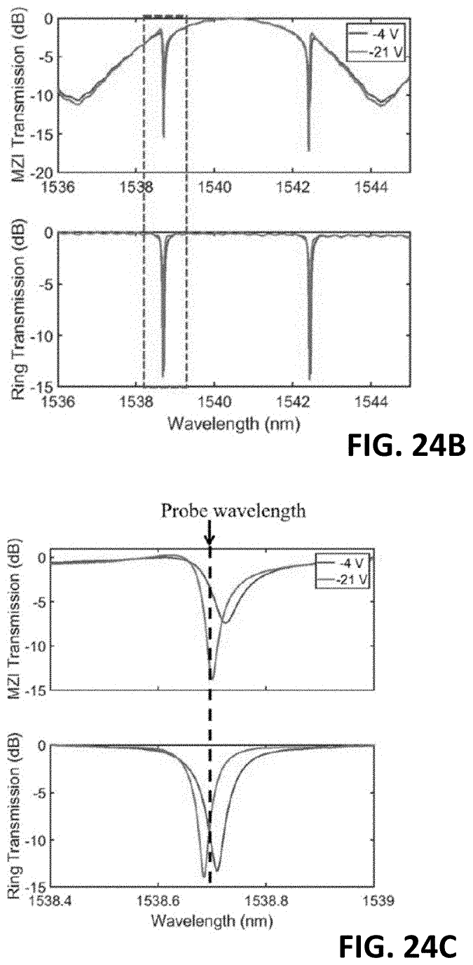

FIGS. 24A-C shows an MZI and ring transmission in the under-coupled (4 V) and over-coupled (21 V) regime of operation for device I. FIG. 24A top panel shows the normalized MZI transmission (T_{MZI}) from 1510 nm-1600 nm for two different bias voltages of 4 V and 21 V applied across the capacitor. The bottom panel of FIG. 24A shows the normalized ring response (T_{Ring}), showing the two regime of operation, when the ring is undercoupled at 4 V and then overcoupled at 21 V. FIG. 24B sows an expanded view of the MZI response in the wavelength range from 1536-1545 nm, showing an MZI fringe that corresponds to a 200 μm±10% path length difference between the chip and reference arm. FIG. 24C shows T_{MZI} and T_{Ring} from 1538.4 nm to 1539 nm, showing the regime of operation where the T_{MZI} experiences a high extinction with minimal change in T_{Ring}, thereby indicating that the phase changed strongly by 0.82 π with minimal amplitude modulation between 4 V and 21 V.

We show in FIG. 24A, the normalized MZI transmission response (top panel

$${\vert \frac{{T}_{MZI}}{{E}_{i n}} \vert}^{2} )$$

and the normalized ring transmission (bottom panel

$${\vert \frac{{T}_{R i n g}}{{E}_{i n}} \vert}^{2} )$$

measured at the fiber MZI output and the SiN chip, respectively, for two different voltages (4 V and 21 V) applied across device I. The spectral measurement of the normalized MZI and ring transmission in FIG. 24A spans the wavelength range from 1510 nm-1600 nm. We provide a zoom in view of the response for the desired wavelength range of 1536 nm-1545 nm (shown in blue boxed region of FIG. 24A). One can observe multiple fringes in the MZI transmission response for the wavelength range from 1510 nm-1600 nm, which indicates interference between the optical signal in the chip and reference arm. We ensure the matching of polarization between the chip and reference arm for maximum extinction of the MZI fringes. We fit the MZI transmission response shown in the top panel of FIG. 24B to equation (VII-1) when |T_{ring}|=1, and extract an optical path length difference (ΔL) of 200 μm±10% between the chip and reference arm of the MZI. We further zoom into the MZI and ring optical response centered on the microring resonance at 1538.68 nm in FIG. 24C. We choose two regimes of operation by biasing the capacitor at two different voltages in such a way that at 4 V, the ring resonator is in the under-coupled regime of operation and at 21 V, the ring resonator is strongly over-coupled to the bus waveguide.

One can see from the MZI response in the top panel of FIG. 24C, that at the probe wavelength of 1538.68 nm, marked by the black dashed lines, the platform shows a strong MZI extinction of 8 dB between the voltages of 4 V and 21 V, whereas the ring transmission remains the same for the two voltages with a fixed insertion loss of 9 dB. Since the concept of a MZI configuration is to convert a phase change in one arm of the MZI to a transmission change at the MZI output, the strong change in MZI extinction at no transmission change in the ring resonator, implies a strong change in phase of the optical signal from the chip between the under-coupled and over-coupled voltage bias. We extract a phase change of 0.82 π at the probe wavelength of 1538.69 nm, which corresponds to the 8 dB change in MZI extinction.

Section IX: Extraction of Δn_{eff} and Δk_{eff} for the Gr—WSe₂ capacitor embedded in a ring resonator.

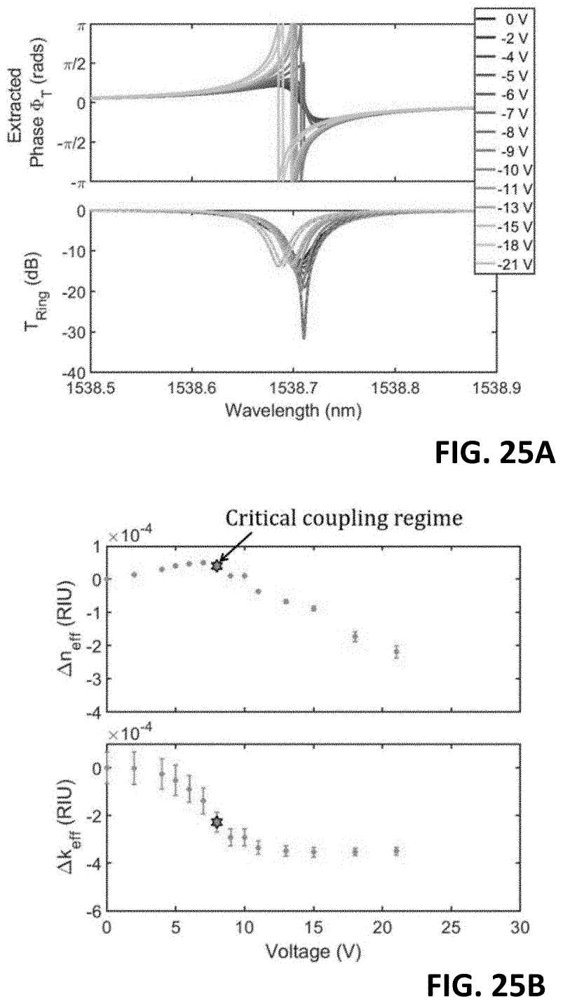

FIGS. 25A-B show calculation of Δn_{eff} and Δk_{eff} of the propagating mode with 40 μm long Gr—WSe₂ capacitor. FIG. 25A shows extracted phase and measured transmission spectra as a function of different voltages applied across the capacitor. FIG. 25B shows change in the real and imaginary part of the effective index of the propagating mode (Δn_{eff} and Δk_{eff}) in refractive index units (RIU) with the orange hexagonal marker, indicating the voltage at which critical coupling occurs, i.e. the decay rate in the ring matches the coupling rate between the bus waveguide and ring resonator

$$( \frac{1}{{τ}_{0}} = \frac{1}{{τ}_{e}} ) .$$

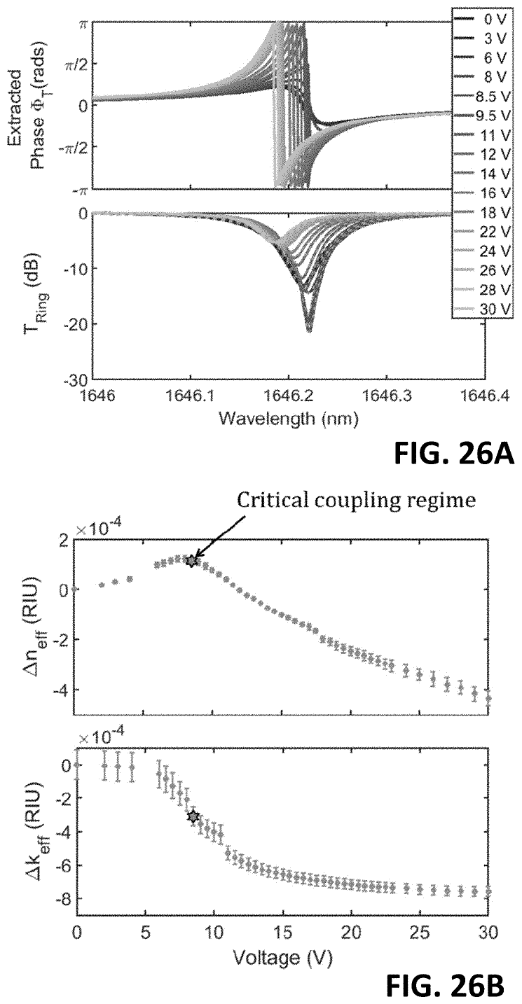

FIG. 26A-B shows calculation of Δn_{eff} and Δk_{eff} of the propagating mode with 25 μm long Gr—WSe₂ capacitor. FIG. 26A shows extracted phase and measured transmission spectra as a function of different voltages applied across the capacitor. FIG. 26B shows Δn_{eff} and Δk_{eff} in RIU with the orange hexagonal marker, indicating the voltage of 8.5 V at which critical coupling occurs.

We calculate the change in the real and imaginary part of the effective index (Δn_{eff} and Δk_{eff}) of the propagating mode with varying voltage, from the change in the position of the resonance wavelength and change in the unloaded quality factor (Q₀), respectively. Since, the change in the effective index is concentrated in the length of the ring with the Gr—WSe₂ capacitor (L_{GrWSe2}), the phase accumulated in the ring

$$⊖ = \frac{2 π}{λ} {n}_{{eff}_{SIN}} ( {L}_{R i n g} - {L}_{G r W S e 2} ) + \frac{2 π}{λ} {n}_{eff - GrWSe 2} ( V ) {L}_{G r WSe 2} ,$$

where n_{eff}_{_{SIN}} is the effective index of the SiN ring resonator without the Gr—WSe₂ capacitor, and n_{eff-GrWSe2}(V) is the voltage dependent effective index of the composite SiN-2D hybrid waveguide. At the resonance wavelength, the transmission through the bus waveguide is minimum, indicating that the accumulated phase θ=2mπ. In order to extract the Δn_{eff}, we track the evolution of the change in the resonance wavelength (Δλᵣₑₛ) with voltage and use the following equations:

$$Δ {n}_{eff - GrWSe 2} ( V ) = \frac{m ( {λ}_{r e s} ( V ) - {λ}_{r e s} ( 0 V ) )}{{L}_{G r WSe 2}}$$

where, m is a measure of the finesse of the cavity (number of round trips in the ring), given by

$$m = \frac{{n}_{g} ( V = 0 )}{{λ}_{r e s} ( V = 0 )} {L}_{Ring} ,$$

where

$${n}_{g} = \frac{{λ}_{m} {λ}_{m + 1}}{Δ {λ}_{F S R} {L}_{R i n g}}$$

at 0 V. To extract Δk_{eff}, we leverage the evolution of the unloaded quality factor (Q₀) as a function of applied voltage. The following two equations relate the change in absorption (dB) and imaginary part of the effective index as a function of voltage:

$${α}_{dB} ( V ) = \frac{2 π {n}_{g} ( V )}{{λ}_{res} ( V ) {Q}_{0} ( V )} * 20 {log}_{10} e ( dB / m ) \\ Δ {k}_{eff} ( V ) = \frac{λ {α}_{linear}}{2 π} ( R I U ) .$$

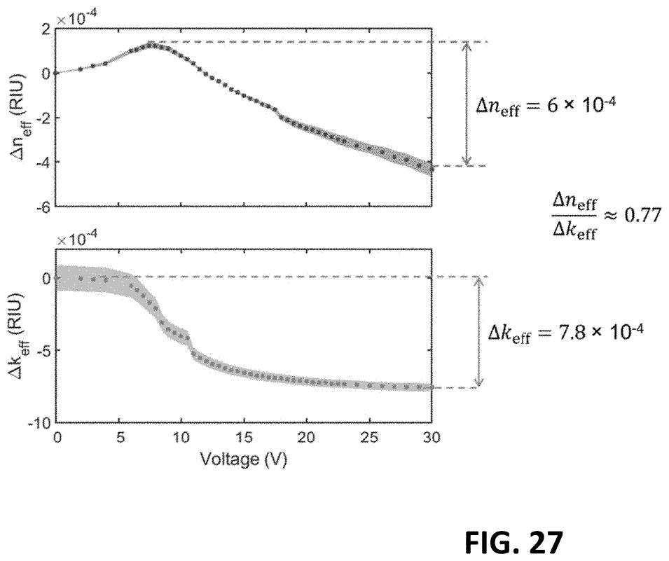

One can see from FIG. 27, that the maximum Δn_{eff} and Δk_{eff} achieved for an applied voltage swing of 30 V is −6×10⁻⁴ RIU and −7.8×10⁻⁴ RIU respectively, which corresponds to a Δn_{eff}/Δk_{eff} of 0.77.

FIG. 27 shows experimentally achieved Δn_{eff}/Δk_{eff} in our composite SiN-2D platform. From the Δn_{eff} and Δk_{eff} extracted from measured T_{Ring}, one can see that the maximum Δn_{eff} and Δk_{eff} is −6×10⁻⁴ RIU and −7.8×10⁻⁴ RIU for a voltage swing from 8 V (under-coupled regime) to 30 V (over-coupled condition).

Section X: Extracted electro-optic response of monolayer graphene and WSe₂.

We find from our simulations that the graphene is initially p-doped with (5.2±0.3)×10¹² cm⁻² carriers (E_{Finit}=0.240±0.006 eV)) and the slope of Δk_{eff} indicates that the εᵣ=6.9±0.2. Since the change in loss of the propagating mode

$$( {Δα}_{eff} = 20 {log}_{10} e * \frac{2 π}{λ} Δ {k}_{eff} )$$

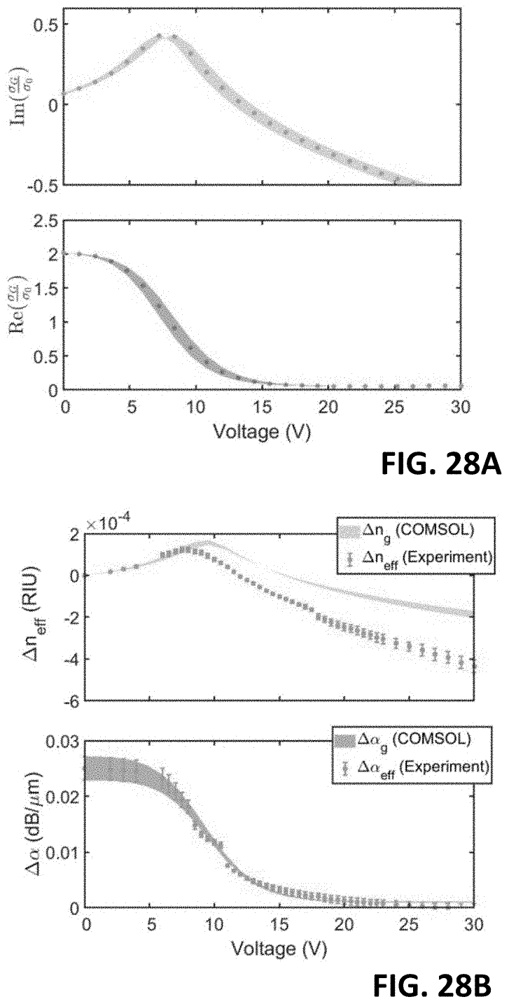

is dominated by the electro-optic response of monolayer graphene, we fit for the unknown parameters (i.e nᵢₙᵢₜᵢₐₗ and εᵣ) in the graphene optical conductivity equation by comparing the experimentally measured Δα_{eff} with the numerically computed propagation loss in COMSOL Multiphysics simulation with monolayer graphene on SiN waveguide. We show the change in the imaginary and real part of the extracted σ_{G}/σ₀ in the top and bottom panel of FIG. 28A. One can see from the bottom panel that the graphene becomes transparent with applied electrostatic doping, which can be attributed to the Pauli blocking condition at high doping densities. We show in the bottom panel (Δα_{eff}(dB)) of FIG. 28B that the change in the numerically computed Δα_{g} due to graphene from COMSOL simulation closely matches the experimentally measured Δα_{eff}, however the numerically computed Δn_{g} has a remarkable departure from the experimentally measured Δn_{eff}. The difference between the simulated and measured Δn_{eff} can be attributed to the change in the index of monolayer WSe₂, which is known to exhibit strong electro-refractive response at high doping densities.

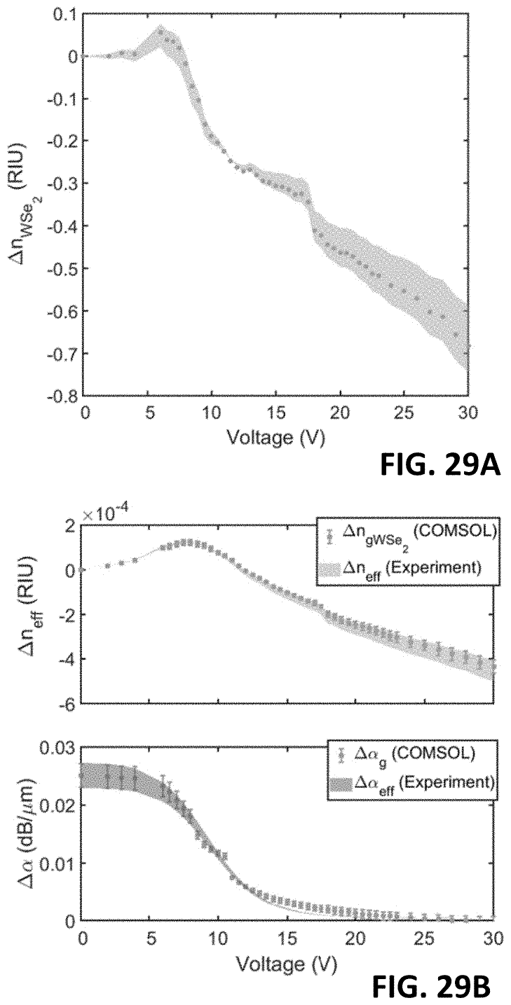

We extract a change of ˜18% in the refractive index of monolayer WSe₂ with an electron doping density of (2.54±0.74)×10¹³ cm⁻² at 30 V (see FIG. 29A). We show the final theoretical fit and the measured experimental data in FIG. 29B and find that by incorporating the graphene and WSe₂ electro-optic integrated response as shown in FIGS. 28A and 29A, one can recreate the effective index change as seen in our device. We model monolayer WSe₂, similar to graphene and is explained in detail in Ref [39].

FIGS. 28A-B shows extracted normalized conductivity of graphene. FIG. 28A shows change in the imaginary (top) and real (bottom) part of the normalized conductivity of graphene

$$( \frac{{σ}_{G}}{{σ}_{0}} )$$

with voltage, extracted from the change in effective index using COMSOL Multiphysics simulations. The

$$Im \{ \frac{{σ}_{G}}{{σ}_{0}} \}$$

is related to the real part of the dielectric permittivity, that contributes to change in the index, whereas the

$$Re \{ \frac{{σ}_{G}}{{σ}_{0}} \}$$

is related to the imaginary part of the dielectric permittivity, that contributes to absorption. The shaded portion indicates the theoretical error that includes the rms error in the measurement. FIG. 28B shows that the Δα_{g} due to graphene from COMSOL simulation closely matches the experimentally measured Δα_{eff}, since the change in loss is dominated by the graphene response. However, the numerically computed Δn_{g} has a remarkable departure from the experimentally measured Δn_{eff}. The difference in the Δn_{eff} can be attributed to the change in the index of monolayer WSe₂, which is known to exhibit strong electro-refractive response at high doping densities.

FIGS. 29A-B shows extracted change in index of monolayer WSe₂. FIG. 29A shows change in the real part of the refractive index of monolayer WSe₂ (Δn_{WSe2}) with applied voltage. One can see that the index of monolayer WSe₂ changes strongly with doping. FIG. 29B shows change in the index and absorption of propagating mode, extracting theoretically from COMSOL simulation (in red and blue shaded region) and measured experimentally (blue squares with errorbar).

Section XI: Performance comparison of various electro-refractive phase modulator

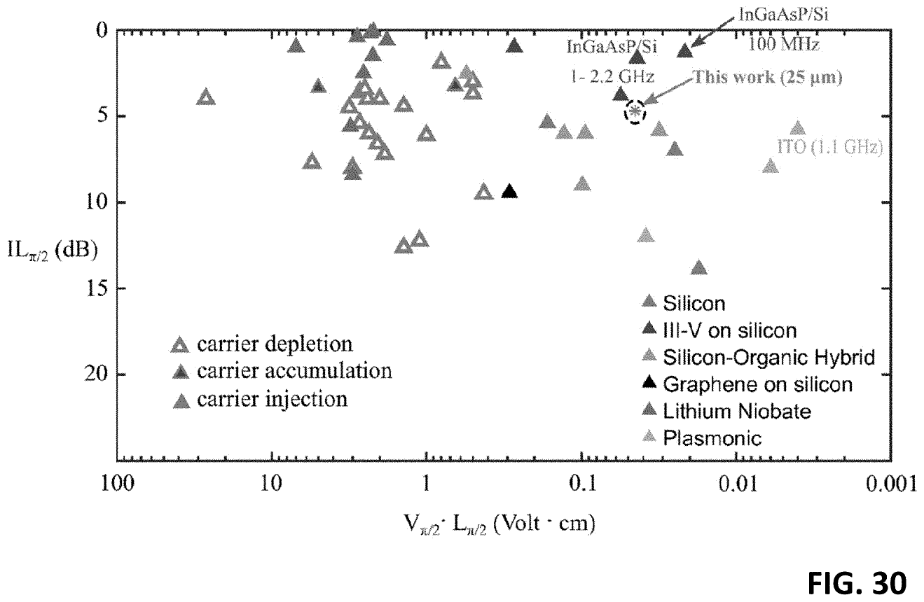

FIG. 30 shows comparison of insertion loss (IL_{π/2}) vs. phase modulation efficiency (V_{π/2}·L_{π/2}) to achieve a phase shift of π/2 radians for various electro-optic modulators.

We compare in FIG. 30, the phase modulation efficiency (V_{π/2}·L_{π/2}) and insertion loss (IL_{π/2}) of various conventional phase modulators based on silicon, InP and III-V on Si, graphene on silicon, organic electro-optic material on silicon, lithium niobate and plasmonic materials with our 25 μm long SiN-2D hybrid waveguide based ring phase modulator. We measure a V_{π/2}·L_{π/2} of 0.0450 V·cm (18 V×25 μm=450 V·μm or 0.045 V·cm) with IL_{π/2} of 4.7 dB in the 25 μm long SiN-2D hybrid ring based phase modulator.

One can see that the SiN-2D platform has at least an order of magnitude smaller V_{π/2}·L_{π/2} compared to state of the art silicon electro-refractive modulators based on carrier accumulation[20] (5 V·cm) and depletion[11] (0.4 V·cm) with similar insertion loss. The larger V_{π/2}·L_{π/2} in depletion based silicon modulators is due to the low Δn_{eff} of 0.97×10⁻⁴-3.87×10⁻⁴ that aims to reduce the propagation loss in silicon waveguide at the expense of long propagation lengths [5], [11], [46]. On the other hand, silicon based carrier-injection modulators have lower V·L_{π/2} of 0.17 V·cm due to the high Δn_{eff} of 2.34×10⁻⁴, that results in an increased IL_{π/2} of 5.2 dB[18]. The V_{π/2}·L_{π/2} of InP modulators[28] that are capable of modulating at gigahertz speeds, is 0.27 V·cm for L_{π/2} of 0.18 cm with a low IL_{π/2} of 1 dB. On the other hand, the V_{π/2}·L_{π/2} and IL_{π/2} of InGaAsP on silicon modulators are lower compared to our device due to a capacitor design that limits the electro-optic operation bandwidth[27]. In order to scale the bandwidth to several GHz, one has to increase the capacitor thickness that would increase their V_{π/2}·L_{π/2} and IL_{π/2}[26]. Phase modulators based on organic electro-optic material in silicon slot waveguides[22] have a low V_{π/2}·L_{π/2} of 0.0315 V·cm (L_{π/2}˜0.15 cm), with a high IL_{π/2} of 5.85 dB, due to the lossy nature of slot waveguides. Phase modulation have also been demonstrated using monolayer graphene on silicon modulators[25], with V_{π/2}·L_{π/2} of 0.28 V·cm which is achieved at the expense of a prohibitively high IL_{π/2} of 9.44 dB. The high IL_{π/2} in graphene phase modulators is due to the probing of the electro-refractive effect in the regime where the optical absorption due to graphene is prohibitively high for photonic applications. Low-loss phase modulation is achieved in lithium niobate modulators[31], [32]; however, these devices suffer from large footprint (˜10-20 cm) due to a low Δn_{eff} of 0.138×10⁻⁴ RIU that translates to a large V_{π/2}·L_{π/2} of 2.8 V·cm. High-speed plasmonic phase modulators[36] are compact with small footprint L_{π/2}˜32 μm, that is comparable to our devices and exhibit low V_{π/2}·L_{π/2} of 0.038 V·cm, but suffer from prohibitively high IL_{π/2} of 12 dB.

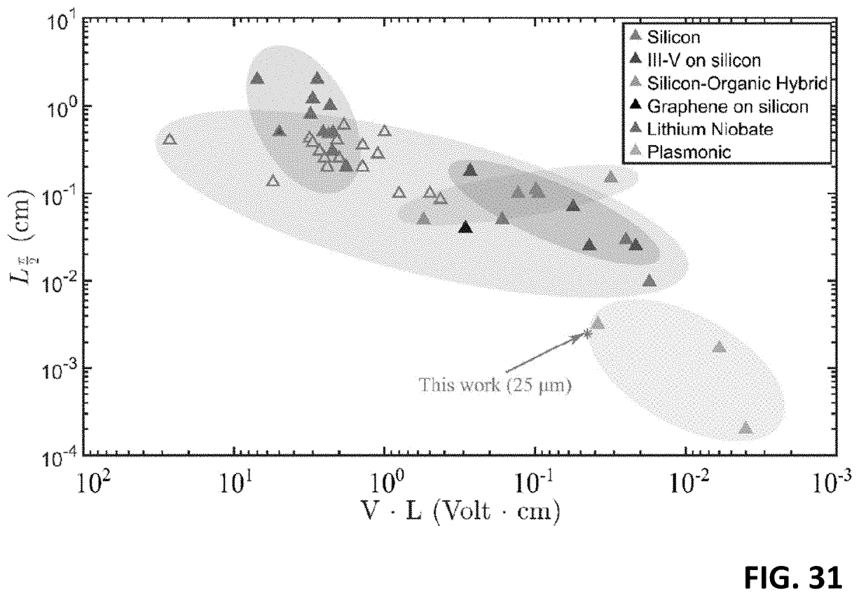

FIG. 31 shows comparison of phase shifter length required to achieve π/2 phase shift (L_{π/2}) vs. phase modulation efficiency (V_{π/2}·L_{π/2}) for various electro-optic modulators. One can see that our device length is of the order of magnitude as plasmonic devices with comparatively lower insertion loss and maintaining high electro-optic bandwidth.

Silicon electro-refractive phase modulators—Traditional silicon electro-refractive modulators based on PN, PIN and MOS capacitors rely on changes in carrier concentration to modulate the phase of the transmitted optical signal. However, this not only changes the real part of the refractive index but also the imaginary part, which induces amplitude modulation in addition to the insertion loss of the waveguide. The insertion loss in silicon waveguide is reduced by decreasing the carrier concentration required for modulation using long devices. This fundamental tradeoff between phase shifter length and insertion loss of silicon electro-refractive phase modulators limits the scalability of these systems. The V_{π/2}·L_{π/2} of the SiN-2D hybrid platform is significantly lower than the V_{π/2}·L_{π/2} of conventional silicon electro-refractive modulators operating in the accumulation and depletion mode, with comparable IL_{π/2}. On the other hand, the V_{π/2}·L_{π/2} of our SiN-2D hybrid platform is similar to that of silicon modulators operating in the injection mode, but with significantly lower IL_{π/2} and higher operation bandwidth than the carrier injection modulators.

Silicon phase modulator based on carrier accumulation[19], [20]—We find from our comparison with the silicon electro-refractive phase modulator based on carrier accumulation[19] that the length required for π/2 phase shift is about 5 mm for a drive voltage of 10 V. This indicates that the V_{π/2}·L_{π/2} in these devices is about 5 V·cm with an insertion loss of 3.35 dB for 5 mm long waveguide. Due to the relatively small Δn_{eff} of 7.75×10⁻⁵ RIU, the length required for the phase shift increases and the insertion loss is low due to the low carrier concentration in the silicon waveguides. In [20], the authors demonstrate a carrier accumulation modulator with lateral metal-oxide-semiconductor capacitor that has a V_{π/2}·L_{π/2} of 0.65 V·cm with an insertion loss of 3.25 dB for a 500 μm device.

Silicon phase modulator based on carrier injection[16], [17], [47]—Silicon phase modulators based on carrier injection operate in the forward bias of the diode operation (0.85 V-3.31 V), thereby requiring low operating voltages. The injection phase modulators require lower phase shifter lengths (˜100 μm-400 μm) due to the relatively high Δn_{eff}˜0.001-0.004. However, this high index change introduces additional free carrier propagation losses, thereby resulting in devices with high IL. The low V_{π/2}·L_{π/2} in silicon injection phase modulators is offset by the high IL and the low operating bandwidth of the devices. For example, in [16], the authors fabricate a 100 μm phase shifter that is capable of achieving π/2 radians with a voltage swing of 1.8 V, with a V_{π/2}·L_{π/2} of 0.0180 V·cm. However, the IL in these devices exceed 12 dB and the bandwidth of operation is limited to 5 GHz.

Silicon phase modulator based on carrier depletion[1]-[10], [12]-[15], [48], [49]—The most common silicon modulators leverage carrier depletion mechanism of index change, so as to allow for high operation bandwidth and low insertion loss. However, modulators based on carrier depletion exhibit low Δn_{eff} that ranges from 6.46×10⁻⁵-5.53×10⁻⁴ (RIU), thereby requiring phase shifter lengths that span a few millimeters. Due to the reverse bias mode of operation, the operating voltage in such devices are a few Volts, thereby rendering large V_{π/2}·L_{π/2} ranging from 0.4-3.15 V·cm.

III-V on silicon metal-oxide-semiconductor (MOS) modulators[26], [27]— The carrier-induced refractive index change

$$( \frac{Δ n}{Δ k} ∼ - 100 )$$

in InGaAsP is significantly greater than that of silicon, rendering strong phase change with extremely low V_{π/2}·L_{π/2} and low optical loss. In [27], the authors demonstrate a InGaAsP/Si hybrid MOS modulator with a V_{π/2}·L_{π/2} of 0.023 V·cm and IL_{π/2} of 1.3 dB. However, this low V_{π/2} is achieved with an extremely thin layer (5 nm) of dielectric Al₂O₃ between the silicon waveguide and InGaAsP material, which limits the electro-optic bandwidth of the modulator to 100 MHz. In order to enable high speed operation (˜1 GHz) in similar silicon III-V MOS phase modulator, the authors in Ref [26] increase the dielectric thickness to 10 nm and replace the dielectric with SiO₂. The 700 μm long silicon III-V modulator exhibits a V_{π/2}·L_{π/2} of 0.056 V·cm with IL_{π/2} of 3.82 dB. Even though the V_{π/2}·L_{π/2} of III-V is comparable to that of our 25 μm device, the electro-optic bandwidth in the III-V modulator is at least an order of magnitude lower and the L_{π/2} is ˜28 times larger than our 25 μm phase shifter.

Graphene on silicon phase modulator[25], [50]—In [25], Sorianello et. al. demonstrates a graphene on silicon phase modulator that achieves a V_{π/2}·L_{π/2} of 0.28 V·cm with a prohibitively high IL_{π/2} of 9.44 dB and 3 dB electro-optic bandwidth of 5 GHz. The electro-refractive effect of graphene is probed in the high absorption regime, which results in extremely high IL for device operation.

Pockels effect in silicon-organic hybrid (SOH) platform—In [21]-[24], the authors integrate silicon slot waveguides with organic electro-optic polymers with high χ⁽²⁾ to demonstrate efficient and compact phase modulator. Compared to the traditional silicon modulators, one can achieve π/2 phase shift in a 1 mm long device. However, the IL_{π/2} associated with the phase shift is as high as 6 dB due to the slot nature of the propagating mode and the additional losses encountered while converting the single mode to the slot mode.

Lithium niobate (LN) electro-optic modulators—Low-loss optical phase modulators based on induced electro-optic χ⁽²⁾ effect suffer from a large device footprint and require complex fabrication[30]-[35]. The large footprint in LN modulators is due to the low change in effective index of the propagating mode (Δn_{eff}˜2×10⁻⁵−7.75×10⁻⁵) with applied electric fields. The optical loss in LN modulators is extremely low (typically 0.2-3 dB) and is limited to the loss due to fabrication. Due to the low Δn_{eff}, the V_{π/2}·L_{π/2} in LN phase modulators exceed 2 V·cm despite the extremely low loss[31], limiting the use of LN modulators for large-scale applications.

Plasmonic modulators—Ultra-compact efficient phase modulators can be engineered using plasmonic materials, however these modulators suffer from extremely high insertion loss. In [36], Ayata et. al. demonstrates a 32 μm long phase shifter that can induce a π/2 phase shift with a voltage swing of 12 V (V_{π/2}·L_{π/2}=0.0384 V·cm). However, the IL associated with the π/2 phase shift is as high as 12 dB. In [37], Haffner et. al. achieves a π/2 phase change in a 17 μm device with a voltage swing of 3.5 V (V_{π/2}·L_{π/2}≈0.006 V·cm) and an insertion loss of 8 dB. Even though the device size is extremely compact, the IL in both the device is much larger than our 25 μm device. In [38], Amin et. al demonstrates a 2 μm ITO based plasmonic phase shifter that can modulate the phase by π/2 radians with a voltage swing of 20 V (V_{π/2}·L_{π/2}=0.004 V·cm) with an IL of 5.8 dB. The limitation on this ITO based device is the low electro-optic bandwidth of 1.1 GHz.

Section XII: Coverage area of gold assisted WSe₂ on planarized SiN waveguides.

We show the coverage area of the Au assisted transferred WSe₂ on planarized SiN waveguides in FIGS. 32A-B, indicating the rings patterned with 25 μm and 40 μm long Gr-Al₂O₃—WSe₂ capacitor (FIG. 32B and FIG. 32A, respectively).

FIGS. 32A-B show coverage area of Au assisted exfoliated monolayer WSe₂ on planarized SiN substrate. We pattern a 50 μm long monolayer WSe₂, followed by metal deposition, dielectric Al₂O₃ deposition and patterning of 40 μm/25 μm long graphene with electrodes to form a 40 μm/25 μm long Gr—Al₂O₃—WSe₂ capacitor on SiN waveguides (FIG. 32A and FIG. 32B, respectively).

Section XIII: PL spectra of Au assisted exfoliated WSe₂ transferred on planarized SiN waveguides.

FIG. 33 shows normalized PL spectra for monolayer WSe₂ using gold-assisted transfer onto planarized SiN waveguides.

We measure the PL spectrum of gold exfoliated monolayer WSe₂ transferred onto planarized SiN waveguides using a Renishaw InVia Micro-Raman spectrometer at an excitation wavelength of 532 nm, as shown in FIG. 33. The spectrum here closely matches the PL spectra of the exfoliated monolayer WSe₂ samples in Ref [51], which were exfoliated onto SiO₂ substrates using the same large-area transfer technique as in our case.

Section XIV: Raman spectra of transferred graphene on planarized SiN waveguides.

We measure the raman spectrum of the top graphene layer after transferring the monolayer graphene onto our substrate, as shown in FIG. 34. The graphene 2D peak is at 2684.48 cm⁻¹, G peak is at 1588.76 cm⁻¹ and the I_{2D}/I_{G} ratio is 2.5867. FIG. 34 shows Raman spectroscope of the top graphene monolayer.

Section XV: Digital phase modulation in Gr—WSe₂ composite platform embedded in a ring resonator.

We further show the potential of our platform in performing binary phase modulation of ˜π radians with a minimal transmission modulation of 0.046 dB and an insertion loss of 5 dB. This is achieved by switching the coupling regime in a ring resonator embedded with a 25 μm long Gr—WSe₂ capacitor, from the under-coupled state at 8 V to the over-coupled condition at 30 V. The minimal transmission modulation is enabled by the index change in the ring resonator that detunes the resonance wavelength, thereby allowing access to a regime of high phase change with minimal transmission modulation.

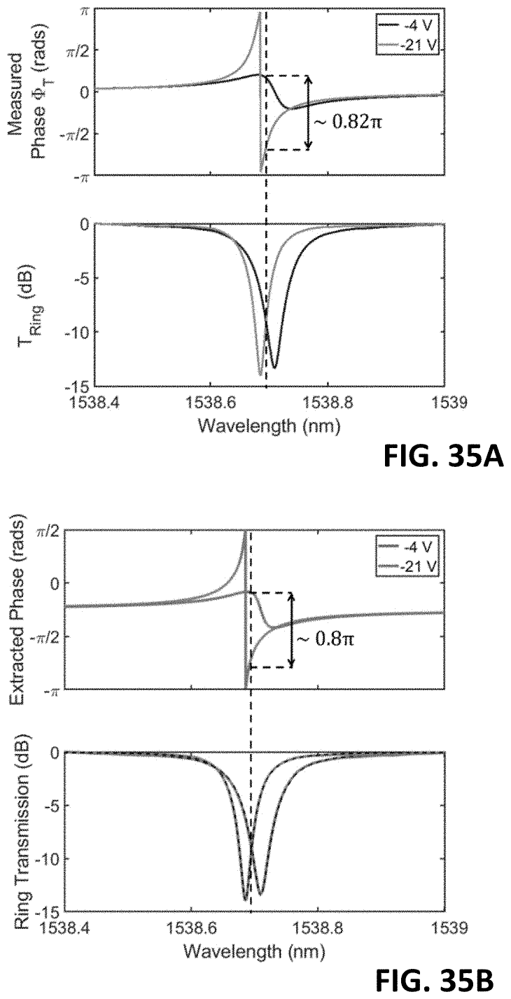

FIGS. 35A-B shows digital phase change between the under-coupled at 4 V and over-coupled regime of operation at 21 V, in the 40 μm Gr—WSe₂ capacitor embedded in a ring resonator of radius 50 μm. We achieve a digital phase change of 0.82 π radians with a transmission modulation of 0.18 dB and insertion loss of 9 dB at λₚ of 1538.695 nm.

As a first demonstration, we show that our 40 μm Gr—WSe₂ device achieves a phase change of 0.82 π at a probe wavelength (λₚ) of 1538.695 nm with a transmission modulation of 0.18 dB. The insertion loss associated with the binary phase change is 9.17 dB at λₚ. The phase change is achieved by switching the ring coupling from the under-coupled regime at 4 V to the over-coupled condition at 21 V.

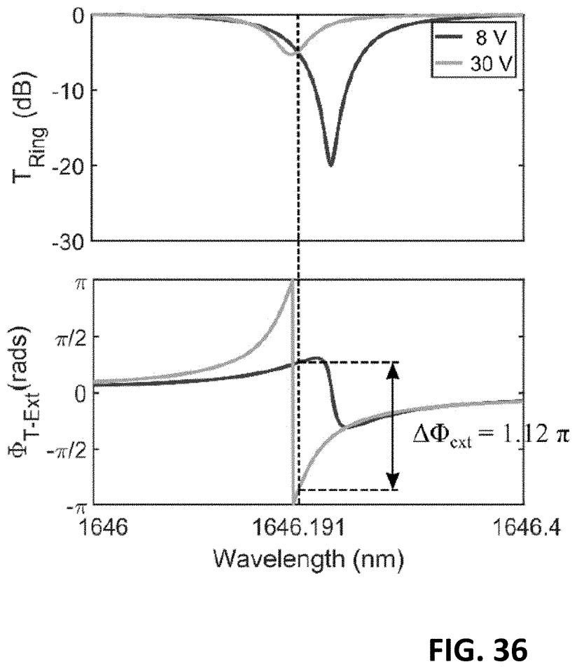

We optimize our device performance to enable a digital phase change of 1.12 π at a λₚ of 1646.191 nm with a minimal transmission modulation of 0.046 dB and a low insertion loss of 5 dB in a 25 μm Gr—WSe₂ capacitor. We achieve this by tuning the ring coupling regime from the under-coupled regime at 8 V to the over-coupled condition at 30 V and inducing loss and index modulation to the same extent. One can see in FIG. 36, the extracted phase change at λₚ of 1646.191 nm is preceded with minimal transmission modulation and lower insertion loss than the 40 μm device.

FIG. 36 shows digital phase change between the under-coupled at 8 V and over-coupled regime of operation at 30 V, in the 25 μm Gr—WSe₂ capacitor embedded in a ring resonator of radius 50 μm. We achieve a digital phase change of 1.12 π radians with a transmission modulation of 0.046 dB and insertion loss of 5 dB at λₚ of 1646.191 nm.

### REFERENCES FOR SUPPLEMENTAL INFORMATION

[1] D. Marris-Morini, L. Vivien, J. M. Fédéli, E. Cassan, P. Lyan, and S. Laval, “Low loss and high speed silicon optical modulator based on a lateral carrier depletion structure,” Opt. Express, vol. 16, no. 1, pp. 334-339, January 2008, doi: 10.1364/OE.16.000334.
[2] J. W. Park, J.-B. You, I. G. Kim, and G. Kim, “High-modulation efficiency silicon Mach-Zehnder optical modulator based on carrier depletion in a PN Diode,” Opt. Express, vol. 17, no. 18, pp. 15520-15524, August 2009, doi: 10.1364/OE.17.015520.
[3] N.-N. Feng et al., “High speed carrier-depletion modulators with 1.4V-cm V_{π}L integrated on 0.25 μm silicon-on-insulator waveguides,” Opt. Express, vol. 18, no. 8, pp. 7994-7999, April 2010, doi: 10.1364/OE.18.007994.
[4] M. R. Watts, W. A. Zortman, D. C. Trotter, R. W. Young, and A. L. Lentine, “Low-Voltage, Compact, Depletion-Mode, Silicon Mach-Zehnder Modulator,” IEEE J. Sel. Top. Quantum Electron., vol. 16, no. 1, pp. 159-164, January 2010, doi: 10.1109/JSTQE.2009.2035059.
[5] D. J. Thomson et al., “High contrast 40 Gbit/s optical modulation in silicon,” Opt. Express, vol. 19, no. 12, pp. 11507-11516, June 2011, doi: 10.1364/OE.19.011507.
[6] F. Y. Gardes, D. J. Thomson, N. G. Emerson, and G. T. Reed, “40 Gb/s silicon photonics modulator for TE and TM polarisations,” Opt. Express, vol. 19, no. 12, pp. 11804-11814, June 2011, doi: 10.1364/OE.19.011804.
[7] G. Rasigade et al., “High extinction ratio 10 Gbit/s silicon optical modulator,” Opt. Express, vol. 19, no. 7, pp. 5827-5832, March 2011, doi: 10.1364/OE.19.005827.
[8] A. Brimont et al., “High-contrast 40& #x2009;& #x2009; Gb/s operation of a 500& #xA0;& #x3BC; m long silicon carrier-depletion slow wave modulator,” Opt. Lett., vol. 37, no. 17, pp. 3504-3506, September 2012, doi: 10.1364/OL.37.003504.
[9] D. J. Thomson et al., “50-Gb/s Silicon Optical Modulator,” IEEE Photonics Technol. Lett., vol. 24, no. 4, pp. 234-236, February 2012, doi: 10.1109/LPT.2011.2177081.
[10] T. Baehr-Jones et al., “Ultralow drive voltage silicon traveling-wave modulator,” Opt. Express, vol. 20, no. 11, pp. 12014-12020, May 2012, doi: 10.1364/OE.20.012014.
[11] M. Ziebell et al., “40 Gbit/s low-loss silicon optical modulator based on a pipin diode,” Opt. Express, vol. 20, no. 10, pp. 10591-10596, May 2012, doi: 10.1364/OE.20.010591.
[12] X. Xiao et al., “High-speed, low-loss silicon Mach-Zehnder modulators with doping optimization,” Opt. Express, vol. 21, no. 4, pp. 4116-4125, February 2013, doi: 10.1364/OE.21.004116.
[13] R. Ding et al., “Design and characterization of a 30-GHz bandwidth low-power silicon traveling-wave modulator,” Opt. Commun., vol. 321, pp. 124-133, June 2014, doi: 10.1016/j.optcom.2014.01.071.
[14] A. Samani et al., “A Low-Voltage 35-GHz Silicon Photonic Modulator-Enabled 112-Gb/s Transmission System,” IEEE Photonics J., vol. 7, no. 3, pp. 1-13, June 2015, doi: 10.1109/JPHOT.2015.2426875.
[15] M. Li, L. Wang, X. Li, X. Xiao, and S. Yu, “Silicon intensity Mach& #x2013; Zehnder modulator for single lane 100& #x2009;& #x2009; Gb/s applications,” Photonics Res., vol. 6, no. 2, pp. 109-116, February 2018, doi: 10.1364/PRJ.6.000109.
[16] W. M. J. Green, M. J. Rooks, L. Sekaric, and Y. A. Vlasov, “Ultra-compact, low RF power, 10 Gb/s silicon Mach-Zehnder modulator,” Opt. Express, vol. 15, no. 25, pp. 17106-17113, December 2007, doi: 10.1364/OE.15.017106.
[17] S. Akiyama et al., “Compact PIN-Diode-Based Silicon Modulator Using Side-Wall-Grating Waveguide,” IEEE J. Sel. Top. Quantum Electron., vol. 19, no. 6, pp. 74-84, November 2013, doi: 10.1109/JSTQE.2013.2278438.
[18] T. Baba, S. Akiyama, M. Imai, and T. Usuki, “25-Gb/s broadband silicon modulator with 0.31-V& #x00B7; cm V& #x03C0; L based on forward-biased PIN diodes embedded with passive equalizer,” Opt. Express, vol. 23, no. 26, pp. 32950-32960, December 2015, doi: 10.1364/OE.23.032950.
[19] A. Liu et al., “A high-speed silicon optical modulator based on a metal-oxide-semiconductor capacitor,” Nature, vol. 427, no. 6975, pp. 615-618, February 2004, doi: 10.1038/nature02310.
[20] K. Debnath et al., “All-silicon carrier accumulation modulator based on a lateral metal-oxide-semiconductor capacitor,” Photonics Res., vol. 6, no. 5, pp. 373-379, May 2018, doi: 10.1364/PRJ.6.000373.
[21] L. Alloatti et al., “100 GHz silicon-organic hybrid modulator,” Light Sci. Appl., vol. 3, no. 5, Art. no. 5, May 2014, doi: 10.1038/1sa.2014.54.
[22] C. Kieninger et al., “Ultra-high electro-optic activity demonstrated in a silicon-organic hybrid modulator,” Optica, vol. 5, no. 6, pp. 739-748, June 2018, doi: 10.1364/OPTICA.5.000739.
[23] S. Wolf et al., “Silicon-Organic Hybrid (SOH) Mach-Zehnder Modulators for 100 Gbit/s on-off Keying,” Sci. Rep., vol. 8, no. 1, Art. no. 1, April 2018, doi: 10.1038/s41598-017-19061-8.
[24] F. Eltes et al., “A BaTiO3-Based Electro-Optic Pockels Modulator Monolithically Integrated on an Advanced Silicon Photonics Platform,” J. Light. Technol., vol. 37, no. 5, pp. 1456-1462, March 2019, doi: 10.1109/JLT.2019.2893500.
[25] V. Sorianello et al., “Graphene-silicon phase modulators with gigahertz bandwidth,” Nat. Photonics, vol. 12, no. 1, pp. 40-44, January 2018, doi: 10.10381s41566-017-0071-6.
[26] T. Hiraki et al., “Heterogeneously integrated III-V/Si MOS capacitor Mach-Zehnder modulator,” Nat. Photonics, vol. 11, no. 8, pp. 482-485, August 2017, doi: 10.1038/nphoton.2017.120.
[27] J.-H. Han, F. Boeuf, J. Fujikata, S. Takahashi, S. Takagi, and M. Takenaka, “Efficient low-loss InGaAsP/Si hybrid MOS optical modulator,” Nat. Photonics, vol. 11, no. 8, pp. 486-490, August 2017, doi: 10.1038/nphoton.2017.122.
[28] Y. Ogiso et al., “Over 67 GHz Bandwidth and 1.5 V Vπ InP-Based Optical IQ Modulator With n-i-p-n Heterostructure,” J. Light. Technol., vol. 35, no. 8, pp. 1450-1455, April 2017.
[29] T. Thiessen et al., “30 GHz heterogeneously integrated capacitive InP-on-Si Mach-Zehnder modulators,” Opt. Express, vol. 27, no. 1, pp. 102-109, January 2019, doi: 10.1364/OE.27.000102.
[30] S. Jin, L. Xu, H. Zhang, and Y. Li, “LiNbO3 Thin-Film Modulators Using Silicon Nitride Surface Ridge Waveguides,” IEEE Photonics Technol. Lett., vol. 28, no. 7, pp. 736-739, April 2016, doi: 10.1109/LPT.2015.2507136.
[31] C. Wang et al., “Integrated lithium niobate electro-optic modulators operating at CMOS-compatible voltages,” Nature, vol. 562, no. 7725, p. 101, October 2018, doi: 10.1038/s41586-018-0551-y.
[32] C. Wang, M. Zhang, B. Stern, M. Lipson, and M. Lončar, “Nanophotonic lithium niobate electro-optic modulators,” Opt. Express, vol. 26, no. 2, pp. 1547-1555, January 2018, doi: 10.1364/OE.26.001547.
[33] T. Ren et al., “An Integrated Low-Voltage Broadband Lithium Niobate Phase Modulator,” IEEE Photonics Technol. Lett., vol. 31, no. 11, pp. 889-892, June 2019, doi: 10.1109/LPT.2019.2911876.
[34] M. He et al., “High-performance hybrid silicon and lithium niobate Mach-Zehnder modulators for 100 Gbit s−1 and beyond,” Nat. Photonics, vol. 13, no. 5, Art. no. 5, May 2019, doi: 10.1038/s41566-019-0378-6.
[35] A. Rao et al., “High-performance and linear thin-film lithium niobate Mach-Zehnder modulators on silicon up to 50& #x2009;& #x2009; GHz,” Opt. Lett., vol. 41, no. 24, pp. 5700-5703, December 2016, doi: 10.1364/0L.41.005700.
[36] M. Ayata et al., “High-speed plasmonic modulator in a single metal layer,” Science, vol. 358, no. 6363, pp. 630-632, November 2017, doi: 10.1126/science.aan5953.
[37] C. Haffner et al., “All-plasmonic Mach-Zehnder modulator enabling optical high-speed communication at the microscale,” Nat. Photonics, vol. 9, no. 8, Art. no. 8, August 2015, doi: 10.1038/nphoton.2015.127.
[38] R. Amin et al., “Sub-wavelength GHz-fast broadband ITO Mach-Zehnder modulator on silicon photonics,” Optica, vol. 7, no. 4, pp. 333-335, April 2020, doi: 10.1364/OPTICA.389437.
[39] I. Datta et al., “Low-loss composite photonic platform based on 2D semiconductor monolayers,” Nat. Photonics, vol. 14, no. 4, Art. no. 4, April 2020, doi: 10.1038/s41566-020-0590-4.
[40] C. Manolatou, M. J. Khan, S. Fan, P. R. Villeneuve, H. A. Haus, and J. D. Joannopoulos, “Coupling of modes analysis of resonant channel add-drop filters,” IEEE J. Quantum Electron., vol. 35, no. 9, pp. 1322-1331, September 1999, doi: 10.1109/3.784592.
[41] S. Koeber et al., “Femtojoule electro-optic modulation using a silicon-organic hybrid device,” Light Sci. Appl., vol. 4, no. 2, Art. no. 2, February 2015, doi: 10.1038/1sa.2015.28.
[42] T. Thiessen et al., “30 GHz heterogeneously integrated capacitive InP-on-Si Mach& #x02013; Zehnder modulators,” Opt. Express, vol. 27, no. 1, pp. 102-109, January 2019, doi: 10.1364/OE.27.000102.
[43] R. Soref and B. Bennett, “Electrooptical effects in silicon,” IEEE J. Quantum Electron., vol. 23, no. 1, pp. 123-129, January 1987, doi: 10.1109/JQE.1987.1073206.
[44] Q. Xu, B. Schmidt, S. Pradhan, and M. Lipson, “Micrometre-scale silicon electro-optic modulator,” Nature, vol. 435, no. 7040, pp. 325-327, May 2005, doi: 10.1038/nature03569.
[45] B. S. Lee et al., “High-performance integrated graphene electro-optic modulator at cryogenic temperature,” Nanophotonics, vol. 10, no. 1, pp. 99-104, January 2021, doi: 10.1515/nanoph-2020-0363.
[46] X. Tu et al., “50-Gb/s silicon optical modulator with traveling-wave electrodes,” Opt. Express, vol. 21, no. 10, pp. 12776-12782, May 2013, doi: 10.1364/OE.21.012776.
[47] T. Baba, S. Akiyama, M. Imai, and T. Usuki, “25-Gb/s broadband silicon modulator with 0.31-V& #x00B7; cm V& #x03C0; L based on forward-biased PIN diodes embedded with passive equalizer,” Opt. Express, vol. 23, no. 26, pp. 32950-32960, December 2015, doi: 10.1364/OE.23.032950.
[48] P. Dong, L. Chen, and Y. Chen, “High-speed low-voltage single-drive push-pull silicon Mach-Zehnder modulators,” Opt. Express, vol. 20, no. 6, pp. 6163-6169, March 2012, doi: 10.1364/OE.20.006163.
[49] M. Ziebell et al., “40 Gbit/s low-loss silicon optical modulator based on a pipin diode,” Opt. Express, vol. 20, no. 10, pp. 10591-10596, May 2012, doi: 10.1364/OE.20.010591.
[50] M. Mohsin et al., “Experimental verification of electro-refractive phase modulation in graphene,” Sci. Rep., vol. 5, p. 10967, June 2015, doi: 10.1038/srep10967.
[51] F. Liu et al., “Disassembling 2D van der Waals crystals into macroscopic monolayers and reassembling into artificial lattices,” Science, vol. 367, no. 6480, pp. 903-906, February 2020, doi: 10.1126/science.aba1416.

What is claimed:

1. A device comprising:
a waveguide;
a resonator optically coupled to the waveguide; and
at least one layer comprising an electro-optic material, wherein the at least one layer has an electro-refractive property and electro-absorptive property, and
wherein the device causes phase modulation to optical signals based on using the at least one layer to tune a coupling of the waveguide and the resonator between being under-coupled and being over-coupled.

2. The device of claim 1, wherein the electro-optic material comprises an electro-absorptive material, and wherein the electro-absorptive material comprises one or more of graphene, silicon, or a plasmonic material.

3. The device of claim 1, wherein the electro-optic material comprises an electro-refractive material, and wherein the electro-refractive material comprises one or more of transition metal dichalcogenide, silicon, indium gallium arsenide (InGaAs), or a plasmonic material.

4. The device of claim 1, wherein the electro-optic material comprises a plasmonic material having both the electro-refractive property and electro-absorptive property.

5. The device of claim 1, wherein the electro-optic material comprises transition metal dichalcogenide having both the electro-refractive property and electro-absorptive property at or near an excitonic resonance.

6. The device of claim 1, wherein the phase modulation is caused based on simultaneously modulating, using the at least one layer, both an index of refraction of the resonator and an insertion loss of the resonator.

7. The device of claim 1, wherein the phase modulation is caused based on modulating, using the electro-refractive property of the electro-optic material, an index of refraction of the resonator.

8. The device of claim 1, wherein the phase modulation is caused based on modulating, using the electro-absorptive property of the electro-optic material, an insertion loss of the resonator.

9. The device of claim 1, wherein the phase modulation is caused based on changing a voltage applied between an electro-refractive portion of the electro-optic material and an electro-absorptive portion of the electro-optic material.

10. The device of claim 9, wherein the electro-refractive portion comprises a layer of transition metal dichalcogenide and the electro-absorptive portion comprises a layer of graphene.

11. The device of claim 9, wherein changing the voltage applied between the electro-refractive portion of the electro-optic material and the electro-absorptive portion of the electro-optic material comprises changing the voltage to cause a tuning of the coupling of the waveguide and the resonator between being under-coupled and being over-coupled.

12. The device of claim 1, wherein the at least one layer is disposed adjacent the resonator, on the resonator, within the resonator, or a combination thereof.

13. The device of claim 1, wherein the at least one layer comprises a monolayer of an electro-refractive material.

14. The device of claim 1, wherein the at least one layer comprises a monolayer of an electro-absorptive material.

15. The device of claim 1, wherein the at least one layer comprises a capacitor structure comprising a first layer having an electro-refractive material, a second layer comprising an insulator, a third layer comprising an electro-absorptive material, a first electrode adjacent the first layer, and a second electrode adjacent the third layer.

16. The device of claim 1, wherein an optical mode of the resonator overlaps at least partially with the electro-optic material.

17. A method comprising:
supplying, via a waveguide, an optical signal to a resonator optically coupled to the waveguide;
modulating a phase of the optical signal based on at least one layer comprising an electro-optic material having an electro-refractive property and an electro-absorptive property, wherein the modulating of the phase is based on using the at least one layer to tune a coupling of the waveguide and the resonator between being under-coupled and being over-coupled; and
outputting, via the waveguide, the modulated optical signal.

18. The method of claim 17, wherein modulating the phase of the optical signal comprises simultaneously modulating, using the at least one layer, both an index of refraction of the resonator and an insertion loss of the resonator.

19. The method of claim 17, wherein modulating the phase of the optical signal comprises modulating, using the electro-absorptive property of the electro-optic material, an insertion loss of the resonator.

20. The method of claim 17, wherein modulating the phase of the optical signal comprises changing a voltage applied between an electro-refractive portion of the electro-optic material and an electro-absorptive portion of the electro-optic material.
